(19) United States
(12) Patent Application Publication
(10) Pub. No.: US 2016/0178326 A1
(43) Pub. Date: Jun. 23, 2016

(54) BALLISTIC RESISTANT APPARATUS WITH ABRASION-RESISTANT MARKING

(71) Applicant: ANGEL ARMOR LLC, Fort Collins, CO (US)

(72) Inventors: Eric B. Strauss, Fort Collins, CO (US); Benny J. Slater, Denver, CO (US)

(21) Appl. No.: 14/599,676

(22) Filed: Jan. 19, 2015

Related U.S. Application Data
(63) Continuation-in-part of application No. 13/353,185, filed on Jan. 18, 2012.
Application No. 13/353,185 is a continuation-in-part of application No. 14/322,931, filed on Jul. 3, 2014.
Application No. 14/322,931 is a continuation-in-part of application No. 14/539,259, filed on Nov. 12, 2014, now abandoned.
Application No. 14/539,259 is a continuation-in-part of application No. 14/599,539, filed on Jan. 18, 2015.
(60) Provisional application No. 61/461,586, filed on Jan. 19, 2011.
(60) Provisional application No. 61/842,937, filed on Jul. 3, 2013.
(60) Provisional application No. 61/903,337, filed on Nov. 12, 2013.
(60) Provisional application No. 61/903,353, filed on Nov. 12, 2013.
(60) Provisional application No. 61/978,342, filed on Apr. 11, 2014.
(60) Provisional application No. 62/012,959, filed on Jun. 16, 2014.

(51) Int. Cl. F41H 5/04; B32B 5/26; B32B 3/04; F41H 5/02

(52) U.S. Cl. CPC F41H 5/04; F41H 5/0471; F41H 5/023; B32B 5/26; B32B 3/04; B32B 2571/02; B32B 2262/101; B32B 2262/0269

(57) ABSTRACT

A ballistic resistant apparatus can include an abrasion-resistant marking. The ballistic resistant apparatus can include a plurality of ballistic resistant sheets arranged to form a stack of ballistic resistant sheets having a first surface and a second surface opposite the first surface. The ballistic resistant apparatus can include a top sheet adjacent to the first surface of the stack of ballistic resistant sheets. The top sheet can include the abrasion-resistant marking made of dye particles deposited within the top sheet according to a dye diffusion thermal transfer process.

### CROSS-REFERENCE TO RELATED APPLICATIONS

This application is a continuation-in-part of U.S. patent application Ser. No. 13/353,185, filed Jan. 18, 2012, which claims the benefit of U.S. Provisional Patent Application No. 61/461,586, filed Jan. 19, 2011, and is a continuation-in-part of U.S. patent application Ser. No. 14/322,931 filed Jul. 3, 2014, which claims the benefit of U.S. Provisional Patent Application No. 61/842,937 filed Jul. 3, 2013 and U.S. Provisional Patent Application No. 61/903,337 filed Nov. 12, 2013, and is a continuation-in-part of U.S. patent application Ser. No. 14/539,259 filed Nov. 11, 2014, which claims the benefit of U.S. Provisional Patent Application No. 61/903,353 filed Nov. 12, 2013, U.S. Provisional Patent Application No. 61/978,342 filed Apr. 11, 2014, and U.S. Provisional Patent Application No. 62/012,959 filed Jun. 16, 2014, and is a continuation-in-part of U.S. patent application Ser. No. 14/599,539, filed Jan. 18, 2015, all of which are hereby incorporated by reference in their entirety as if fully set forth in this description.

### FIELD

This disclosure relates to methods of manufacturing ballistic resistant apparatuses and systems for manufacturing ballistic resistant apparatuses.

### BACKGROUND

Ballistic resistant panels can safeguard people and property from ballistic threats. More specifically, ballistic resistant panels can be incorporated into bulletproof vests to protect people from projectiles, such as bullets or shrapnel, and can be incorporated into vehicle doors and floors to prevent occupants and equipment from projectiles or blasts. Ballistic resistant panels are commonly made of woven fabrics consisting of high performance fibers, such as aramid fibers. When struck by a projectile, fibers in the woven fabric dissipate impact energy transferred from the projectile by stretching and breaking, thereby providing a certain level of ballistic protection.

Existing ballistic resistant panels are often made of a stack of woven ballistic resistant sheets stitched together by a sewing process that requires a costly industrial sewing machine. The level of ballistic protection provided by existing panels is largely dictated by physical properties of the fibers used in the sheets, the number of sheets in the stack, and the stitching pattern used to bind the sheets together to form the panels. A wide variety of stitching patterns are used in existing panels, including quilt stitches, radial stitches, row stitches, and box stitches.

When a projectile strikes a panel made of a stack of woven ballistic resistant sheets bound by stitching, each woven ballistic resistant sheet dissipates a certain portion of the energy of the projectile as the projectile passes through each sheet. Within each woven ballistic resistant sheet, individual fibers stretch and break apart as the projectile penetrates the sheet. The impact energy absorbed by a struck fiber is transferred and dissipated to nearby fibers at crossover points where the fibers are interwoven. Also, individual stitches stretch and break as the projectile enters the panel, thereby dissipating impact energy from the projectile and acting as a sacrificial element of the panel.

Due to the sacrificial nature of existing panels, the fibers and stitches within the panel are severely damaged after being struck by a projectile. Visual inspection of the panel will typically reveal significant damage to the woven ballistic resistant sheets and to stitches both at the impact location and the surrounding area, indicating a severely weakened panel in those areas. If a second projectile strikes the panel at or near the first impact location, the panel will not effectively stop the second projectile, and the second projectile will pass through the panel and into a person or property behind the panel. Therefore, existing panels do not provide reliable protection against multiple projectiles striking the panel in close proximity, which is a common threat posed by many automatic and semi-automatic firearms and by trained marksmen equipped with non-automatic firearms. For at least these reasons, existing ballistic resistant panels are not well-suited for combat environments or other applications where multi-round capability is required.

### SUMMARY

This disclosure presents ballistic resistant apparatuses, including body armor, vehicle armor, and many other forms of armor that can be lightweight, thin, conformable, high performing, and multi-round capable and can include abrasion-resistant markings formed by a dye diffusion thermal transfer method.

A ballistic resistant apparatus with an abrasion-resistant marking can include a plurality of ballistic resistant sheets arranged to form a stack of ballistic resistant sheets having a first surface and a second surface opposite the first surface. The ballistic resistant apparatus can include a top sheet adjacent to the first surface of the stack of ballistic resistant sheets. The top sheet can include an abrasion-resistant marking formed by dye particles deposited within the top sheet according to a dye diffusion thermal transfer process. The ballistic resistant apparatus can include a sheet of thermoplastic adhesive film between the first surface of the stack of ballistic resistant sheets and the top sheet. The sheet of adhesive film can be configured to bond the top sheet to the first surface of the stack of ballistic resistant sheets. In some examples, the top sheet can be made of polyester, ceramic, nylon, glass, metal, fabric, vinyl, ultra high molecular weight polyethylene, acrylonitrile butadiene styrene, polybutylene terephthalate, or polypropylene. The plurality of ballistic resistant sheets can include high performance fibers, such as aramid, para-aramid, meta-aramid, polyolefin, or ultra-high-molecular-weight polyethylene fibers.

The ballistic resistant apparatus can include an edge protection feature such as a durable side wall disposed between the top sheet and the protective cover. The durable side wall can circumscribe a perimeter of the stack of ballistic resistant sheets. In some examples, the durable side wall can be made of a thermoplastic polymer, a thermoplastic elastomer, or other suitable material.

The ballistic resistant apparatus can include a protective cover adjacent to the second surface of the stack of ballistic resistant sheets. The protective cover can be made of nylon with a coating of polyurethane, polypropylene, polyethylene, or polyvinylchloride that serves as a thermoplastic adhesive when heated. The coating can be provided on a surface of the protective cover that is in contact with the second surface of the stack of ballistic resistant sheets. The protective cover can be adhered to a surface of the durable side wall to provide a sealed volume defined by the protective cover, the durable side wall, and the top sheet. The sealed volume can provide a watertight and/or airtight enclosure around the stack of ballistic resistant sheets. In some examples, the sealed volume can be evacuated of air and maintained at a sub-atmospheric pressure, thereby resulting in the enclosure providing a compressive force against the external surfaces of the stack of ballistic resistant sheets, which can improve the ballistic performance of the ballistic resistant apparatus.

A ballistic resistant apparatus with an abrasion-resistant marking can include a stack of ballistic resistant sheets having a first plurality of ballistic resistant sheets made of high performance fibers where each ballistic resistant sheet within the first plurality of ballistic resistant sheets can be at least partially bonded to at least one adjacent ballistic resistant sheet in the first plurality of ballistic resistant sheets. The stack of ballistic resistant sheets can include a second plurality of ballistic resistant sheets made of high performance fibers where the second plurality of ballistic resistant sheets is adjacent to the first plurality of ballistic resistant sheets. The stack of ballistic resistant sheets can include a third plurality of ballistic resistant sheets made of high performance fibers where the third plurality of ballistic resistant sheets is adjacent to the second plurality of ballistic resistant sheets. Each ballistic resistant sheet within the third plurality of ballistic resistant sheets can be at least partially bonded to at least one adjacent ballistic resistant sheet in the third plurality of ballistic resistant sheets. The ballistic resistant apparatus can include a top sheet adjacent to a surface of the stack of ballistic resistant sheets where the top sheet includes an abrasion-resistant marking made of dye particles deposited within the top sheet by a dye diffusion thermal transfer process. The ballistic resistant apparatus can include a sheet of thermoplastic adhesive film between the surface of the stack of ballistic resistant sheets and the top sheet. The sheet of adhesive film can be configured to bond the top sheet to the first surface of the stack of ballistic resistant sheets.

The first plurality of ballistic resistant sheets can include 1-10, 10-20, or 20-30 ballistic resistant sheets, the second plurality of ballistic resistant sheets can include 1-10, 10-20, or 20-30 ballistic resistant sheets, and the third plurality of ballistic resistant sheets can include 1-10, 10-20, or 20-30 ballistic resistant sheets. In some examples, the first plurality of ballistic sheets can include 1-10 0/90 x-ply ballistic resistant sheets, the second plurality of ballistic sheets can include 1-10 0/90 x-ply ballistic resistant sheets or s-glass fiberglass sheets, and the third plurality of ballistic resistant sheets comprises 1-10 0/90 x-ply ballistic resistant sheets.

A first resin in the first plurality of ballistic sheets can have a melting temperature of about 215-240, 240-265, 265-295, or 295-340 degrees F., a second resin in the second plurality of ballistic sheets can have a melting temperature of about 255-295, 295-330, 330-355, or 355-375 degrees F., and a third resin in the third plurality of ballistic sheets can have a melting temperature of about 215-240, 240-265, 265-295, or 295-340 degrees F.

A trauma plate with an abrasion-resistant marking can include a plurality of ballistic resistant sheets arranged to form a stack of ballistic resistant sheets having a first surface and a second surface opposite the first surface. The trauma plate can include a top sheet adjacent to the first surface of the stack of ballistic resistant sheets. The top sheet can include an abrasion-resistant marking formed of dye particles deposited within the top sheet beneath a top surface of the top sheet. The trauma plate can include a durable side wall extending around a perimeter of the stack of ballistic resistant sheets, where the durable side wall is adhered to a bottom surface of the top sheet. The durable side wall can protect the edges of the ballistic resistant sheets from drop-induced damage.

The trauma plate can include a protective cover adjacent to the second surface of the stack of ballistic resistant sheets. The protective cover can be adhered to the durable side wall. The stack of ballistic resistant sheets can be encased and bounded by a combination of the top sheet, the durable side wall, and the protective cover. The top sheet can be made of polyester, ceramic, nylon, glass, metal, fabric, vinyl, ultra high molecular weight polyethylene, acrylonitrile butadiene styrene, polybutylene terephthalate, or polypropylene. The top sheet, the durable side wall, and the protective cover together can define an airtight and/or watertight sealed volume that contains the stack of ballistic resistant sheets. In some examples, the sealed volume can be evacuated and maintained at a sub-atmospheric pressure, thereby resulting in the sealed volume providing a compressive force against the external surfaces of the stack of ballistic resistant sheets, which can improve the ballistic performance of the ballistic resistant apparatus.

The stack of ballistic resistant sheets can include a first plurality of ballistic sheets made of aramid fibers and a first resin with a first melting temperature. The stack of ballistic resistant sheets can also include a second plurality of ballistic sheets adjacent to the first plurality of ballistic sheets, where the second plurality of ballistic sheets is made of aramid fibers and a second resin with a second melting temperature that is greater than the first melting temperature. The first plurality of ballistic resistant sheets can include about 1-10, 10-20, or 20-30 ballistic resistant sheets, and the second plurality of ballistic resistant sheets can include about 1-10, 10-20, or 20-30 ballistic sheets. In some examples, the protective cover can be made of rubber, NYLON, RAYON, ripstop NYLON, CORDURA, polyvinyl chloride, polyurethane, silicone elastomer, or fluoropolymer, and the durable side wall can be made of phenolic resin, a thermoplastic polymer (e.g. nylon, ultra high molecular weight polyethylene), a thermoplastic elastomer, or other suitable material.

Additional objects and features of the invention are introduced below in the detailed description and shown in the drawings. While multiple embodiments are disclosed, still other embodiments will become apparent to those skilled in the art from the following detailed description, which shows and describes illustrative embodiments. As will be realized, the disclosed embodiments are susceptible to modifications in various aspects, all without departing from the scope of the present disclosure. Accordingly, the drawings and detailed description are to be regarded as illustrative in nature and not restrictive.

This Summary is provided to introduce a selection of concepts in a simplified form that are further described in the Detailed Description below. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF DRAWINGS

FIG. 1 shows a process of fabricating a roll of ballistic resistant sheet material using a plurality of high performance fibers drawn from a plurality of creels.

FIG. 2 shows a process of forming a 0/90 x-ply ballistic resistant sheet from two rolls of unidirectional ballistic resistant sheet material, where a first roll of unidirectional sheet material is oriented at 90 degrees relative to a second roll of unidirectional sheet material.

FIG. 3 shows a process of forming a 0/90 x-ply ballistic resistant sheet from two unidirectional ballistic resistant sheets, the process involving applying heat and pressure to promote bonding of a first sheet of unidirectional ballistic sheet material to a second sheet of unidirectional ballistic sheet material.

FIG. 4 shows a portion of a 0/90 x-ply ballistic resistant sheet containing two unidirectional ballistic resistant sheets and two layers of film resin arranged in an alternating configuration, where a first unidirectional ballistic resistant sheet is oriented at 90 degrees relative to a second unidirectional ballistic resistant sheet.

FIG. 5 shows a carrier vest for a person, the carrier vest having a pocket containing a flexible ballistic-resistant panel (e.g. soft armor insert) positioned behind a second ballistic resistant panel that can be a rigid ballistic resistant panel (e.g. hard armor insert) or a semi-rigid ballistic resistant panel (e.g. trauma plate).

FIG. 6 shows a prior art bullet-proof vest with an edge seam of a carrier undone to expose a stack of ballistic resistant sheets fanned out with no partial or full bonding between adjacent ballistic resistant sheets.

FIG. 7A shows a process of arranging a stack of ballistic resistant sheets according to a two-dimensional pattern inside a protective cover prior to a vacuum bagging process.

FIG. 7B shows two stacks of ballistic resistant sheets, each wrapped in a protective cover material and ready for insertion into a vacuum bag sized to accommodate several flexible ballistic resistant panels during a vacuum bagging process.

FIG. 7C shows a vacuum bagging process employing a variable volume container sized to accommodate one flexible ballistic resistant panel, the variable volume container being connected to a vacuum source by a vacuum conduit.

FIG. 8 shows a carrier vest configured to receive a flexible ballistic-resistant panel (e.g. soft armor insert) positioned behind a rigid or semi-rigid ballistic resistant member (e.g. hard armor insert or trauma plate, respectively).

FIG. 9 shows a flexible ballistic resistant panel (e.g. soft armor insert) having a protective cover and shaped to fit within a front pocket of the carrier vest of FIG. 8 to protect an individual's torso from ballistic threats, the flexible ballistic resistant panel containing a stack of ballistic resistant sheets arranged according to a two-dimensional pattern that defines a perimeter shape of the panel.

FIG. 10 is one example of a cross-sectional view of the flexible ballistic resistant panel of FIG. 9 taken along section A-A, the panel containing a plurality of ballistic resistant sheets each being formed of an arrangement of fibers that define a two-dimensional pattern associated with the shape of the flexible ballistic resistant panel, the ballistic resistant sheets being stacked according to the two-dimensional pattern.

FIG. 11 is one example of a cross-sectional view of the flexible ballistic resistant panel of FIG. 9 taken along section A-A, the panel containing a stack of ballistic resistant sheets encased by a protective cover where the stack of ballistic resistant sheets includes a first plurality of ballistic resistant sheets, a second plurality of ballistic resistant sheets adjacent to the first plurality of ballistic resistant sheets, and a third plurality of ballistic resistant sheets adjacent to the second plurality of ballistic resistant sheets.

FIG. 12 is one example of a cross-sectional view of the flexible ballistic resistant panel of FIG. 9 taken along section A-A, the panel containing a stack of ballistic resistant sheets encased by a protective cover where the stack of ballistic resistant sheets includes a first plurality of ballistic resistant sheets, a second plurality of ballistic resistant sheets adjacent to the first plurality of ballistic resistant sheets, and a third plurality of ballistic resistant sheets adjacent to the second plurality of ballistic resistant sheets.

FIG. 13 is one example of a cross-sectional view of the flexible ballistic resistant panel of FIG. 9 taken along section A-A, the panel containing a stack of ballistic resistant sheets encased by a protective cover where the stack of ballistic resistant sheets includes a first plurality of ballistic resistant sheets, a second plurality of ballistic resistant sheets adjacent to the first plurality of ballistic resistant sheets, and a third plurality of ballistic resistant sheets adjacent to the second plurality of ballistic resistant sheets.

FIG. 14 is a cross-sectional view of a ballistic resistant apparatus including two flexible ballistic resistant panels, where each panel is encased by a protective cover, and the entire apparatus is encased by an outer protective cover.

FIG. 15 shows a cross-sectional view of a ballistic resistant apparatus including a first plurality of ballistic resistant sheets, a second plurality of ballistic resistant sheets, a third plurality of ballistic resistant sheets, a fourth plurality of ballistic resistant sheets, and a fifth plurality of ballistic resistant sheets.

FIG. 16 is a side cross-sectional view of a ballistic resistant apparatus including three flexible ballistic resistant panels within an outer protective cover, where each panel is also encased in its own protective cover.

FIG. 17 is a perspective view of at least two laminatable layers of material (e.g. ballistic resistant sheets) encased by a protective cover along with corresponding release layers and breather layers positioned within a variable volume container that is in an open condition in accordance with a particular embodiment of a lamination method.

FIG. 18 is a perspective view of at least two laminatable layers of material (e.g. ballistic resistant sheets) encased by a protective cover along with corresponding release layers and breather layers positioned within an evacuated variable volume container that is in a closed condition in accordance with a particular embodiment of a lamination method.

FIG. 19A is a perspective view of a closed condition of the evacuated variable volume container located within a heated enclosure or heated and pressurized enclosure, where the variable volume container contains a ballistic resistant apparatus having a protective cover over a stack of ballistic resistant sheets.

FIG. 19B is a perspective view of a closed condition of the evacuated variable volume container located within a heated enclosure or heated and pressurized enclosure, where the variable volume container contains a ballistic resistant apparatus having a stack of ballistic resistant sheets.

FIG. 20 is a perspective view of an evacuated variable volume container located in a particular configuration of a press mold having a first mold part and a second mold part.

FIG. 21 is a perspective view of the evacuated variable volume container of FIG. 20 pressed between the first mold part and the second mold part of the press mold.

FIG. 22 is a perspective view of an evacuated variable volume container located in a particular configuration of a press mold having a first mold part and a second mold part.

FIG. 23 is a perspective view of the evacuated variable volume container of FIG. 22 pressed between the first mold part and the second mold part of the press mold.

FIG. 24 is a perspective view of the closed condition of the evacuated variable volume container having reduced pressure within the variable volume container to consolidate a laminatable stack of ballistic resistant sheets to form a ballistic resistant apparatus.

FIG. 25 is a perspective view of an open condition of the variable volume container permitting removal of the ballistic resistant apparatus of FIG. 24 from the variable volume container.

FIG. 26 is a perspective view of a laminate in the form of a planar ballistic resistant apparatus produced by a laminating method, the ballistic resistant apparatus containing a stack of ballistic resistant sheets encased by a protective cover.

FIG. 27 is a perspective view of a closed condition of an evacuated variable volume container having reduced pressure within the variable volume container relative to ambient pressure, the reduce pressure sufficient to consolidate a laminatable stack of ballistic resistant sheets to form a contoured ballistic resistant apparatus.

FIG. 28 is a perspective view of an open condition of a variable volume container permitting removal of the contoured ballistic resistant apparatus of FIG. 27.

FIG. 29 is a perspective view of a laminate in the form of a contoured ballistic resistant apparatus having a hollow hemispherical shape produced by a laminating method, the contoured ballistic resistant apparatus containing a stack of ballistic resistant sheets encased by a protective cover.

FIG. 30 shows a front perspective view of a ballistic resistant apparatus having an abrasion-resistant marking formed in a top sheet of the apparatus.

FIG. 31 shows rear perspective view of the ballistic resistant apparatus of FIG. 30.

FIG. 32 shows a rear perspective view of a ballistic resistant apparatus having cushioned perimeter portions.

FIG. 33 shows a cross-sectional side view of the ballistic resistant apparatus of FIG. 32 taken along section B-B, exposing a stack of ballistic resistant sheets encased by a protective cover and a top sheet.

FIG. 34 shows a cross-sectional side view of a ballistic resistant apparatus having a stack of ballistic resistant sheets encased by a protective cover and having a top sheet adhered to an outer surface of the protective cover.

FIG. 35 shows a person wearing a bulletproof vest comprising a carrier vest and a ballistic resistant apparatus attached to the carrier vest, the ballistic resistant apparatus having an abrasion-resistant marking containing critical information about the apparatus.

FIG. 36 shows a cross-sectional side view of a ballistic resistant apparatus having a stack of ballistic resistant sheets encased by a top sheet, a durable side wall, and a protective cover, the apparatus having an abrasion-resistant marking formed therein by dye particles distributed beneath an outer surface of the top sheet.

FIG. 37 shows a cross-sectional side view of a ballistic resistant apparatus having a stack of ballistic resistant sheets encased by a top sheet, a durable side wall, and a protective cover, the apparatus also having cushioned perimeters portions.

FIG. 38 shows a method of forming an abrasion-resistant marking on a ballistic resistant apparatus according to a dye diffusion thermal transfer method, the method employing a variable volume container.

FIG. 39 shows a method of forming an abrasion-resistant marking on a ballistic resistant apparatus according to a dye diffusion thermal transfer method, the method employing a heated and pressurized enclosure.

FIG. 40 shows an exploded view of a ballistic resistant apparatus having a stack of ballistic resistant sheets configured to be encased by a combination of a protective cover, durable side wall, and a top sheet, where the top sheet has an abrasion-resistant marking formed therein, the abrasion resistant marking being formed by dye particles distributed within the top sheet by a dye diffusion thermal transfer method.

### DETAILED DESCRIPTION

Methods and systems for manufacturing ballistic resistant apparatuses with abrasion-resistant markings are described herein. The ballistic resistant apparatuses manufactured according to the methods described herein and with the systems described herein exhibit significantly better ballistic performance than existing ballistic resistant apparatuses made with similar base materials. In addition, the ballistic resistant apparatuses described herein can be lighter, thinner, easier to conceal, and less expensive to manufacture than existing panels. The ballistic resistant apparatuses described herein can be made in a reversible configuration where either side of the apparatus can serve as a strike face, thereby eliminating risk of user error. The apparatuses described herein can prevent ricochet of projectiles (which is an inherent drawback of metal armor) by, for example, encapsulating the projective through controlled delamination and energy absorption. The apparatuses described herein can experience significantly less back face deformation than existing apparatuses when exposed to an identical ballistic threat.

Methods of manufacturing the ballistic resistant apparatuses (e.g. ballistic resistant panels) described herein can involve one or more steps, including cutting ballistic resistant sheets, arranging the ballistic resistant sheets to form a stack, covering the stack of ballistic resistant sheets with a protective cover, vacuum bagging the stack of ballistic resistant sheets, heating the stack of ballistic resistant sheets, applying pressure to the stack of ballistic resistant sheets, cooling the stack of ballistic resistant sheets, trimming the protective cover, and breaking-in the ballistic panel.

The term “panel,” as used herein, can describe any three-dimensionally shaped ballistic resistant apparatus, including any flat or contoured shape, or combination thereof, having any desired perimeter shape, including a regular or irregular perimeter shape, or combination thereof. In some applications, the panel can include one or more openings for functional purposes. For example, if the panel is used within a vehicle door as vehicle armor, the panel can include an opening to accommodate a component located within the door, such as a wiring harness or door handle mechanism.

The ballistic resistant panels described herein can be capable of absorbing and dissipating energy from high-velocity impacts through one or more of the following energy-absorbing mechanisms: spall formation, tensile fiber failure, fiber de-bonding, fiber pullout, and interlayer delamination.

### Wide-Ranging Applications

The ballistic resistant apparatuses 100 described herein can be lightweight and flexible and can be used in a wide range of applications that require effective dissipation of impact energy. Applications include, but are not limited to, body armor (e.g. concealable and non-concealable bullet-proof vests and insertable ballistic-resistant panels for bullet-proof vests, such as trauma plates 105 or spall guards), vehicle armor (e.g. vehicle door inserts, firewall coverings, deployable vehicle window coverings), wall coverings, backpacks, backpack inserts, protective cases for electronic equipment, athletic equipment (e.g. helmets and chest protectors), barricades, pipeline coverings, doors, wall inserts, modular wall panels, building materials (e.g. studs, siding, molding, shingles, decking, fencing, sheeting, ceiling tiles, and floor tiles), military helmets, public speaking podiums, theater seats, removable theater seat cushions, airline seats, removable airline seat cushions, cockpit doors for aircrafts, submarine components, military tents, garments (e.g. jackets, pants, and hats), personal accessories (e.g. purses, briefcases, and messenger bags), protective cases and coverings for mobile electronic devices, mattresses, and inflatable vessels (e.g. inflatable boats and life rafts).

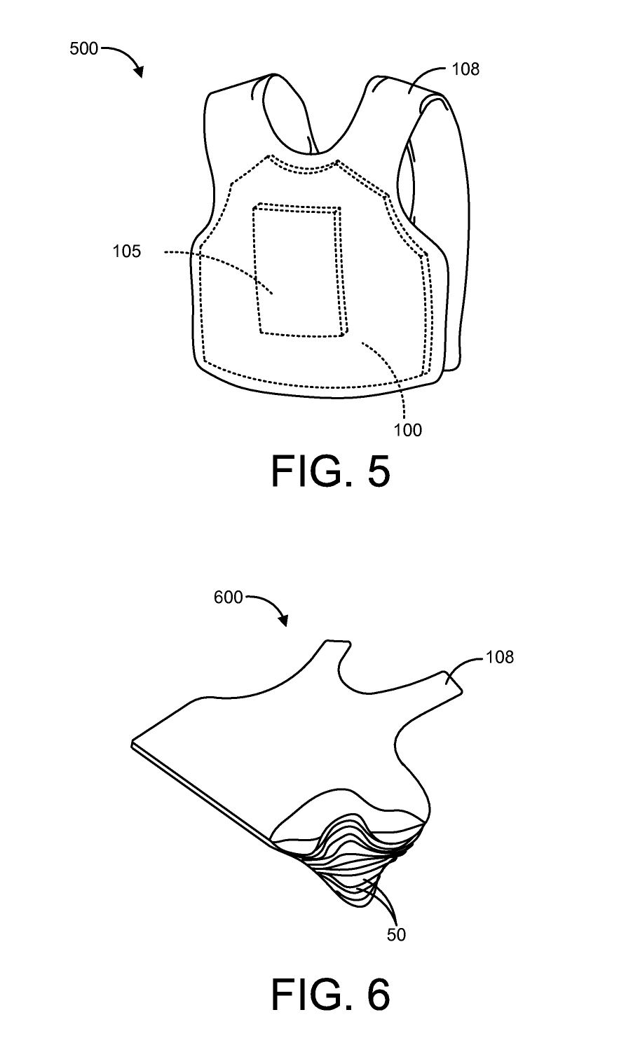

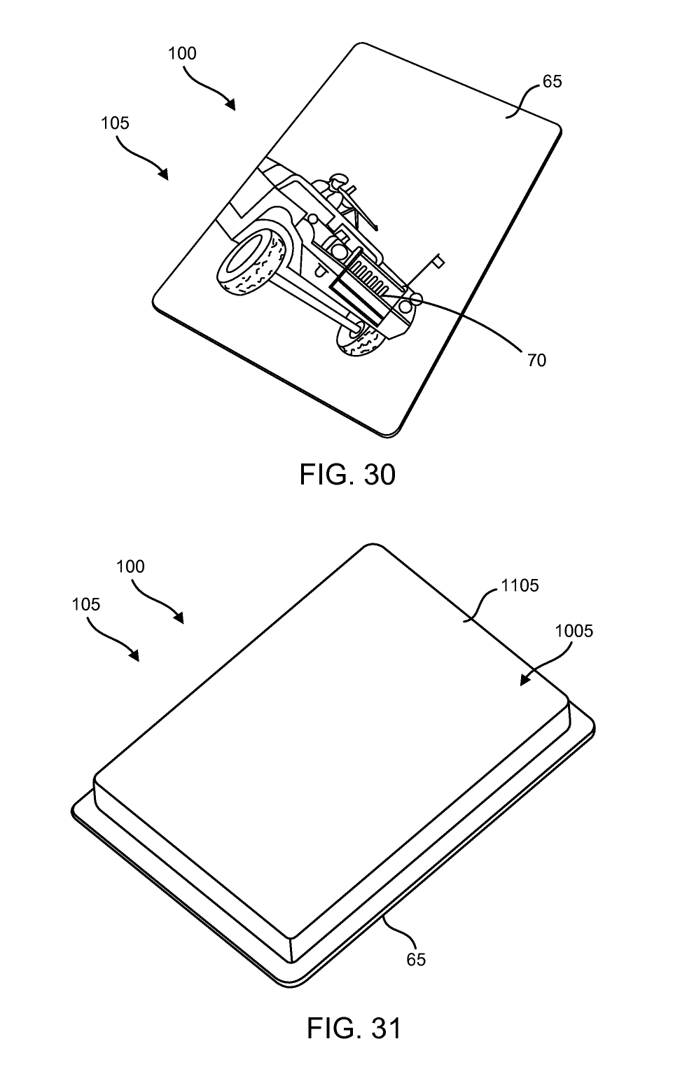

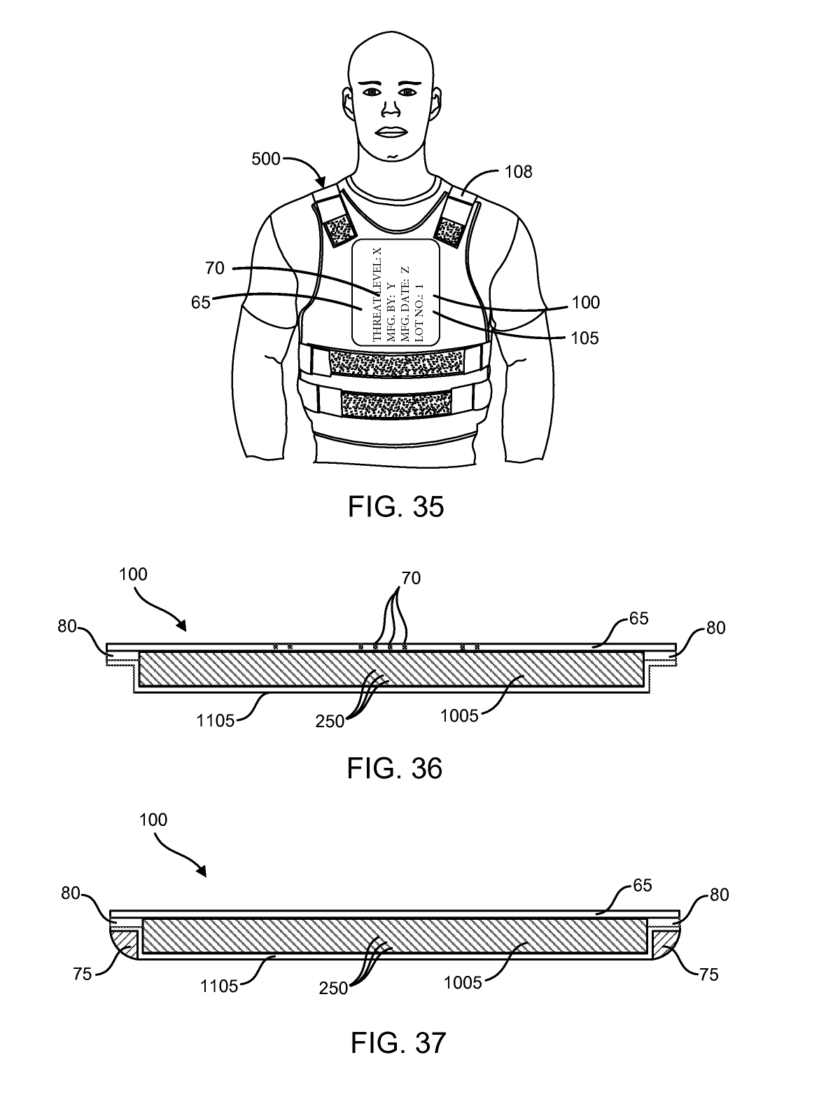

In some examples, the ballistic resistant apparatus 100 can be a trauma plate 105 that is configured to be inserted in front of or behind a first ballistic resistant apparatus 100 in a carrier vest 108, as shown in FIGS. 5 and 30-37, as part of a bulletproof vest assembly. In some examples, the trauma plate 105 can be manufactured according to the methods disclosed herein using the systems and materials disclosed herein. In some examples, the trauma plate 105 can include one or more additional material layers to bolster its threat level certification, such as a top sheet 65, and can include a marking containing critical identifying information on the top sheet 65, as discussed herein primarily with respect to FIGS. 30 and 35. The top sheet 65 can improve the stab resistance and ballistic performance of the ballistic resistant apparatus 100.

In other applications, the flexible ballistic resistant apparatuses 100 described herein can serve as spall liners in tanks and other armored vehicles to protect against, for example, the effects of high explosive squash head (HESH) anti-tank shells. Spall liners can serve as a secondary armor for occupants and equipment within an armored vehicle having a primary armor made of steel, ceramic, aluminum, or titanium. In the event of an impact or explosion proximate an outer surface of the armored vehicle, the spall liner can prevent or reduce fragmentation into the vehicle cabin, which is desirable, since fragmentation can result in fragments entering the vehicle cabin and injuring vehicle occupants. When used as a spall liner, the ballistic resistant panels 100 can be positioned between exterior steel armor plating of the military vehicle and an interior volume of the cabin of the vehicle. To provide adequate protection against spall, it may be necessary to provide a stack or assembly of ballistic resistant panels, where the stack includes one or more ballistic panels 100 in combination. The number of panels used in the assembly, may be dictated by the ballistic performance of each panel and the ballistic threat level that must be defended against.

The ballistic resistant panels 100 described herein can be incorporated into vehicle (e.g. automobile, tank, jet, helicopter) doors, floors, firewalls, roofs, and seats to protect the vehicle, occupants, equipment, and ammunitions in the vehicle from ballistic threats. Due to their low weight and low cost, the panels 100 described herein can be incorporated into consumer vehicles without significantly reducing fuel economy or increasing vehicle cost. In addition to protecting against ballistic threats, the panels 100 may improve certain aspects of crash performance of vehicles. Due to the flexibility and thinness of the panels 100, a panel can be installed within a vehicle door (e.g. a vehicle door of a police cruiser) between a door window and an outer door structure or between a door window and an inner door structure. This allows existing vehicles to be easily armored without needing to fully disassemble the doors. The flexible panel 100 can be easily inserted into a door cavity and can be contorted around door components. Due to the relatively soft nature of the panels described herein, the panels do not cause unwanted noise or vibration.

The flexible ballistic resistant panels 100 described herein can be used to protect commercial, governmental, or residential buildings (e.g. banks, homes, schools, office buildings, prisons, restaurants, laboratories, churches, and convenience stores) from ballistic threats. The panels 100 can be incorporated into walls, floors, or ceilings (e.g. in homes, banks, or law enforcement facilities). In one example, the ballistic resistant panels 100 can be incorporated into a wall and concealed by or within drywall. In this way, the panel 100 may not be easily detected and may not detract from the appearance of the wall. The panels 100 can be incorporated into manufactured (i.e. pre-made) walls that are delivered to a construction site, or the panels can be inserted into walls that are built on site. In another example, a ballistic resistant panel 100 can serve as a wall component and can include an exterior covering (e.g. drywall) that is adapted to be painted to replicate the appearance of a traditional wall in a home or office building. In this example, the ballistic panel 100 may include a structural component that supports the panel in an upright position and allows the panel to be mounted in place. In some examples, the structural component can be one or more carbon fiber layers arranged within the panel or adhered to an outer surface of the panel.

The flexible ballistic resistant panels 100 described herein can be used to cover and protect pipelines, such as petroleum or gas pipelines, from ballistic threats. In some examples, the panels 100 can be wrapped around an external surface of a pipeline and can prevent a vandal or terrorist (e.g. in a conflict zone) form piercing the pipeline by firing a bullet or other projectile at the pipeline. Some pipelines are positioned above ground and are exposed to weather. As described herein, the panel 100 can include an external cover 1105 made from a suitable waterproof material. The cover 1105 can prevent ballistic resistant sheets (e.g. 250) within the panel 100 from being damaged by rain or other forms of precipitation. The cover 1105 can be UV-resistant and can prevent sun damage as well as any performance degradation associated therewith. In one example, the panels 100 can be installed after the pipeline is in place. The panels 100 can be attached to the pipeline using any suitable fasteners, including, for example, magnets, snaps, adhesives, or external straps. The panels 100 can be interlocking using, for example, snaps, zippers, tongue and groove connectors, or hook and look fasteners, to prevent unwanted shifting of the panels after installation due to wind, which could leave portions of the pipeline exposed and vulnerable to ballistic threats.

The flexible ballistic resistant panels 100 described herein can be incorporated into vehicle tires to protect the tires from punctures caused by ballistic threats. For example, a panel 100 can be incorporated into the sidewall of a military vehicle tire to prevent against punctures caused by projectiles. The panels 100 can replace heavy and costly steel armor. In one example, the panel 100 can be attached to a sidewall of a vehicle tire and can provide a protective covering that may be removable and replaceable if damaged. In another example, the panel 100 can be integrated into the tire (e.g. disposed within the rubber compound of the tire). In this configuration, the panel 100 can protect the sidewall or the treaded surface of the tire from punctures, or ballistic threats, including projectiles (e.g. bullets) or shrapnel from blasts caused by landmines or grenades.

The flexible ballistic resistant panels 100 described herein can be incorporated into temporary or permanent barricades. Barricades are often used to divert and control traffic and pedestrians at large public gatherings or to prevent vehicles from accessing certain areas, such as military installations. To protect citizens from certain terrorist threats at public gatherings (e.g. shrapnel from an improvised explosive device), it can be desirable to incorporate ballistic panels 100, as described herein, into barricades. Due to their light weight and low cost, the panels 100 are well-suited for incorporation into a temporary barricade that is easily transported by one or more individuals and not significantly more expensive than a traditional temporary barricade.

### Methods of Manufacturing Ballistic Resistant Apparatuses

One substantial problem with conventional methods of producing a laminate can be that the layers of laminatable material are open to the environment, which allows contaminants to associate with the laminate. Also, laminatable materials, if not properly sealed, can contaminate the environment. Another substantial problem with conventional methods of producing laminates can be that the adherent material, such as an adhesive, generates gas bubbles that can become entrapped between the layers of laminatable material during production. Another substantial problem with conventional methods can be that the amount of heat and pressure applied to the laminatable materials can be insufficient to produce laminates that resist penetration and that remain laminated for a desired amount of time, such as more than one year.

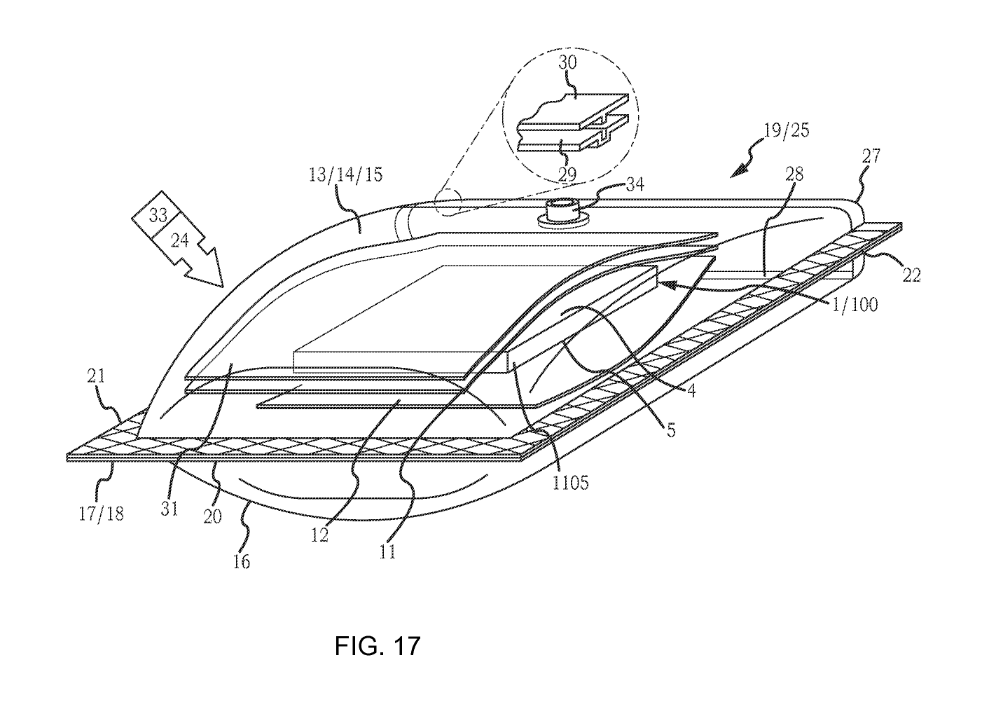

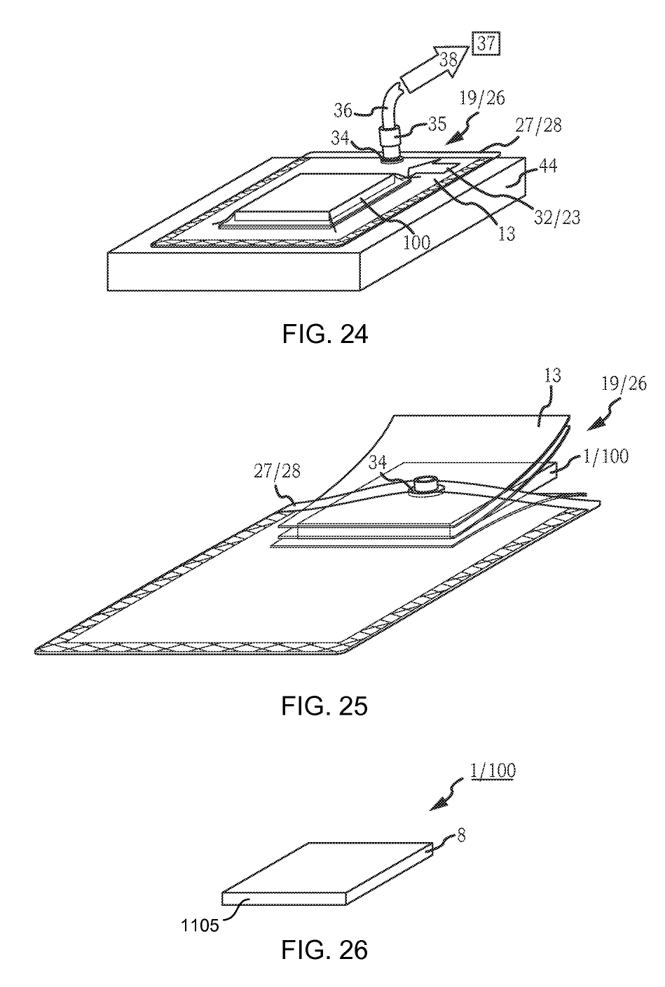

Generally referring to FIGS. 17-29, and the description below, a lamination system including an apparatus and methods for producing a laminate 1, such as a ballistic resistant apparatus 100 made of a plurality of ballistic sheets (e.g. 250), is shown and described. For the purposes of this method, the term “laminate” means a material constructed by uniting two or more layers of laminatable material 2 (where “laminatable material” can include ballistic resistant sheets (e.g. 250), adhesive sheets, and a protective cover 1105) together in accordance with one or more steps of the lamination method as shown in the figures and described below. The laminate 1 produced by the lamination method can take a wide variety of configurations from substantially planar forms (as shown by way of example in FIGS. 9 and 26) to non-planar contoured forms (as shown by way of example in FIG. 29) depending on the application.

In some examples, the laminate 1 can be a ballistic resistant apparatus 100 including a plurality of ballistic resistant sheets 250 arranged in a stack 1005 where at least two or more of the ballistic resistant sheets are at least partially laminated to each other. In other examples, the laminate 1 can be a ballistic resistant apparatus 100 including a plurality of ballistic resistant sheets 250 arranged in a stack 1005 where all or nearly all of the ballistic resistant sheets are partially laminated to neighboring ballistic sheets in the stack. In still other examples, the laminate 1 can be a ballistic resistant apparatus 100 including a plurality of ballistic resistant sheets 250 arranged in a stack 1005 where all or nearly all of the ballistic resistant sheets are fully laminated to neighboring ballistic sheets in the stack. In still other examples, the laminate 1 can be a ballistic resistant apparatus 100 including a stack 1005 of ballistic resistant sheets 250, the stack including a first plurality of ballistic resistant sheets 250 arranged in a first stack where all or nearly all of the ballistic resistant sheets are fully laminated to neighboring ballistic sheets in the first stack and a second plurality of ballistic resistant 250 sheets arranged in a second stack where all or nearly all of the ballistic resistant sheets are not laminated or only partially laminated to neighboring ballistic sheets in the second stack.

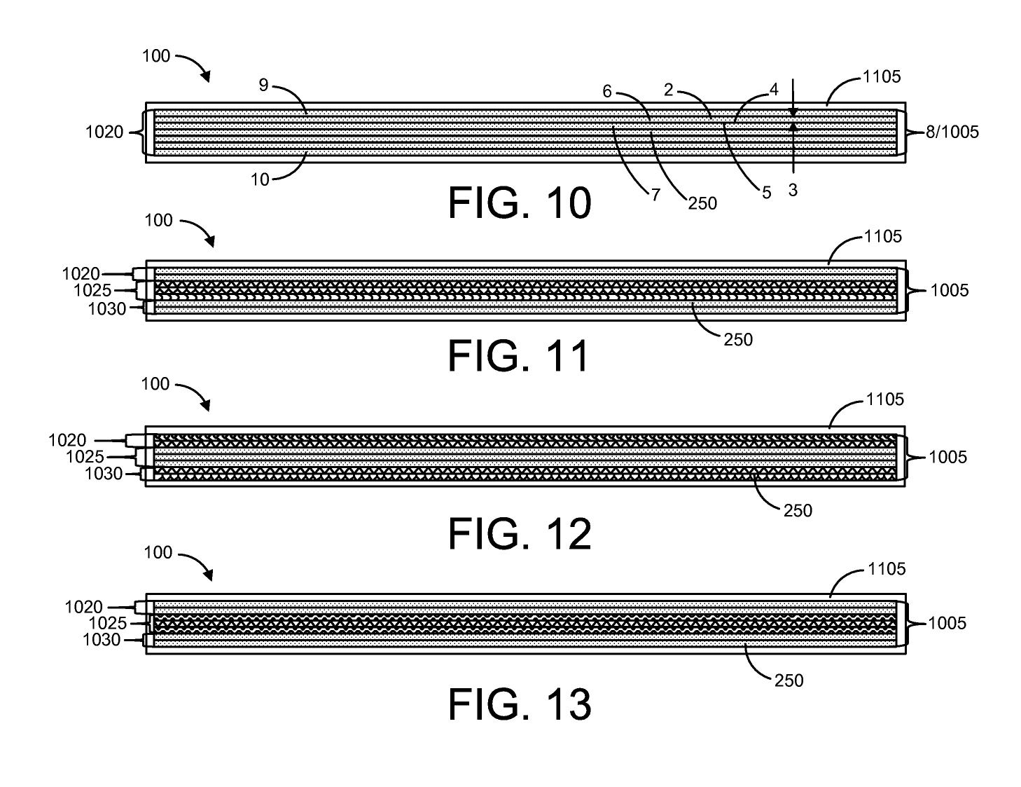

Now referring primarily to FIGS. 10 and 17, the lamination method can include the step of obtaining or stacking at least two layers of laminatable material 2, such as two or more ballistic resistant sheets (e.g. 0/09 x-ply ballistic resistant sheets 250), which can be united by the application of sufficient amounts of heat and pressure by way of the methods described herein. Any number of layers of laminatable material 2 can be utilized with the method depending upon the application (e.g. depending on the object to be protected and the anticipated threat level). The layers of laminatable material 2 can be in the form of sheets, such as ballistic-resistant sheets 250, which can be obtained as woven or non-woven materials, or the like. As examples, the layers of laminatable materials 2 can include ballistic resistant sheet material woven from ultra-high molecular weight polyethylene (e.g. DYNEEMA or SPECTRA), aramid fibers (e.g. KEVLAR fibers), polypropylene (e.g. INNEGRA available from Innegra Technologies), fiberglass (e.g. s-glass, e-glass), or other high performance fibers, or sheets made of boron carbide, silicon carbide, alumina, alumina titanium, carbon fiber, other materials described herein, or the like.

Each of the layers of laminatable material 2 can have a thickness 3 disposed between a first side 4 and a second side 5, as shown in FIG. 10. The at least two layers of laminatable material 2 can be stacked to engage the first side 4 of a first layer of laminatable material 6 against the second side 5 of a second layer of laminatable material 7 and repeated until the number of layers of laminatable material 2 are sufficient to form a stack 1005 of layers that is suitable for the particular application. The stacked layers of laminatable material 2, also referred to as a laminatable stack 8 herein, have a top layer of laminatable material 9 and a bottom layer of laminatable material 10 effectively bounding the stack and serving as a top surface and a bottom surface of the stack, as shown in FIG. 10.

An amount of adherent material 48 (e.g. a resin) can be disposed between the layers of laminatable material 2 (e.g. between the ballistic resistant sheets (50, 55) shown in FIG. 4) or applied to a surface of the layers of laminatable material. The amount of resin 48 can be provided as a separate material (e.g. sprayed, applied, or provided as a sheet) or the layers of laminatable material 2 can be pre-impregnated with the amount of resin 48 through an impregnation process during manufacturing of the laminatable material. The resin 48 can be any one or a combination of resins. Examples of resins 48 useful in bonding the layers of the laminatable material 2, include phenolic, epoxy, polyethylene terephthalate, vinylester, polyimides, bis(maleimide/diallybisphenol A, cyanate esters, thermoplastics, polypropylene, nylon, other resins identified herein, or the like.

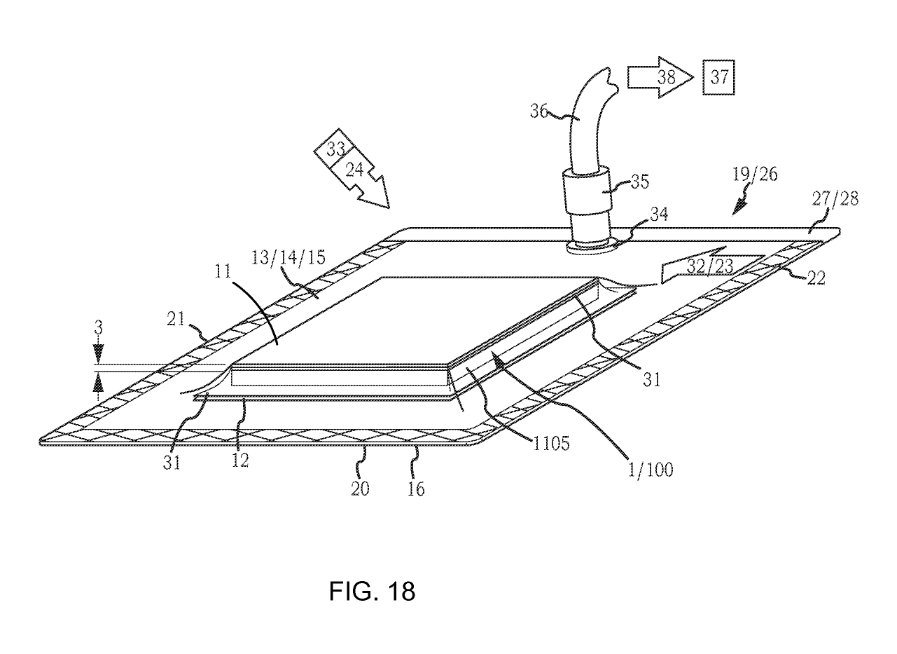

In another step, the method can include providing a variable volume container 13 having at least one flexible side wall 14, as shown in FIG. 17. The variable volume container 13 can, for example, take the constructional form of two superimposed sheets of flexible material 15,16 having superimposed edges 17, 18 that can at least in part be permanently sealed to provide as the remaining part of the superimposed edges 17, 18 a sealable or releasably sealable opening element 19. In some examples, the variable volume container 13 can be a vacuum bag. As shown by FIG. 17, as one example, the two superimposed sheets of flexible material 15, 16 can be permanently sealed along three superimposed edges 17, 18 (e.g. the bottom edge 20 and two side edges 21, 22) to provide the sealable opening element 19 that allows access to the inside of the variable volume container 13. As used herein, “permanently sealed” means that these edges are not intended to be opened during use of the variable volume container 13, and are not releasably sealable and are sufficiently sealed to allow retention of a vacuum pressure 23 within the variable volume container 13. The vacuum pressure 23 being lower pressure relative to atmospheric pressure, as further described below. Any method known to those of skill in the art, such as heat sealing, can be use to create the permanently sealed portion of the superimposed edges 17, 18 of the variable volume container 13. Variable volume containers 13 including more than two superimposed sheets of material 15, 16 can also be used to facilitate the method described herein. The variable volume container 13 can have a configuration that has any suitable shape, such as square or rectangular, as shown in the example of FIGS. 17 and 18, and can operate between an open condition 25 shown in FIG. 17 and a closed condition 26 shown in FIG. 18. The variable volume container 13 can be produced from any material compatible with the pressure and temperature applied to the laminatable stack 8 to consolidate a laminate 1 to produce a ballistic resistant apparatus 100.

As to particular non-limiting embodiments of the method, the sealable opening element 19 can permit use of a pressure sensitive adhesive 27 coupled to the superimposed edge(s) 17, 18 that are not permanently sealed. The pressure sensitive adhesive 27 can be protected from inadvertent adherence. The phrase “protected from inadvertent adherence” means that the pressure sensitive adhesive 27 bearing superimposed edge 17 does not prematurely stick to a target surface 28 of the other superimposed edge 18 or to another portion of the superimposed sheets of flexible material 15, 16, or to any other surface, until activation of the pressure sensitive adhesive 27 by pressing the pressure sensitive adhesive 27 against the opposed target surface 29. Pressing the pressure sensitive adhesive 27 against the opposed target surface 29 results in a releasable seal generating the closed condition 26 of the variable volume container 13, as shown in FIG. 18.

In some embodiments of the method, the sealable opening element 19 can provide use of a groove element 29 that can be mated with a groove-engaging element 30, as shown in FIG. 18. Pressing the groove-engaging element 30 into the groove element 29 can releasably seal to generate the closed condition 26 of the variable volume container 13. Any method known to those of skill in the art that allows the opening element 19 to be sealed either releasably such as with a pressure sensitive adhesive 27 or a groove-engaging element 30 into a groove element 29, or permanently such as heat-sealing, can be used to generate the closed condition 26 of the variable volume container 13. It is to be understood that the closed condition 13 of the variable volume container 13 can be generated by the use of any method of sealing that allows retention of a vacuum pressure 23 within the variable volume container 13 relative to atmospheric pressure, as further described below.

In another step, the method can, but does not necessarily, further include engaging a first release layer 11 with the bottom layer of the ballistic resistant apparatus 100. The first release layer 11 can provide an interface that prevents contact between the bottom surface of the apparatus 100 and other the surfaces of other materials during subsequent steps in the lamination method. Certain embodiments may not include a first release layer 11 engaged with the bottom surface of the apparatus 100 or can include a first release layer 11 engaged with a second release layer 12 engaged with the first release layer 11. In other examples, any number of release layers can be utilized depending upon the embodiment or application.

In another step, embodiments of the method can further include engaging a first release layer 11 with the bottom surface of the apparatus 100, and the second release layer 12 with the top surface of the apparatus. The second release layer 12 can provide an interface that prevents contact between the between the top layer of laminatable material 9, or laminate 1, and other the surfaces of other materials during subsequent steps in the lamination method. Certain embodiments of the method may not include a first release layer 11 or second release layer 12 correspondingly engaged with the top or bottom surfaces of the apparatus 100. In other examples, any number of release layers 11 can be utilized depending upon the embodiment or application. The composition of the second release layer 12 may be selected depending on the composition of the top surface of the apparatus 100 engaged by the second release layer 12. Because the top surface of the apparatus 100 can be different than the bottom surface of the apparatus, the first release layer 11 and the second release layer 12 can be, but are not necessarily, different in composition.

The term “release layer” includes any type of material that can be engaged to the bottom surface of the apparatus 100 or the top surface of the apparatus 100 during the lamination method for the production of the laminate 1 and can be subsequently removed from the laminate 1 without a substantial amount of the release layer 11, 12 remaining engaged with the apparatus upon completion of the method. The composition of the first release layer 11 can be selected depending on the composition of the bottom surface of the apparatus 100 engaged by the first release layer 11. As examples, the first release layer 11 (or second release layer 12, or a plurality of release layers) can include a fluorocarbon such as TEFLON, polytetrafluoroethylene coated fiberglass or silicon treated nylon 66, such as PEEL-PLY available from Airtech International, Inc., steel, aluminum, silicon, latex, rubber, or the like.

The method can include the step of inserting the laminatable stack 8 having a top surface and a bottom surface, correspondingly engaged to the first release layer 11 and the second release layer 12 inside of the variable volume container 13.

In another step, the method can include inserting at least one breather layer 31 between a) the at least one flexible wall 14 of the variable volume container 13 and the first release layer 11 (as shown in FIGS. 17 and 18), and/or b) between the at least one flexible wall 14 and the second release layer 12 (as shown in FIGS. 17 and 18). As to certain embodiments, the breather layer 31 can be used without a first release layer 11, or without the second release layer 12, or without either, depending on the type of breather layer 31 and the type of layers of laminatable material 2 or adherent material 48.

As used herein, the term “breather layer” means a layer of material sufficiently porous and of sufficient dimensional configuration to allow or assist in transfer of gases 32 from within the variable volume container 13 to outside the variable volume container through a vacuum conduit 36 in response to vacuum pressure 23 applied to the variable volume container 13. The vacuum pressure 23, typically applied at the interface between the at least one flexible wall 14 and the breather layer 31 that is correspondingly engaged with the first release layer 11 or second release layer 12, each correspondingly engaged to the laminatable stack 8, as shown in the example of FIG. 17. Various types of breather layers 31 are described for example in U.S. Pat. Nos. 3,666,600; 4,062,917; 4,216,047; 4,353,855; and 4,548,859, each of which is hereby incorporated by reference in its entirety.

Now referring to FIG. 18, the method can further include a step of sealing the sealable opening element 19 to generate the closed condition 26 of the variable volume container 13. Again referring to FIG. 18, the method can further include the step of evacuating gases 32 from inside the variable volume container 13. As used herein, the term “gases” means the gases held within the closed condition 32 of the variable volume container 13, which can include a mixture of gases, including atmospheric gases 33 trapped within the variable volume container 13 by achieving the closed condition 26 of the variable volume container 13 along with gases produced or released by the laminatable stack of ballistic sheets 8, the first release layer 11, the second release layer 12, the breather layer 31, the adherent material 48, the variable volume container 13, or otherwise, while at room temperature or at elevated temperatures as further described below, or due to achieving the vacuum pressure 23 inside of the variable volume container 13, as further described below. For the purposes of this method, the phrase “evacuating gases” means reducing pressure of the gas(es) 32 inside of the variable volume container 13 regardless of the process or equipment used to evacuate the gas(es). As shown in the non-limiting example of FIG. 18, the variable volume container 13 can include an evacuation element 34 through which an amount of the gas(es) 32 contained inside of the variable volume container 13 can flow from inside the variable volume container 13 to a location outside of the variable volume container 13. The evacuation element 34 can have a configuration mateable with a terminal fitting 35 of a vacuum conduit 36, as shown in the examples of FIGS. 18-20. A vacuum generator 37 can generate a vacuum 38 within the vacuum conduit 36, which can be fluidly coupled with the gases 32 inside of the variable volume container 13 by engaging the terminal fitting 35 of the vacuum conduit 36 to the evacuation element 34 of the variable volume container 13. A vacuum pressure 23 within the variable volume container 13 can remove the gases 32 within the variable volume container 13. Regardless of the form of the vacuum source, the resulting vacuum pressure 23 in the variable volume container 13 can be less than atmospheric pressure in the range of about 750 Torr to about 10 Torr. Achieving a vacuum pressure 23 in the variable volume container 13 can be permit gases 32 contained in, or released by, layers of the ballistic resistant apparatus 100 to be evacuated from the variable volume container 13 prior to subsequent steps in the lamination method, especially upon heating the laminatable stack 8, as further described below. By releasing gases contained in the apparatus 100 relatively early in the lamination method, and by drawing those gases out of the variable volume container 13 by way of the vacuum conduit 36, laminates 1 with better ballistic performance and/or higher surface quality can be produced.

Again primarily referring to FIG. 18, in another step, the method can further include reducing the volume of the variable volume container 13 in response to the vacuum pressure 23 inside of the variable volume container 13. In the particular embodiment of the lamination method shown in FIG. 18, the two superimposed sheets of flexible material (16, 17), or at least one flexible wall 14, of the variable volume container 13 can be drawn against the ballistic resistant apparatus 100 and associated first release layer 11 and second release layer 12, depending upon the embodiment, which can in part compressingly engage the layers of the apparatus together.

As to certain embodiments, the method can further include the step of sealing the evacuation element 34 to retain the vacuum pressure 23 inside of the variable volume container 13, and uncoupling the terminal fitting 35 of the vacuum conduit 36 from the evacuation element 34 of the variable volume container 13. Typically, however, the vacuum 38 will be continuously applied to maintain the vacuum pressure 23 inside of the variable volume container 13 to remove gases 32, including mixtures of gases generated by curing resins (e.g. 160) within the stack 1005 of ballistic sheets during a heating step, as discussed below.

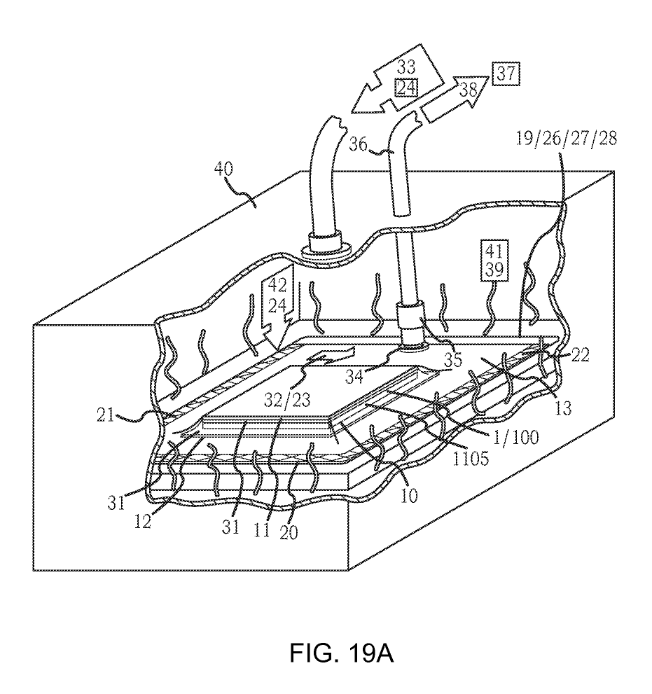

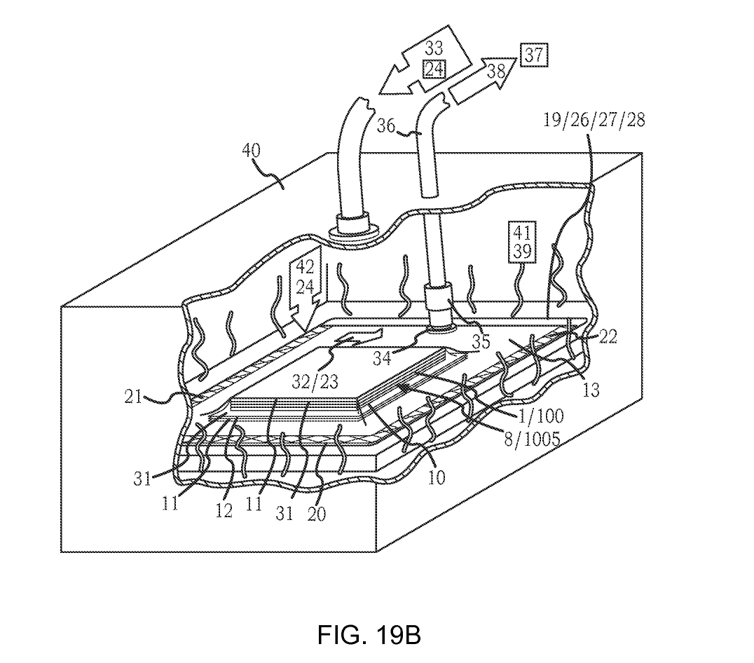

Now referring primarily to FIGS. 19A-B, the method can further include the step of heating the laminatable stack 8 outside of or within the variable volume container 13 to produce a ballistic resistant apparatus 100. As to certain embodiments, the stack of ballistic sheets 8 can be heated within the variable volume container 13. As to certain embodiments of the method, the heating step can be achieved during continuous evacuation of the variable volume container 13 to continuously maintain the vacuum pressure 23 inside of the variable volume container 13 at the vacuum pressure 23 described herein regardless of the mode of operation of the vacuum generator 37. The evacuated variable volume container 13 containing the stack of ballistic sheets 8 can be sufficiently heated to allow consolidation of the stack of ballistic resistant sheets 8, thereby producing a ballistic resistant apparatus 100.

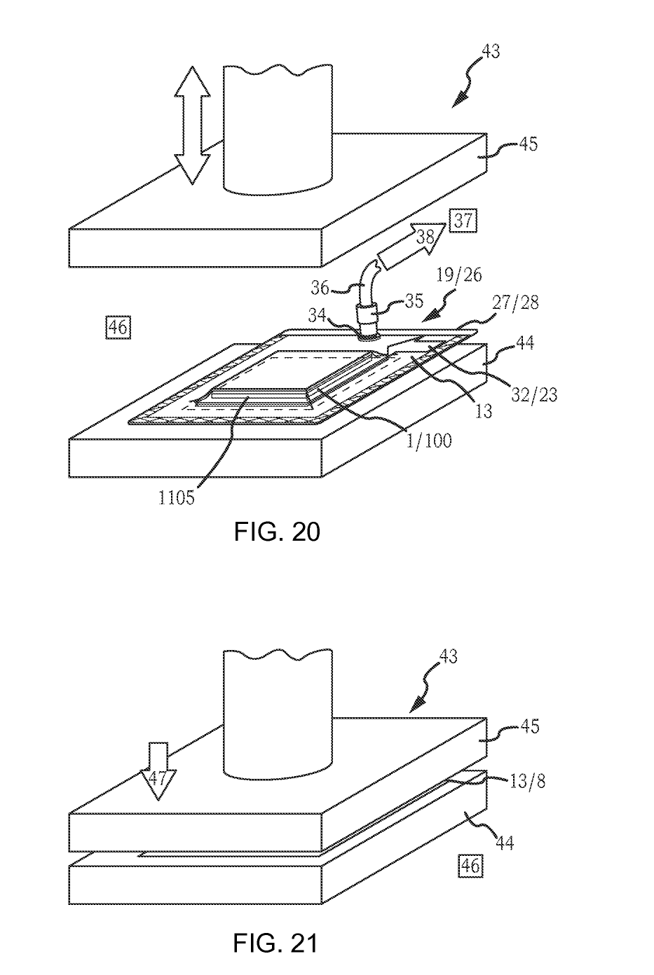

In some examples, as shown in FIGS. 20-23, the consolidated assembly of ballistic resistant sheets (e.g. 250) can be placed in a press mold and pressed to produce a three-dimensional ballistic resistant apparatus 100 while the consolidated assembly is still at an elevated temperature and prior to solidifying and hardening of melted adhesives or resins within the assembly.

The term “consolidation” means sufficient adherence between the at least two layers of laminatable material 2 (e.g. ballistic resistant sheets) to allow production of a laminate 1. Typically, the at least two layers of laminatable material 2, once consolidated, will be substantially inseparable. The temperature 39 of the variable volume container 13 can be varied depending on a wide variety of lamination factors, such as, but not limited to: the composition, number, thickness, size, porosity, or other factors as to the at least two layers of laminatable material 2; or the vacuum pressure 23, atmospheric pressure 24, mold pressure, mold temperature, or other factors affecting the lamination process. The temperature 39 of the at least two layers of laminatable material 2, or the laminatable stack 8, can be in the range of about 10 degrees Celsius (“C.”) to about 400° C. depending on the above described factors.

Regardless of the heat source, a wide variety of laminates 1 can be produced where the temperature is selected from the group including or consisting of: between about 10° C. and about 50° C., between about 25° C. and about 75° C., between about 50° C. and about 100° C., between about 75° C. and about 125° C., between about 100° C. and about 150° C., between about 125° C. and about 170° C., between about 150° C. and about 200° C., between about 175° C. and about 225° C., between about 200° C. and about 250° C., between about 225° C. and about 275° C., between about 250° C. and about 300° C., between about 275° C. and about 325° C., between about 300° C. and about 350° C., between about 325° C. and about 375° C., and between about 350° C. and about 400° C.

Again referring to FIGS. 19A-B, as to certain embodiments of the lamination method for producing a ballistic resistant apparatus 100, heating of the evacuated variable volume container 13 and the laminatable stack 8 contained inside of the variable volume container 13 can be achieved by locating the evacuated variable volume container 13 inside of a heated enclosure 40, such as an oven, autoclave, or hydroclave, capable of maintaining a constant temperature 39 or generating a temperature gradient 41 (i.e. pre-selected change(s) in temperature over a period of time that can be implemented manually or automatically, such as by mechanical or computer control) to heat the evacuated variable volume container 13, including the laminatable stack 8 or laminate 1, through a temperature gradient 41 or to a particular predetermined temperature 39.

Again referring primarily to FIGS. 19A-B, the lamination method for producing a ballistic resistant apparatus 100 can further include the step of increasing pressure of the atmosphere gases 33 about the external surface of the evacuated variable volume container 13 while the laminatable stack 8 and, optionally, one or more release layers 11,12 and breather layer 31 are within the variable volume container. As to certain embodiments of the lamination method, the step of increasing pressure of the atmosphere gases 33 about the external surface of the evacuated variable volume container 13 can be achieved during continuous evacuation of the variable volume container 13 to continuously maintain the vacuum pressure 23 inside of the variable volume container 13, regardless of the mode of operation of the vacuum generator 37. Increasing the pressure of the atmospheric gases 33 can be achieved with any suitable pressure source, such as an air compressor fluidly connected to the heated enclosure 40 to provide a pressurized heated enclosure 42, as shown in FIGS. 19A-B.

The evacuated variable volume container 13 containing the laminatable stack 8 can be sufficiently externally pressurized to urge the at least two layers of laminatable material 2 (e.g. ballistic resistant sheets 250) against one another to facilitate consolidation for production of the laminate 1 or to prepare the laminate 1 for press molding. The pressure of the atmospheric gases 33 in contact with the external surface of the variable volume container 13 can be varied depending on a wide variety of lamination factors, such as, but not limited to, the composition, number, thickness, size, porosity, or other factors as to the at least two layers of laminatable material 2; or the vacuum pressure 23, atmospheric pressure 24, mold pressure, mold temperature, or other factors affecting the lamination process. The pressure of the atmosphere gases 33 in contact with the external surface of the variable volume container 13 can be in the range of about 15 pounds per square inch (“psi”) to about 50,000 psi depending on the above-described factors.

Again referring to FIGS. 19A-B, as to certain embodiments of the lamination method for producing a ballistic resistant apparatus 100, the step of increasing pressure of the atmosphere gases 33 about the external surface of the evacuated variable volume container 13, and the step of heating of the evacuated variable volume container 13 and the laminatable stack 8 (or laminate 1) contained inside, can be achieved by locating the evacuated variable volume container 13 inside of a pressurized heated enclosure 42, such as an oven, autoclave, or hydroclave capable of maintaining a constant external pressure 24 at a constant temperature 39 or generating a pressure gradient 42 or a temperature gradient 41 (pre-selected change(s) in the pressure or temperature, or both, over a period of time), which can be implemented automatically (by mechanical or computer implemented means) or manually to pressurize and heat the evacuated variable volume container 13, including the laminatable stack 8, according to either the pressure gradient 42, the temperature gradient 41, a particular external pressure 24, a particular temperature 39, or combination thereof.

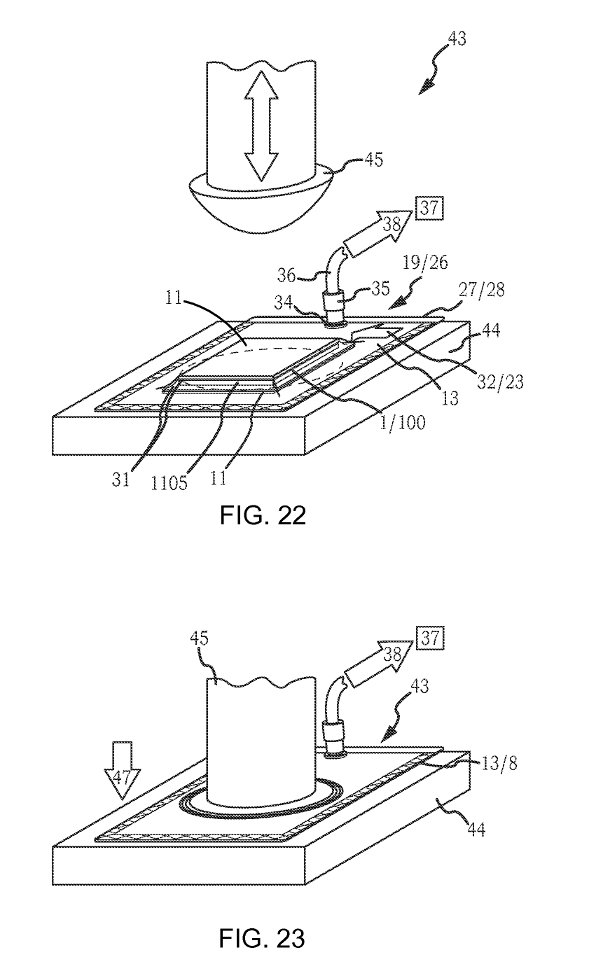

Now referring to FIGS. 20-23, in some examples, the lamination method can further include the step of placing the laminatable stack 8 (or laminate 1) in a press mold 43. The press mold 43 can have a first mold part 44 configured to mate with a second mold part 45. The first mold part 44 and the second mold part 45 can take a numerous and wide variety of configurations. As one example, the portions of the first mold part 44 and the second mold part 45 can be substantially flat as shown in the example of FIGS. 20 and 21. As a second example, the first mold part 44 (e.g. female mold part) can be recessed or provide a receding or hollow portion while the second mold part 45 (e.g. male mold part) can be correspondingly mateably raised as shown in the example of FIGS. 22 and 23. While FIG. 22 shows a first mold part 44 that provides a recessed hemisphere and a second mold part 45 that provides a corresponding mateable raised hemisphere, the method is not so limited, and any manner of corresponding mateable recessed and raised mold parts 44, 45 useful in producing a correspondingly configured laminate 1 can be utilized. Additionally, an advantage of the lamination method can be that the first mold part 44 and the second mold part 45 can be utilized at ambient temperature 46 and do not require heating prior to placing in the press mold 43 the variable volume container 13 having within it the heated evacuated laminatable stack 8 along with the associated release layers (11, 12) and breather layers 31 for subsequent production of the laminate 1. However, this advantage is not intended to preclude embodiments of the method that use preheated press molds 43.

To place the laminatable stack 8 (or laminate 1) in the press mold 43, the first mold part 44 and the second mold part 45 can be disposed a sufficient distance apart to allow the laminatable stack 8 to be placed between the first mold part 44 and the second mold part 45, as shown in FIGS. 20 and 22. As to certain embodiments of the method, the laminatable stack 8 along with the associated first release layer 11, second release layer 12, and breather layer 31 can be place in the evacuated variable volume container 13, which can then be placed in the press mold 43. As to other embodiments of the method, the step of placing the laminatable stack 8 in the press mold 43 can be achieved during continuous evacuation of the variable volume container 13 to continuously maintain the vacuum pressure 23 inside of the variable volume container 13 at the vacuum pressure 23 described herein regardless of the mode of operation of the vacuum generator 37.

Now referring primarily to FIGS. 21 and 23, the lamination method for producing a ballistic resistant apparatus 100 can further include the step of press molding the heated laminatable stack 8 contained within the evacuated variable volume container 13 between the first mold part 44 and the second mold part 45. Press molding can include moving the first mold part 44 and the second mold part 45 to exert sufficient mold pressure 47 on external surfaces of the evacuated variable volume container 13 containing the heated laminatable stack 8 to assist in consolidating the at least two layers 2 to produce the ballistic resistant apparatus 100 (the laminate 1). The laminate 1 resulting from the press molding can remain contained within the evacuated variable volume container 13. The amount of mold pressure 47 transferred to the heated laminatable stack 8 (or heated one or more layers of laminate 1) within the evacuated variable volume container 13 can be sufficient to consolidate the at least two layers of laminatable material 2 over a period of time. When utilizing pre-consolidated laminate 1 prepared by the method described herein, or by any other method, there can be an advantage in applying heat and pressure to the laminate 1 to further consolidate, maintain consolidation, or reduce loss of consolidation, which can maintain or increase advantageous properties of the laminate, such as tensile and/or compressive strength, ballistic performance, puncture resistance, resistance to delamination, or the like.

While the amount of mold pressure 47 utilized depends upon the lamination factors or the mold factors above described, the amount of mold pressure 47 exerted on the heated laminatable stack 8 within the evacuated variable volume container 13 to consolidate the at least two layers of laminatable material 2 (or mold the laminate 1) can be greater than 100 psi, greater than 500 psi, greater than 1,500 psi, greater than 3,000 psi, or can be in the range of about 3,000 psi to about 10,000 psi. In particular, as to those embodiments of the which use a press mold 43 at ambient temperature, the mold pressure 47 transferred to the laminatable stack 8 (or the laminate 1) can be sufficient to consolidate the heated laminatable stack 8 (or mold the laminate 1 without loss of the advantageous properties described herein) within the evacuated variable volume container 13, which can occur in a wide range of between about 15 psi and about 50,000 psi. In regard to certain methods, increased resistance of the laminate 1 to penetration or stab can be achieved with increased pressure of between about 75 psi and about 250 psi. Certain embodiment of the method can be performed at between 1,500 psi and about 50,000 psi. The period of time in which the amount of pressure is applied to the laminatable stack 8 can be as little as about one second, and there is no upper limit as to the amount of time that can be used to consolidate the laminatable stack 8.

A pressure source can apply pressure to the laminatable stack 8 by way of vacuum pressure 23 within the variable volume container 13, by way of external pressure 24 of atmospheric gases 33 in contact with the external surface of the variable volume container 13, by way of a press or press mold 43, or a combination thereof. The pressure applied by the pressure source can be selected from one or more of the pressures included in or selected from the group consisting of: between about 15 pounds per square inch and about 75 pounds per square inch, between about 50 pounds per square inch and about 150 pounds per square inch, between about 75 pounds per square inch and about 250 pounds per square inch, between about 200 pounds per square inch and about 1000 pounds per square inch, between about 500 pounds per square inch and about 1,500 pounds per square inch, between about 1,000 pounds per square inch and about 3,000 pounds per square inch, between about 2,000 pounds per square inch and about 4,000 pounds per square inch, between about 3,000 pounds per square inch and about 5,000 pounds per square inch, between about 4,000 pounds per square inch and about 6,000 pounds per square inch, between about 5,000 pounds per square inch and about 7,000 pounds per square inch, between about 6,000 pounds per square inch and about 8,000 pounds per square inch, between about 7,000 pounds per square inch and about 9000 pounds per square inch, between about 8,000 pounds per square inch and about 10,000 pounds per square inch, between about 9,000 pounds per square inch and about 20,000 pounds per square inch, between about 15,000 pounds per square inch and about 25,000 pounds per square inch, between about 20,000 pounds per square inch and about 30,000 pounds per square inch, between about 25,000 pounds per square inch and about 35,000 pounds per square inch, between about 30,000 pounds per square inch and about 40,000 pounds per square inch, between about 35,000 pounds per square inch and about 45,000 pounds per square inch, and between and about 40,000 pounds per square inch and about 50,000 pounds per square inch.

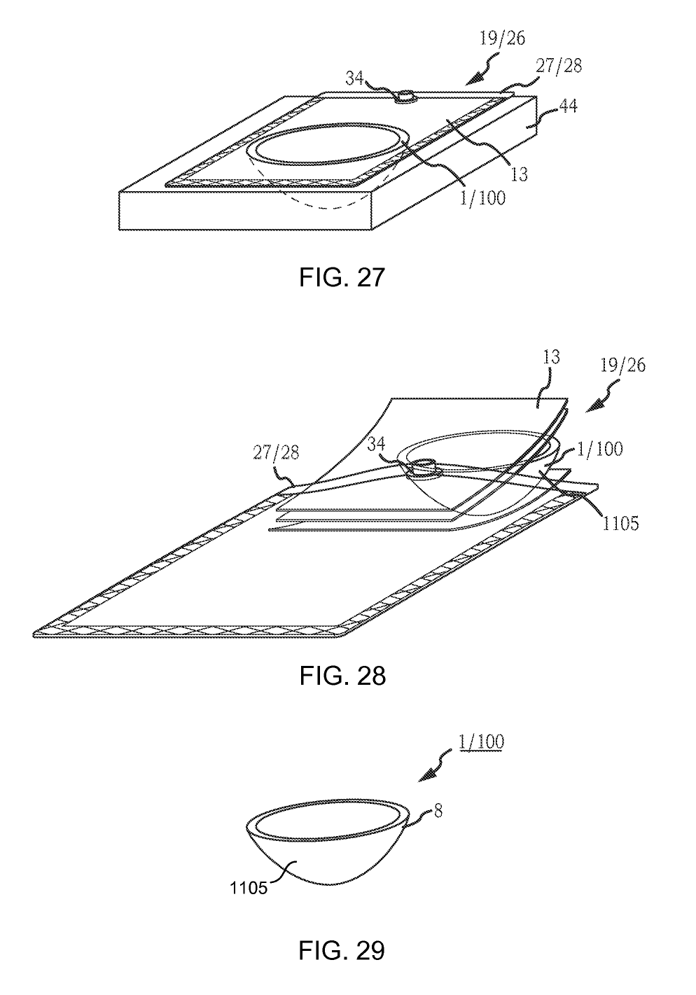

In some examples, the lamination method for producing a contoured ballistic resistant apparatus 100 may not include applying pressure to a laminate 1 located between a first mold part 44 and a second mold part 45 of a press mold 43. Instead, a contoured ballistic resistant apparatus 100 can be produced using vacuum pressure 23 and a first mold part with a recess and/or contour, similar to the first mold part 44 shown in FIG. 27. In one example, a release layer 11 can be provided over the recessed and/or contoured surface of the first mold part 44. A breather layer 31 can then be provided over the surface of the release layer 11. The laminatable layers 2 of the laminate 1 can be provided over the breather layer 31. If needed, a second breather layer 31 can be provided over the laminatable layers 2 of the laminate 1, and a second release layer 12 can be provided over the second breather layer 31. A sheet of vacuum bag material 1310 can then be provided over the second release layer 12. A perimeter of the sheet of vacuum bag material 1310 can be sealed directly to the surface of the first mold part 13 using an adhesive to form a variable volume container 13, where a first surface of the container 13 is a flexible wall 14 and a second surface of the container 13 is a rigid wall. Gas within the variable volume container 13 can be evacuated as described herein by a vacuum conduit 36 connected to a vacuum generator 37. As gas is evacuated from the variable volume container 13, the flexible wall 14 of the variable volume container urges the layers of laminatable material 2 to conform to the recess and/or contour of the first mold part 44. As heat is applied, the layers of laminatable material 2 consolidate to form a contoured ballistic resistant apparatus 100 as shown, for example, in FIG. 29. In some examples, the first mold part 44 can be located in the heated pressurized enclosure 42 during the process, and additional external pressure 23 and heat can be applied to the external surface of the variable volume container 13 to promote consolidation of the layers of laminatable material 2 to form a contoured ballistic resistant apparatus 100 as shown, for example, in FIG. 29.

Referring to FIGS. 25 and 28, the lamination method can include the step of removing the laminate 1 (ballistic resistant apparatus 100) from the variable volume container 13. Removal of the laminate 1 can include the step of releasing the vacuum pressure 23 within the variable volume container 13. Release of the vacuum pressure 23 within the variable volume container 13 can be achieved as to certain embodiments of the method for disengaging the terminal fitting 35 of the vacuum conduit 36 from the evacuation element 34 to allow ingress of atmospheric gases 33 into the variable volume container 13. As to other embodiments of the method, the release of vacuum pressure 23 can be achieved by generating the open condition 25 of the variable volume container 13 by opening the sealable opening element 19. The laminate 1, along with the associated first release layer 11, second release layer 12, and breather layer 31, can be removed from the variable volume container 13.

Referring to FIGS. 25 and 28, the lamination method can include the step of removing a laminate 1 (ballistic resistant apparatus 100) contained within the evacuated variable volume container 13 from the press mold 43. Removal of the laminate 1 contained within the evacuated variable volume container 13 can be achieved by separating the first mold part 44 from the second mold part 45 to allow release of the laminate 1 contained within the evacuated variable volume container 13 from the first mold part 44 or the second mold part 45 of the press mold 43. Certain embodiments of the method can further include the step of cooling the laminate 1 contained within the evacuated variable volume container 13 for a period of time prior to removal from the press mold 43 such period of time sufficient to retain the configuration of the laminate 1 outside of the press mold 43. The lamination method can further include the steps of disengaging the breather layer(s) 31 from the laminate 1 and disengaging the release layer(s) (11, 12) from the inner surface of the variable volume container 13.

Referring primarily to FIGS. 26 and 29, the method can include the step of producing a laminate 1 (e.g. a ballistic resistant apparatus 100) by use of the lamination method. The laminate 1 can include the consolidation of the at least two layers of laminatable material 2 (e.g. at least two layers of ballistic resistant sheets) by stepwise application of any combination of the embodiments of the lamination method described above.

### Ballistic Resistant Sheet Construction

A ballistic resistant panel 100 can be made of one or more ballistic resistant sheets 50. The term “sheet,” as used herein, can describe one or more layers of any suitable material, such as a polymer, metal, fiberglass, composite material, or combination thereof. Examples of polymers include aramids, para-aramids, meta-aramids, polyolefins, and thermoplastic polyethylenes. Examples of aramids, para-aramids, or meta-aramids include NOMEX, KERMEL, KEVLAR, TWARON, NEW STAR, TECHNORA, HERACRON, and TEIJINCONEX. An example of a polyolefin is INNEGRA. Examples of thermoplastic polyethylenes include TENSYLON from E. I. du Pont de Nemours and Company, DYNEEMA from Dutch-based DSM, and SPECTRA from Honeywell International, Inc., which are all examples of ultra-high-molecular-weight polyethylenes (UHMWPE). Examples of types of glass fibers include A-glass, C-glass, D-glass, E-glass, E-CR-glass, R-glass, S-glass, and T-glass. Another suitable fiber is M5 (polyhydroquinone-diimidazopyridine), which is both high-strength and fire-resistant.

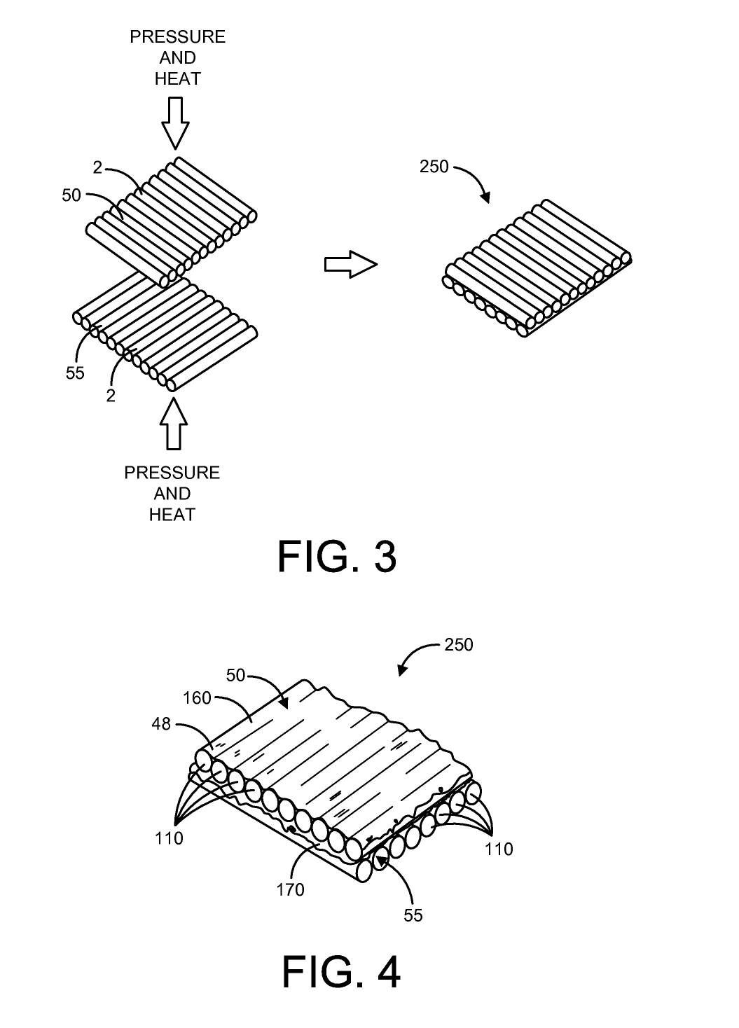

A ballistic resistant sheet 50 can be constructed using any suitable manufacturing process, such as extruding, die cutting, forming, pressing, weaving, rolling, etc. The sheet can include a woven or non-woven construction of a plurality of fibers bonded by a resin, such as a thermoplastic polymer, thermoset polymer, elastic resin, or other suitable resin. In one example, the ballistic resistant sheet 50 can include a plurality of aramid bundles of fibers 110 bonded by a resin 160 containing, for example, polypropylene, polyethylene, polyester, or phenol formaldehyde. The plurality of bundles of fibers 110 in the sheet 50 can be oriented in the same direction, thereby creating a unidirectional fiber arrangement, known as a uni-ply ballistic resistant sheet 50, as shown in FIG. 3.

In some examples, the ballistic resistant sheet 50 can include fibers 110 that are pre-impregnated with a resin, such as thermoplastic polymer, thermoset polymer, epoxy, or other suitable resin. The fibers 110 can be arranged in a woven pattern or arranged unidirectionally, as shown in FIGS. 3 and 4. The resin 160 can be partially cured to allow for easy handling and storage of the ballistic resistant sheet 250 prior to formation of the ballistic resistant apparatus 100. To prevent complete curing (e.g. polymerization) of the resin 160 before the ballistic resistant sheet 250 is incorporated into a ballistic resistant apparatus 100, the ballistic resistant sheet may require cold storage.

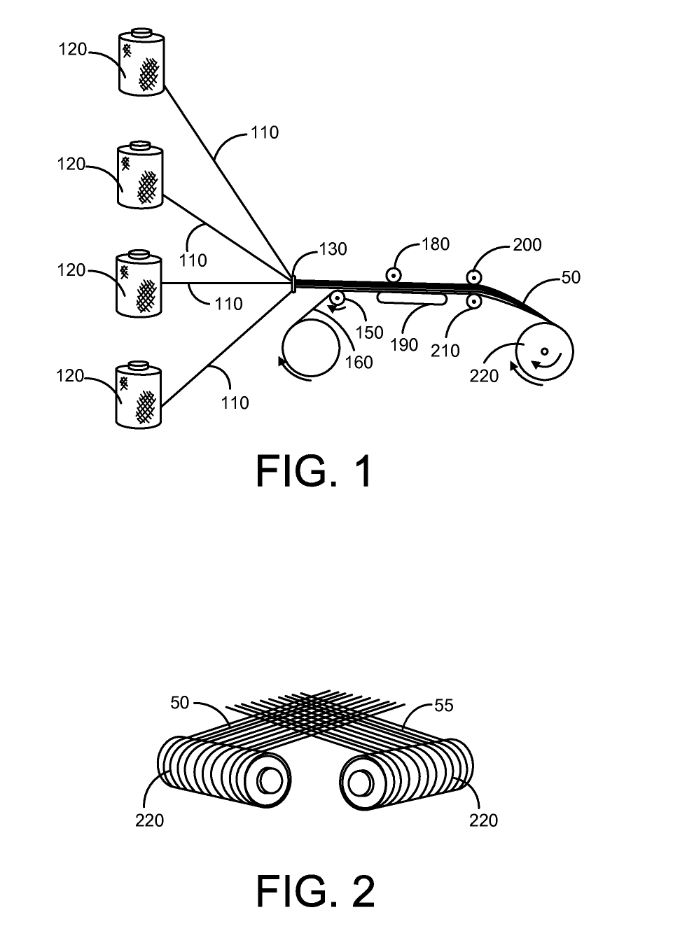

Certain ballistic resistant sheets are described in U.S. Pat. No. 5,437,905, which is hereby incorporated by reference in its entirety. FIG. 1 shows an example method for forming unidirectional ballistic resistant sheet material from a plurality of bundles of fibers 110. The bundles of fibers 110 can be supplied from a plurality of yarn creels 120. The bundles of fibers 110 can pass through a comb guide 130 where the bundles of fibers are arranged in a parallel orientation and formed into an array and passed over a resin application roller 150 where a resin film 160, such as a thin polyethylene or polypropylene film or other suitable film, is applied to one side of the array. The bundles of fibers 110 may be twisted or stretched prior to passing over the resin application roller 150 to increase their tenacity. A pre-lamination roller 180 can then press the array of bundles of fibers 110 against the resin film 160, which is then pressed against a heated plate 190, which causes the resin film to adhere to the array. After heating, the bundles of fibers 110 and the resin film 160 can be passed through a pair of heated pinch rolls 200, 210 to form a ballistic resistant sheet 50. The ballistic resistant sheet 50 can then be wound onto a roll 220 for ease of storage and transport.

As shown in FIGS. 2-4, two ballistic resistant sheets (50, 55) having unidirectional arrangements of fibers 110 (and known as uni-ply) can be bonded together to produce a configuration known as x-ply 250. X-ply 250 ballistic resistant sheets can include a first ballistic resistant sheet 50 and a second ballistic resistant sheet 55, each having a two-dimensional arrangement of unidirectionally-oriented fibers 110. The second ballistic resistant sheet 55 can be arranged at a 90-degree angle with respect to the first ballistic resistant sheet 50, which is set to a reference angle of 0-degrees, as shown in FIG. 3. This configuration is known as 0/90 x-ply, where “0” and “90” denote the relative orientations (in degrees) of the bundles of fibers 110 within the first and second ballistic resistant sheets (10, 30), respectively. The first ballistic resistant sheet 50 can be laminated to the second ballistic resistant sheet 55. A first thermoplastic film 160 and second thermoplastic resin film 170 can be bonded to the outer surfaces of the first and second ballistic resistant sheets (50, 55) without penetration of the resin films into the bundles of fibers 110 or through the laminated sheets from one side to the other.

Through a process involving heat and pressure, as shown in FIG. 3, the resin films (160, 170) melt and subsequently solidify to effectively laminate the uni-ply ballistic resistant sheets (50, 55) to each other, as shown in FIG. 4, thereby producing a 0/90 x-ply configuration.

### Ballistic Resistant Sheet Resin

Ballistic resistant sheets (e.g. 50, 55, 250) can be coated or impregnated with one or more resins (e.g. 160). When a resin coating or an impregnating step is performed during manufacturing of the ballistic resistant sheet 50, the sheet is known as a pre-impregnated ballistic sheet. In some examples, when pre-impregnated ballistic sheets 50 are used to produce the ballistic resistant panel 100, no additional resins may be required, since a suitable amount of resin may already be present in the pre-impregnated ballistic sheets due to a prior coating or impregnating process. Certain resins, such as resins made of thermoplastic polymers, may include long chain molecules. The chains of molecules may be held close to each other by weaker secondary forces. Upon heating, the secondary forces may be reduced, thereby permitting sliding of the chains of molecules and resulting in visco-plastic flow and ease in molding. Heating of the ballistic resistant sheets (e.g. 50, 55, 250) may cause softening of the resin (e.g. 160, 170), and the resin may become tacky as it softens. Softening may occur at the softening point, which is the temperature at which the resin softens beyond some arbitrary softness and can be determined, for example, by the Vicat method (ASTM-D1525). Applying pressure to the stack of ballistic resistant sheets 1005 when the resin is softened and tacky may result in a softened resin layer on a first ballistic resistant sheet contacting and adhering to a second ballistic resistant sheet that is adjacent to the first ballistic resistant sheet, and when the panel 100 is subsequently cooled and the temperature of the resin is reduced, a result is that the first and second ballistic resistant sheets may be partially or fully bonded to each other to form a laminate.

In one example, ballistic resistant sheets (e.g. 50, 250) in a ballistic resistant apparatus 100 may be coated or impregnated with a polypropylene resin, and the polypropylene resin may have a melting point of about 255-295 or 295-330 degrees F. In another example, ballistic resistant sheets in a ballistic resistant apparatus may be coated or impregnated with a polyethylene resin, and the polyethylene resin may have a melting point of about 215-240 degrees F. During a manufacturing process to make a ballistic resistant apparatus 100, the stack of ballistic resistant sheets 1005 may be heated to a temperature near the melting point of the resin to cause softening of the resin, and pressure may be applied to the stack of ballistic resistant sheets to press adjacent ballistic resistant sheets closer together. When the ballistic resistant apparatus 100 is cooled, and the temperature of the resin is reduced, adjacent ballistic resistant sheets (e.g. 50, 55, 250) may be left partially or fully bonded to each other to form a laminate.

When forming a ballistic apparatus 100 from one or more ballistic resistant sheets (e.g. 50, 55, 250) containing one or more resins (e.g. 160, 170), a suitable processing temperature for the apparatus can be dictated, at least partly, by the resin type and resin content (i.e. percent weight) within the ballistic resistant sheets. Selecting a resin with a lower melting point may reduce a target processing temperature for the panel 100, and selecting a resin with a higher melting point may increase the target processing temperature for the panel. The amount of partial or full bonding that occurs between adjacent ballistic resistant sheets in the stack can be controlled, at least in part, by resin selection, resin content, process temperature, and process pressure.

### Commercially-Available Ballistic Resistant Sheets

Ballistic resistant sheets constructed from high performance fibers, such as fibers made of aramids, para-aramids, meta-aramids, polyolefins, or ultra-high-molecular-weight polyethylenes, are commercially available from a variety of manufacturers. Several specific examples of commercially-available ballistic resistant sheets made of high performance fibers are provided below. Ballistic resistant sheets are commercially-available in many configurations, including uni-ply, 0/90 x-ply, and 0/90/0/90 double x-ply configurations. Ballistic resistant sheeting material can be ordered in a wide variety of forms, including tapes, rolls, sheets, structural sandwich panels, and preformed inserts, which can all be cut to size during a manufacturing process.

TechFiber, LLC, located in Arizona, manufactures a variety of ballistic resistant sheets made of aramid fibers that are sold under the trademark K-FLEX. One version of K-FLEX is made with KEVLAR fibers having a denier of about 1000 and a pick count of about 18 picks per inch. Certain versions of K-FLEX can have a resin content of about 15-20%. Different versions of K-FLEX may contain different resins. For instance, a first version of K-FLEX can include a resin (e.g. a polyethylene resin) with a melting temperature of about 215-240 degrees F., a second version of K-FLEX can include a resin with a melting temperature of about 240-265 degrees F., a third version of K-FLEX can include a resin with a melting temperature of about 265-295 degrees F., and a fourth version of K-FLEX can include a resin with a melting temperature of about 295-340 degrees F. K-FLEX is available in uni-ply, 0/90 x-ply, and 0/90/0/90 double x-ply configurations.

TechFiber, LLC also manufactures a variety of unidirectional ballistic resistant sheets made of aramid fibers that are sold under the trademark T-FLEX. Certain versions of T-FLEX can have a resin content of about 15-20% and can include aramid fibers such as TWARON fibers (e.g. model number T765). Different versions of T-FLEX may contain different resins. For instance, a first version of T-FLEX can include a resin (e.g. a polyethylene resin) with a melting temperature of about 215-240 degrees F., a second version of T-FLEX can include a resin with a melting temperature of about 240-265 degrees F., a third version of T-FLEX can include a resin with a melting temperature of about 265-295 degrees F., and a fourth version of T-FLEX can include a resin with a melting temperature of about 295-340 degrees F. T-FLEX is available in uni-ply, 0/90 x-ply, and 0/90/0/90 double x-ply configurations.

Polystrand, Inc., located in Colorado, manufactures a variety of unidirectional ballistic resistant sheets made of aramid fibers that are sold under the trademark THERMOBALLISTIC. One version of THERMOBALLISTIC ballistic resistant sheets are sold as product number TBA-8510 and include aramid fibers with a pick count of about 12.5 picks per inch. Other versions of THERMOBALLISTIC ballistic resistant sheets are sold as product numbers TBA-8510X and TBA-9010X and include aramid fibers (e.g. KEVLAR fibers) and have a 0/90 x-ply configuration. In certain versions, the resin content of the THEMROBALLISTIC ballistic resistant sheets can be about 10-20% or 15-20%. Different versions of THERMOBALLISTIC ballistic resistant sheets may contain different resins. For instance, a first version of THERMOBALLISTIC ballistic resistant sheets can include a resin with a melting temperature of about 225-255 degrees F., a second version of THERMOBALLISTIC ballistic resistant sheets can include a resin (e.g. a polypropylene resin) with a melting temperature of about 255-295 degrees F., a third version of THERMOBALLISTIC ballistic resistant sheets can include a resin (e.g. a polypropylene resin) with a melting temperature of about 295-330 degrees F., a fourth version of THERMOBALLISTIC ballistic resistant sheets can include a resin with a melting temperature of about 330-355 degrees F., and a fifth version of THERMOBALLISTIC ballistic resistant sheets can include a resin with a melting temperature of about 355-375 degrees F. One version of THERMOBALLISTIC ballistic resistant sheets can include a polypropylene resin. THERMOBALLISTIC ballistic resistant sheets are available in uni-ply, 0/90 x-ply, and 0/90/0/90 double x-ply configurations.

E. I. du Pont de Nemours and Company (DuPont), headquartered in Delaware, manufactures a ballistic resistant sheet material made of ultra-high-molecular-weight polyethylene fabric that is sold under the trademark TENSYLON. A Material Data Safety Sheet was prepared on Feb. 2, 2010 for a material sold under the tradename TENSYLON HTBD-09-A (Gen 2) by BAE Systems TENSYLON High Performance Materials. The Material Safety Data Sheet is identified as TENSYLON MSDS Number 1005, is publicly available, and is hereby incorporated by reference in its entirety. The ballistic resistant sheets are marketed as being lightweight and cost-effective and boast low back face deformation, excellent flexural modulus, and superior multi-threat capability over other commercially available ballistic resistant sheets. The ballistic resistant sheet material can be purchased on a roll and can be cut into ballistic resistant sheets having a size and shape dictated by an intended application.

Honeywell International, Inc., headquartered in New Jersey, manufactures a variety of ballistic resistant sheets made of aramid fibers that are sold under the trademarks GOLD SHIELD and GOLD FLEX. One version of GOLD SHIELD ballistic resistant sheets are sold under product number GN-2117 and are available in 0/90 x-ply configurations and have an areal density of about 3.2 ounces per square yard.

Barrday, Inc., headquartered in Cambridge, Ontario, manufactures a variety of ballistic resistant sheets made of para-aramid fibers that are sold under the trademark BARRFLEX. One version of BARRFLEX ballistic resistant sheets is sold as product number U480 and is available in 0/90 x-ply configurations. Each layer of the ballistic resistant sheet is individually constructed with a thermoplastic film laminated to a top and bottom surface.

Teijin Limited, headquartered in the Netherlands, manufactures a ballistic resistant sheet material made of ultra-high-molecular-weight polyethylene fabric in a solvent-free process. The sheet material is sold under the trademark ENDUMAX and is available with a thickness of about 55 micrometers.

Ply-Tech, Inc., located in New Braunfels, Tex. manufactures a variety of ballistic resistant sheets made of aramid fibers that are sold under the trademark KM2 1000. One version of KM2 1000 is made of 1,000 denier KEVLAR KM2 brand yarn from DuPont and is a biaxial (i.e. 0/90 X-ply) ballistic resistant sheet 250 with a fabric weight (i.e. areal density) of about 5.7 ounces per square yard. The KM2 1000 0/90 X-ply ballistic resistant sheet 250 can include two uni-ply ballistic resistant sheets (e.g. 50, 55) bonded together with an adhesive resin. Each uni-ply ballistic sheet (e.g. 50, 55) can include a plurality of KM2 brand fibers arranged unidirectionally to form a two-dimensional arrangement of fibers, and the sheets can be cross-plied to provide a 0/90 X-ply configuration. A polyethylene film can be applied over each uni-ply ballistic resistant sheet prior to joining the sheets with adhesive resin to form the 0/90 X-ply ballistic resistant sheet 250.

### Protective Cover

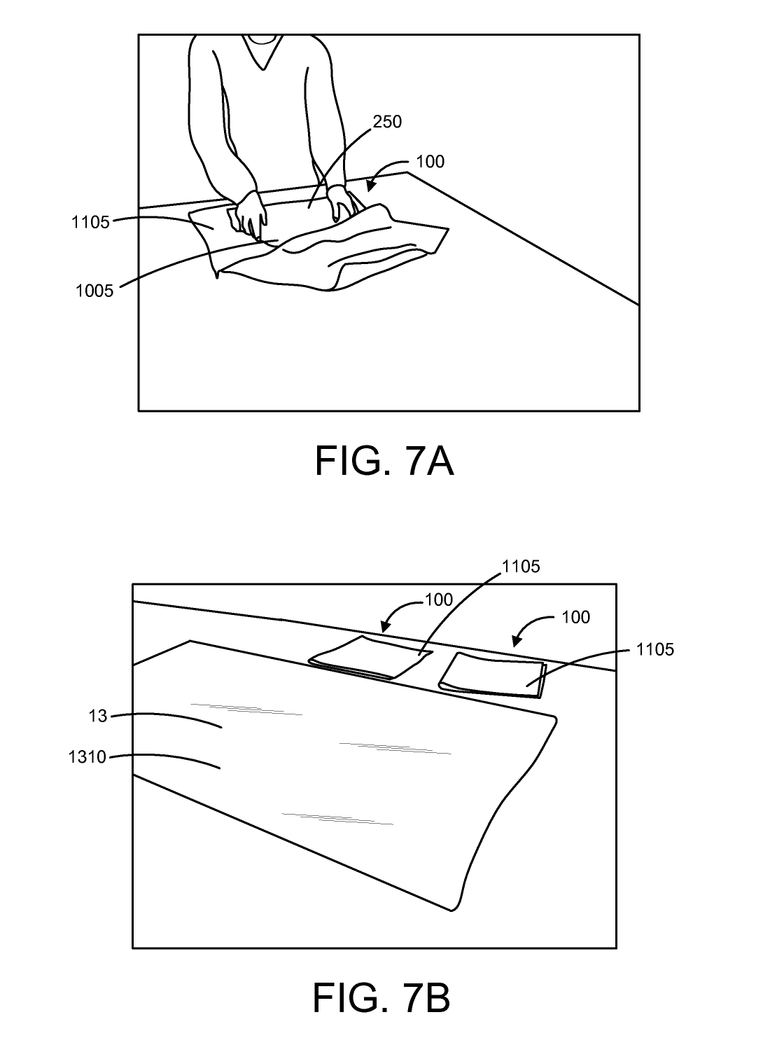

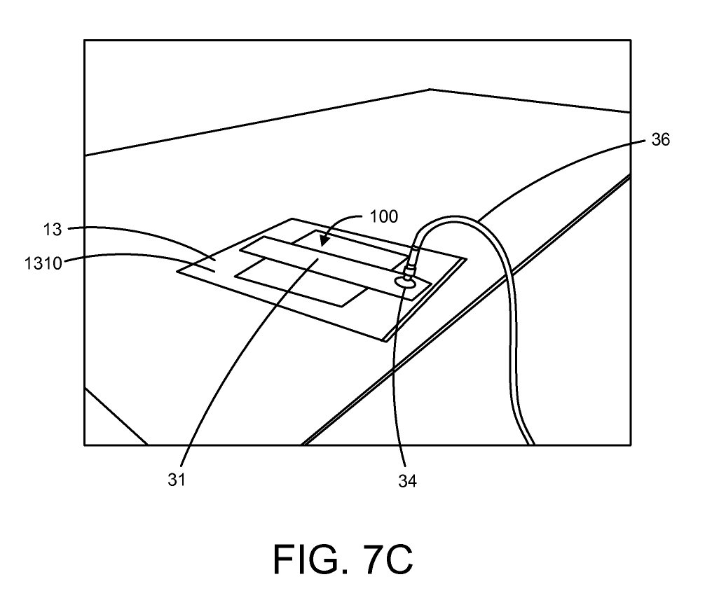

The stack of ballistic resistant sheets 1005 can be encased in a protective cover 1105. In one example, the protective cover 1105 can be a water-resistant or waterproof cover, thereby allowing the methods described herein to produce a water-resistant or waterproof ballistic resistant apparatus 100. The protective cover 1105 can be adapted to prevent the ingress of liquid through the cover toward the ballistic resistant sheets encased by the cover. FIG. 7A shows a step of a process for making a flexible ballistic resistant panel 100. In FIG. 7A, a stack of ballistic resistant sheets 1005 is being positioned within a protective cover 1105 prior to a vacuum bagging process. In some examples, as shown in FIGS. 7A-C, the protective over 1105 can be a single sheet of waterproof material that is folded to cover both the top and bottom surfaces of the stack 1005 of ballistic resistant sheets. In other examples, the protective over 1105 can include one or more sheets of waterproof material that are joined to form a waterproof cover that surrounds the stack 1005 of ballistic resistant sheets. Preventing water ingress can be desirable, since moisture can negatively affect the performance of certain ballistic resistant sheets. In particular, moisture can negatively affect tensile strength of certain fibers 11 (e.g. aramid fibers) within the ballistic resistant sheets (e.g. 50, 55, 250), or can affect interactions of certain fibers, potentially resulting in the sheets being less effective at dissipating impact energy from a projectile.

In some examples, the protective cover 1105 can be airtight and can encapsulate the stack of ballistic sheets 1005 and prevent air from reaching the stack of ballistic sheets after the manufacturing process is complete and the cover has been sealed around a perimeter portion of the stack of ballistic sheets. During the manufacturing process, air present between adjacent sheets 50 in the stack of ballistic sheets 1005 can be removed during a vacuum bagging process, as described herein. Once an airtight barrier has been formed around the stack of ballistic sheets by the cover 1105, oxygen is not able to reach the ballistic sheets 50 and, consequently, a rate of aging of the fibers (e.g. 110) and resins (e.g. 160) within the stack 1005 of ballistic sheets may be decreased, thereby increasing the useful life and ballistic performance over time of the ballistic resistant apparatus 100. The pressure inside and interior volume provided by the cover 1105 may remain below atmospheric pressure upon completion of manufacturing, and therefore a compressive force may be exerted on the outer surfaces of the cover, effectively preserving the stack of ballistic sheets 1005 in a compressed condition, which can improve ballistic performance. Despite providing an airtight barrier, the cover 1105 can be made of a compliant material, which allows the ballistic resistant apparatus 100 to retain flexibility, thereby allowing the apparatus 100 to be conformed to non-planar configurations for a wide variety of applications as described herein.

The protective cover 1105 can be made from any suitable material such as, for example, rubber, NYLON, RAYON, ripstop NYLON, CORDURA, polyvinyl chloride (PVC), polyurethane, silicone elastomer, fluoropolymer, or any combination thereof. The protective cover 1105 can be a coating that contains polyurethane, polyuria, or epoxy, such as a coating sold by Rhino Linings Corporation of San Diego, Calif. In another example, the protective cover 1105 can be made from any suitable waterproof or non-waterproof material and coated with a waterproof material such as, for example, rubber, PVC, polyurethane, polytetrafluoroethylene, silicone elastomer, fluoropolymer, wax, or any combination thereof. In one example, the protective cover 1105 can be made from NYLON coated with PVC. In another example, the protective cover 1105 can be made from NYLON coated with thermoplastic polyurethane. The protective cover 1105 can be made of any suitable material, such as about 50, 70, 200, 400, 600, 840, 1050, or 1680-denier NYLON coated with thermoplastic polyurethane. In yet another example, the protective cover 1105 can be made from 1000-denier CORDURA coated with thermoplastic polyurethane.

In addition to being made of a waterproof material that protects the ballistic resistant sheets (e.g. 25) from water ingress, the protective cover 1105 can also be made of a chemically-resistant material to protect the ballistic resistant sheets if the panel is exposed to acids or bases. Certain acids and bases can cause the tenacity of certain fibers, such as aramid fibers, to degrade over time, where “tenacity” is a measure of strength of a fiber or yarn. It is therefore desirable, in certain applications where exposure to chemicals is possible, for the protective cover 1105 to be chemically-resistant (e.g. resistant to acids and/or bases) to prevent the cover from deteriorating if exposed to acids or bases. Deterioration of the protective cover is undesirable, since it would permit acids or bases to breach the cover material and reach the stack of ballistic resistant sheets 1005 inside the cover. To avoid that outcome, the protective cover 1105 can be made of a chemically-resistant material or can include a chemically-resistant coating on an outer or inner surface of the cover. For instance, the protective cover 1105 can include a thermoplastic polymer coating on an outer or inner surface of the cover. Non-limiting examples of chemically-resistant thermoplastic polymers that can be used as a coating on the protective cover 1105 include polypropylene, low-density polyethylene, medium-density polyethylene, high-density polyethylene, ultra-high-molecular-weight polyethylene, and polytetrafluoroethylene (e.g. TEFLON).

The protective cover 1105 can made of a flame-resistant or flame-retardant material. In one example, the protective cover 1105 can include a flame-resistant or flame-retardant material mixed with a base material. In another example, the protective cover 1105 can include a base material coated with a flame-resistant or flame-retardant material. In yet another example, the protective cover 1105 can include a base material with a flame-resistant or flame-retardant material chemically bonded to the base material. The flame-resistant or flame-retardant material can be a phenolic resin, a phenolic/epoxy composite, NOMEX, an organohalogen compound (e.g. chlorendic acid derivative, chlorinated paraffin, decabromodiphenyl ether, decabromodiphenyl ethane, brominated polystyrene, brominated carbonate oligomer, brominated epoxy oligomer, tetrabromophthalic anyhydride, tetrabromobisphenol A, or hexabromocyclododecane), an organophosphorus compound (e.g. triphenyl phosphate, resorcinol bis(diphenylphosphate), bisphenol A diphenyl phosphate, tricresyl phosphate, dimethyl methylphosphonate, aluminum diethyl phosphinate, brominated tris, chlorinated tris, or tetrekis(2-chlorethyl)dichloroisopentyldiphosphate, antimony trioxide, or sodium antimonite), or a mineral (e.g. aluminium hydroxide, magnesium hydroxide, huntite, hydromagnesite, red phosphorus, or zinc borate).

The protective cover 1105, along with the stack of ballistic resistant sheets 1005, can be heated and subjected to a vacuum bagging process, thereby partially or fully bonding an inner surface of the protective cover to the stack of ballistic resistant sheets 1005 encased by the cover. Full or partial bonding can prevent the stack of ballistic resistant sheets 1005 from shifting within the cover 1105 during use, which can be important to ensure that ballistic performance of the panel 100 does not vary due to, for example, shifting of sheets within the stack. The protective cover 1105 can include a temperature sensitive adhesive or a layer of resin on an inner surface of the cover. During a manufacturing process, the protective cover 1105 can be heated to promote full or partial bonding of the inner surface of the cover to the stack of ballistic resistant sheets 1005 due to the adhesive or resin. In one example, the protective cover 1105 can be made of a material that is coated with polyurethane, polypropylene, vinyl, polyethylene, or a combination thereof, on the inner surface the cover. Heating the protective cover 1105 to a temperature above the melting point of the adhesive or resin and then cooling the cover below the melting point can result in bonding of the inner surface of the cover to the outer surface of the stack of ballistic resistant sheets 1005.

In some examples, the protective cover 1105 can be made of ripstop nylon coated with polyurethane. The protective cover 1105 can be made of ripstop nylon with a polyurethane coating that is about 0.1-1.5, 0.1-0.75, 0.1-0.5, or 0.25 mil thick. The protective cover 1105 can be made of 70-denier ripstop nylon with a polyurethane coating that is about 0.1-1.5, 0.1-0.75, 0.1-0.5, or 0.25 mil thick. The polyurethane coating can be provided on an inner surface of the protective cover 1105. A durable water repellant finish can be provided on an outer surface of the cover 1105. Suitable polyurethane coated ripstop nylon materials are commercially available under the trademark X-PAC from Rockywoods Fabrics, LLC located in Loveland, Colo.

### Vacuum Bagging

The stack of ballistic resistant sheets 1005 can be vacuum bagged to remove air that is present between adjacent sheets (e.g. 25), thereby compressing the stack and reducing its thickness. During the vacuum bagging process, a stack of ballistic resistant sheets 1005 can be inserted into a variable volume container 13, such as a vacuum bag, which is then sealed, as shown in FIG. 7C. A vacuum conduit 36 (e.g. vacuum hose) extending from a vacuum pump is then connected to an evacuation element 34 (e.g. vacuum port) on a variable volume container 13 (e.g. vacuum bag 1310), and the vacuum pump is activated to effectively evacuate air from the variable volume container through the vacuum hose. A breather layer 31 can be positioned between the components of the ballistic resistant apparatus 100 and the variable volume container 13 to ensure uniform evacuation of the variable volume container. As air is evacuated from the variable volume container 13, the air pressure inside the container decreases. Meanwhile, the ambient air pressure acting on the outside of the variable volume container 13 remains at atmospheric pressure (e.g. ˜14.7 psi). The pressure differential between the air pressure inside and outside the variable volume container 13 is sufficient to produce a suitable compressive force against the stack of ballistic resistant sheets 1005 within the ballistic resistant panel 100. The compressive force is applied uniformly over the panel 100, thereby resulting in a panel with uniform or nearly uniform thickness.

In one example, the variable volume container 13 can be sized to accommodate one ballistic panel 100, as shown in FIG. 7C. In another example, the variable volume container 13 can be sized to accommodate a plurality of ballistic panels 100, as shown in FIG. 7B. For instance, the variable volume container 13 can be sized to accommodate two or more, 2 or more, 2-20, 4-12, or 6-10 ballistic panels. Vacuum bagging batches of ballistic panels 100 can be more efficient than vacuum bagging individual panels and allows for quality testing of at least one panel per batch. Quality control testing of a panel 100 may involve destructive testing, such as firing projectiles at the panel 100 to determine a V50 rating or a ballistic protection level. Therefore, it is desirable to make two or more panels 100 in an identical vacuum bagging process where it can be assumed that the panels not destructively tested will perform similarly to the panel that has been destructively tested.

The variable volume container 13 (e.g. vacuum bag 1310) used in the vacuum bagging process can be reusable, which can reduce consumables and decrease labor costs. The reusable vacuum bag 1310 can be made from any suitable material, such as LEXAN, silicone rubber, TEFLON, fiberglass reinforced polyurethane, fiberglass reinforced polyester, or KEVLAR reinforced rubber.

### Heating Process

During formation of the ballistic resistant panel 100, the stack of ballistic resistant sheets 1005 can be heated in a heating process. Heating can promote bonding (e.g. partial or full bonding) between adjacent ballistic resistant sheets (e.g. 50, 55, 250). When adjacent ballistic resistant sheets are fully (i.e. completely) bonded, it may be difficult or nearly impossible to separate the sheets by hand, since former boundaries between adjacent sheets may no longer exist due to various degrees of melting, comingling, and solidifying of resins on adjacent sheets. When adjacent sheets are partially bonded, it may still be possible to separate adjacent sheets by hand, depending on the extent of the partial bonding, but damage to the sheets (e.g. fiber pullout) may occur to the sheets when attempting to separate them. Full or partial bonding is desirable since it can enhance the panel's 100 ability to dissipate impact energy of a projectile that strikes the panel as the ballistic resistant sheets within the panel experience delamination. During delamination, adjacent ballistic resistant sheets that were partially or fully bonded prior to impact are separated (i.e. delaminated) in response to the projectile entering the panel, and the energy required to separate those ballistic resistant sheets is dissipated from the projectile, thereby reducing the speed of the projectile and eventually stopping and capturing the projectile. A panel 100 containing ballistic resistant sheets that are partially or fully bonded can more effectively dissipate impact energy from a projectile than a panel that has no bonding and is simply a stack of ballistic resistant sheets sewn together, such as the ballistic resistant sheets shown in the prior art bullet-proof vest 600 in FIG. 6. The ballistic resistant sheets in FIG. 6 have no partial or full bonding between adjacent layers, which is evident from the way the ballistic resistant sheets can easily be fanned out after an edge seam of the vest is undone. For this reason, the bullet-proof vest 600 in FIG. 6 is unable to match the ballistic performance of the ballistic resistant panels 100 described herein when incorporated, for example, into a concealable bullet-proof vest 500 as shown in FIG. 5.

In one example, heating of the stack of ballistic resistant sheets 1005 can occur after the stack has been vacuum bagged and while the stack is still sealed within the variable volume container 13. In another example, the stack of ballistic resistant sheets 1005 can be heated after vacuum bagging and after the stack has been removed from the variable volume container 13. In yet another example, heating can occur before the stack of ballistic resistant sheets 1005 has been subjected to a vacuum bagging process.

Heating can occur using any suitable heating equipment such as, for example, a conventional oven, infrared oven, hydroclave, or autoclave. To ensure accurate temperature control throughout the heating process, the heating equipment can include a closed-loop controller, such as a proportional-integral-derivative (PID) controller, that receives an input from a temperature sensor. To avoid temperature variations throughout a heating chamber (e.g. 40, 42) of the heating equipment, a fan can be installed and operated within the heating chamber. The fan can circulate air throughout the heating chamber (e.g. 40, 42), thereby encouraging mixing of higher and lower temperature regions that may form within the heating chamber (due, for example, to placement of a heating element), and attempting to produce a uniform (or nearly uniform) gas temperature adjacent to all outer surfaces of the panel 100 to ensure consistent behavior of the resins in the ballistic resistant sheets. In some examples, the heating chamber can be located within, or can be the same apparatus as, the pressure vessel described herein.

During the heating process, a process temperature can be selected based, at least in part, on a melting point of one or more resins that are incorporated into one or more of the ballistic resistant sheets (e.g. 50, 55, 250) in the stack 1005. For instance, if the stack 1005 includes a ballistic resistant sheet containing a thermoplastic polymer resin (e.g. a polyethylene resin) with a melting temperature of about 215-240 degrees F., the process temperature can be increased to about 200-240 degrees F. or beyond to promote softening or melting of the resin in the ballistic resistant sheet. Similarly, if the stack includes a ballistic resistant sheet containing a thermoplastic polymer resin (e.g. a polypropylene resin) with a melting temperature of about 255-295 or 295-330 degrees F., the process temperature can be increased to about 240-295 or about 280-330 degrees F., respectively, or beyond to promote softening or melting of the resin in the ballistic resistant sheet.

As noted herein, the panel 100 can include a stack of ballistic resistant sheets 1005 including at least a first plurality of ballistic resistant sheets and a second plurality of ballistic resistant sheets. The first plurality of ballistic resistant sheets can include a first thermoplastic polymer (i.e. first resin) having a first melting point, and the second plurality of ballistic resistant sheets can include a second thermoplastic polymer (i.e. second resin) having a second melting point where the second melting point is higher than the first melting point. In one example, during the heating process, it can be desirable to heat the panel 100 to a temperature between the first and second melting points, thereby causing melting of the first thermoplastic polymer and resulting in bonding (e.g. partial or full bonding) of each sheet in the first plurality of ballistic resistant sheets to an adjacent sheet. Since the process temperature remains below the second melting point, the second thermoplastic polymer will not melt, and the second plurality of ballistic resistant sheets may not undergo any bonding, thereby permitting flexibility of the panel to remain relatively high since the ballistic resistant sheets in the second plurality of ballistic resistant sheets are permitted to move relative to one another when the panel is flexed.

In one example, where the first melting point of the first resin in the first plurality of the ballistic resistant sheets is about 215-240 degrees F. and the second melting point of the second resin in the second plurality of ballistic resistant sheets is about 295-330 degrees F., the process temperature can be about 250-275 or 265-275 degrees F. for at least 15 minutes or for about 60 minutes or more. In another example, where the first melting point of the first resin in the first plurality of the ballistic resistant sheets is about 215-240 degrees F. and the second melting point of the second resin in the second plurality of ballistic resistant sheets is about 255-295 degrees F., the process temperature can be about 200-240 degrees F. for at least 15 minutes or for about 60 minutes or more.

To promote partial or full bonding of adjacent ballistic resistant sheets (e.g. 50, 55, 250) in the stack 1005, the stack can be heated to a suitable temperature for a suitable duration. Suitable temperatures and durations may depend on the types of resin or resins present in the one or more ballistic resistant sheets in the stack. Examples of suitable process temperatures and durations for a heating process for any of the various stacks of ballistic resistant sheets described herein can include: 200-550 degrees F. for at least 1 second; 200-550 degrees F. for at least 5 minutes; 200-550 degrees F. for at least 15 minutes; 200-550 degrees F. for at least 30 minutes; 200-550 degrees F. for at least 60 minutes; 200-550 degrees F. for at least 90 minutes; 200-550 degrees F. for at least 120 minutes; 200-550 degrees F. for at least 180 minutes; 200-550 degrees F. for at least 240 minutes; 200-550 degrees F. for at least 480 minutes; 225-350 degrees F. for at least 1 second; 225-350 degrees F. for at least 5 minutes; 225-350 degrees F. for at least 15 minutes; 225-350 degrees F. for at least 30 minutes; 225-350 degrees F. for at least 60 minutes; 225-350 degrees F. for at least 90 minutes; 225-350 degrees F. for at least 120 minutes; 225-350 degrees F. for at least 180 minutes; 225-350 degrees F. for at least 240 minutes; 250-350 degrees F. for at least 1 second; 250-350 degrees F. for at least 5 minutes; 250-350 degrees F. for at least 15 minutes; 250-350 degrees F. for at least 30 minutes; 250-350 degrees F. for at least 60 minutes; 250-350 degrees F. for at least 90 minutes; 250-350 degrees F. for at least 120 minutes; 250-350 degrees F. for at least 180 minutes; 250-350 degrees F. for at least 240 minutes; 250-300 degrees F. for at least 1 second; 250-300 degrees F. for at least 5 minutes; 250-300 degrees F. for at least 15 minutes; 250-350 degrees F. for at least 30 minutes; 250-300 degrees F. for at least 60 minutes; 250-350 degrees F. for at least 90 minutes; 250-300 degrees F. for at least 120 minutes; 250-300 degrees F. for at least 180 minutes; 250-300 degrees F. for at least 240 minutes; 250-275 degrees F. for at least 1 second; 250-275 degrees F. for at least 5 minutes; 250-275 degrees F. for at least 15 minutes; 250-275 degrees F. for at least 30 minutes; 250-275 degrees F. for at least 60 minutes; 250-275 degrees F. for at least 90 minutes; 250-275 degrees F. for at least 120 minutes; 250-275 degrees F. for at least 180 minutes; 250-275 degrees F. for at least 240 minutes; 265-275 degrees F. for at least 1 second; 265-275 degrees F. for at least 5 minutes; 250-275 degrees F. for at least 15 minutes; 265-275 degrees F. for at least 30 minutes; 265-275 degrees F. for at least 60 minutes; 265-275 degrees F. for at least 90 minutes; 265-275 degrees F. for at least 120 minutes; 265-275 degrees F. for at least 180 minutes; 265-275 degrees F. for at least 240 minutes; 225-250 degrees F. for at least 1 second; 225-250 degrees F. for at least 5 minutes; 225-250 degrees F. for at least 15 minutes; 225-250 degrees F. for at least 30 minutes; 225-250 degrees F. for at least 60 minutes; 225-250 degrees F. for at least 90 minutes; 225-250 degrees F. for at least 120 minutes; 225-250 degrees F. for at least 180 minutes; 225-250 degrees F. for at least 240 minutes; 200-240 degrees F. for at least 1 second; 200-240 degrees F. for at least 5 minutes; 200-240 degrees F. for at least 15 minutes; 200-240 degrees F. for at least 30 minutes; 200-240 degrees F. for at least 60 minutes; 200-240 degrees F. for at least 90 minutes; 200-240 degrees F. for at least 120 minutes; 200-240 degrees F. for at least 180 minutes; or 200-240 degrees F. for at least 240 minutes.

For any of the above-mentioned process temperatures and durations for a heating process, the stack of ballistic resistant sheets 1005 can be sealed within a variable volume container 13 during the heating process. In certain examples, a vacuum conduit 36 (e.g. vacuum hose) extending from a vacuum pump can remain connected to an evacuation element 34 (e.g. vacuum port) on the variable volume container 13 during the heating process, thereby providing a compressive force against the panel 100 during the heating process. This configuration can ensure good results even if the variable volume container 13 is not perfectly sealed due to, for example, minor leaks in the bag material or edge sealant.

Exposing the ballistic resistant panel 100 to a higher temperature during the heating process can effectively reduce cycle times, which is desirable for mass production. Due to the thickness of the panel 100 and heat transfer properties of the panel, exposing the panel to a high temperature (e.g. 500 degrees F.) for a relatively short duration may allow the inner portion of the panel to achieve a target temperature needed for bonding (e.g. 250-275 degrees F.) more quickly than if the heat source was initially set to the target temperature needed for bonding. However, when using short cycle times with higher process temperatures, care must be taken to avoid reaching temperatures where weakening of the high performance fibers might occur.

### Applying Pressure

During formation of the ballistic resistant apparatus 100, pressure can be applied to the stack of ballistic resistant sheets 1005. Pressure can promote partial or full bonding of adjacent ballistic resistant sheets (e.g. 50, 55, 250) in the stack 1005. Pressure can be applied to the stack of ballistic resistant sheets 1005 using a press (e.g. mechanical pressure), autoclave (e.g. air pressure), hydroclave, bladder press, or other suitable device. In one example, pressure can be applied to the stack of ballistic resistant sheets 1005 during the heating process. In another example, pressure can be applied to the stack of ballistic resistant sheets prior to the heating process. In yet another example, pressure can be applied to the stack of ballistic resistant sheets after the heating process, but while the stack of ballistic resistant sheets 1005 is still at an elevated temperature. If pressure is applied to the stack of ballistic resistant sheets, it can occur after the stack of ballistic resistant sheets 1005 has been vacuum bagged and while the stack is still residing inside the variable volume container 13 and being heated. Alternately, pressure can be applied to the stack of ballistic resistant sheets 1005 after the stack has been removed from the variable volume container 13 or before the stack is inserted into the variable volume container 13.

During a process involving both heat and pressure, a process temperature can be selected based on a melting point of one or more thermoplastic polymers (i.e. resins) that are incorporated into one or more of the ballistic resistant sheets in the stack 1005. For instance, if the stack 1005 includes a ballistic resistant sheet (e.g. 250) containing a first resin (e.g. 160) with a melting temperature of about 215-240 degrees F., the process temperature can be increased to about 200-240 degrees F. or beyond to promote softening or melting of the first resin in the stack. Similarly, if the stack 1005 includes a ballistic resistant sheet containing a second resin with a melting temperature near 255-295 or 295-330 degrees F., the process temperature can be increased to about 240-295 or 280-330 degrees F., respectively, or beyond to promote softening or melting of the second resin in the stack.

To promote partial or full bonding of adjacent ballistic resistant sheets (e.g. 250) in the stack 1005, a suitable pressure can be applied to the stack for a suitable duration. Suitable pressures and durations may depend on the types of resin or resins present in the one or more ballistic resistant sheets in the stack. Examples of suitable process pressures and durations for any of the various stacks of ballistic resistant sheets 1005 described herein can include: 10-100 psi for at least 1 second, 10-100 psi for at least 1 second; 10-100 psi for at least 5 minutes; 10-100 psi for at least 15 minutes; 10-100 psi for at least 30 minutes; 10-100 psi for at least 60 minutes; 10-100 psi for at least 90 minutes; 10-100 psi for at least 120 minutes; 10-100 psi for at least 180 minutes; 10-100 psi for at least 240 minutes; 50-75 psi for at least 1 second; 50-75 psi for at least 5 minutes; 50-75 psi for at least 15 minutes; 50-75 psi for at least 30 minutes; 50-75 psi for at least 60 minutes; 50-75 psi for at least 90 minutes; 50-75 psi for at least 120 minutes; 50-75 psi for at least 180 minutes; 50-75 psi for at least 240 minutes; 75-100 psi for at least 1 second; 75-100 psi for at least 5 minutes; 75-100 psi for at least 15 minutes; 75-100 psi for at least 30 minutes; 75-100 psi for at least 60 minutes; 75-100 psi for at least 90 minutes; 75-100 psi for at least 120 minutes; 75-100 psi for at least 180 minutes; 75-100 psi for at least 240 minutes; at least 10 psi for at least 1 second; at least 10 psi for at least 5 minutes; at least 10 psi for at least 15 minutes; at least 10 psi for at least 30 minutes; at least 10 psi for at least 60 minutes; at least 10 psi for at least 90 minutes; at least 100 psi for at least 120 minutes; at least 10 psi for at least 180 minutes; at least 10 psi for at least 240 minutes; at least 100 psi for at least 1 second; at least 100 psi for at least 5 minutes; at least 100 psi for at least 15 minutes; at least 100 psi for at least 30 minutes; at least 100 psi for at least 60 minutes; at least 100 psi for at least 90 minutes; at least 100 psi for at least 120 minutes; at least 100 psi for at least 180 minutes; or at least 100 psi for at least 240 minutes.

Lower pressures are achievable with, for example, a manual press or a small autoclave. Higher pressures are achievable with, for example, an industrial autoclave, hydroclave, bladder press (e.g. made of KEVLAR reinforced rubber), a pneumatic press, or a hydraulic press. To promote partial or full bonding of adjacent ballistic resistant sheets in the stack 1005, a suitable pressure can be applied to the stack for a suitable duration or only momentarily. Suitable pressures and durations may depend on the types of resin or resins present in the one or more ballistic resistant sheets in the stack. Examples of suitable process pressures and durations for any of the various stacks of ballistic resistant sheets described herein can include: 100-500 psi for at least 1 second; 100-500 psi for at least 5 minutes; 100-500 psi for at least 15 minutes; 100-500 psi for at least 30 minutes; 100-500 psi for at least 60 minutes; 100-500 psi for at least 90 minutes; 100-500 psi for at least 120 minutes; 100-500 psi for at least 180 minutes; 100-500 psi for at least 240 minutes; 500-1,000 psi for at least 1 second; 500-1,000 psi for at least 5 minutes; 500-1,000 psi for at least 15 minutes; 500-1,000 psi for at least 30 minutes; 500-1,000 psi for at least 60 minutes; 500-1,000 psi for at least 90 minutes; 500-1,000 psi for at least 120 minutes; 500-1,000 psi for at least 180 minutes; 500-1,000 psi for at least 240 minutes; 1,000-2,500 psi for at least 1 second; 1,000-2,500 psi for at least 5 minutes; 1,000-2,500 psi for at least 15 minutes; 1,000-2,500 psi for at least 30 minutes; 1,000-2,500 psi for at least 60 minutes; 1,000-2,500 psi for at least 90 minutes; 1,000-2,500 psi for at least 120 minutes; 1,000-2,500 psi for at least 180 minutes; 1,000-2,500 psi for at least 240 minutes; at least 2,500 psi for at least 1 second; at least 2,500 psi for at least 5 minutes; at least 2,500 psi for at least 15 minutes; at least 2,500 psi for at least 30 minutes; at least 2,500 psi for at least 60 minutes; at least 2,500 psi for at least 90 minutes; at least 2,500 psi for at least 120 minutes; at least 2,500 psi for at least 180 minutes; or at least 2,500 psi for at least 240 minutes.

Combination of Heat and Pressure

Heat and pressure can be applied simultaneously to reduce overall cycle time required to manufacture the ballistic resistant apparatus 100, and an autoclave can facilitate the process. An autoclave (e.g. 42) is a pressure vessel that can be used to apply pressure and heat to one or more ballistic apparatuses 100 during a manufacturing process. If pressure is applied during the heating process, the process temperature can be modified to account for the effect that pressure has on the melting point of the one or more resins that are incorporated in one or more of the ballistic resistant sheets in the stack 1005. For instance, if the melting point of the resin increases as pressure increases, the target process temperature for the heating process can be increased when the heating process occurs in conjunction with the pressure process to ensure melting of the resin.

Where a manufacturing process includes high pressures and high temperatures, it can be desirable to reduce the oxygen content within the autoclave to avoid a potential combustion event during the process. In some examples, an inert gas, such as nitrogen, can be introduced to the autoclave (e.g. 42) to displace oxygen within the autoclave. This can be accomplished by sealing the autoclave, evacuating air from the autoclave using a vacuum line, and then filling the autoclave with nitrogen.

### 3-Dimensional Forming Process

During a forming process, a mold can be used to transform a flat ballistic resistant panel 100 into any suitable three-dimensional shape (e.g. a formed ballistic resistant apparatus as shown in FIG. 29). In one example, the forming process can occur concurrently with the vacuum bagging process. In another example, pressure, such as air pressure within an autoclave, can be used to form the ballistic resistant panel 100 into any suitable 3-dimensional shape while the panel 100 is still in the variable volume container 13. In yet another example, pressure, such as air pressure within an autoclave, and heat can be used to form the ballistic resistant panel 100 into any suitable 3-dimensional shape while the panel 100 is still in the variable volume container 13. In still another example, the panel 100 may be inserted into a mold while still at an elevated temperature following the heating process, and a press can be used to conform the panel to the shape of the mold.

### Heat Sealing

As discussed above, the stack of ballistic resistant sheets 1005 can be encased in a protective cover 1105. The outer perimeter of the cover 1105 can be heat-sealed to prevent water ingress and/or to form an airtight seal. Heat sealing is a process where a first material is joined to a second material (e.g. one thermoplastic sheet is joined to another thermoplastic sheet) using heat and pressure. During the heat sealing process, a heated die or sealing bar can apply heat and pressure to a specific contact area or path to seal or join the two materials together. When heat-sealing the perimeter of the protective cover 1105, the presence of a thermoplastic material proximate the contact area can promote sealing in the presence of heat and pressure. In one example, the protective cover 1105 can include thermoplastic polyurethane proximate the contact area to permit heat sealing. The cover 1105 can be made of a first portion and a second portion, and the heat sealing process can be used to join the first portion to the second portion, thereby encapsulating the stack of ballistic resistant sheets 1005 in a waterproof and/or airtight enclosure.

### Cooling

After the stack of ballistic resistant sheets 1005 has been heated to a predetermined temperature for a predetermined duration, the stack 1005 can be cooled in a controlled manner. In one example, the cooling process can occur while the stack of ballistic resistant sheets 1005 is outside of the variable volume container 13. In another example, the cooling process can occur while the stack of ballistic resistant sheets 1005 is inside the vacuum bag 1305 with vacuum applied. During the cooling process, the temperature of the stack of ballistic resistant sheets 1005 can be reduced from the predetermined temperature to about room temperature. Cooling can occur through natural convection, forced convection, liquid cooling, or any other suitable cooling process. If liquid cooling is employed, a suitable spray cooling process can be employed. Alternately, the stack of ballistic resistant sheets 1005 encased in the waterproof cover 1105 can be submerged in a water bath. The water bath can be connected to a heat exchanger and a circulating pump to increase the rate of cooling.

### Break-In Process

For certain applications, it is desirable to manufacture a ballistic resistant apparatus 100 that is relatively flexible. For instance, when the apparatus 100 is intended for use in a personal garment, such as a bullet-proof vest 500, as shown in FIG. 5, it can be desirable to use a flexible ballistic resistant panel 100 that provides the wearer greater mobility. Ballistic resistant panels 100 that are relatively flexible are generally referred to as “soft armor,” whereas ballistic resistant panels that are relatively rigid, such as steel or ceramic plates, are generally referred to as “hard armor.”

To further improve the flexibility of the soft armor panels 100 described herein, the panels can be subjected to a break-in process. The break-in process can be accomplished by hand or mechanical device. A mechanical device can be used to speed the break-in process and to provide greater consistency among a series of panels 100, thereby improving quality control and ensuring consistent panel performance. In one example, a series of rollers can be configured to receive the flexible panel 100. As the panel 100 passes through a first set of rollers, the panel may be deformed in a first direction to transform the nearly flat panel to a curved panel. Due to the resilience of the stack of ballistic resistant sheets 1005, the panel 100 may return to a nearly flat panel shortly after exiting the first set of rollers. The panel 100 may then pass through a second set of rollers configured to deform the panel in a second direction that is opposite the first direction. Once again, due to the resilience of the stack of ballistic resistant sheets, the panel may return to a nearly flat panel shortly after exiting the second set of rollers. To further enhance the flexibility of the panel, the panel may be fed through the first and second rollers one or more additional times.

### Methods or Cutting Ballistic Resistant Sheets

The intended use of the ballistic resistant apparatus 100 dictates the size and shape of the apparatus 100, which in turn dictates the geometry of a pattern (e.g. two-dimensional pattern) that is cut from the ballistic resistant sheets (e.g. 250) that are used to construct the apparatus. The intended use of the ballistic resistant apparatus 100 will also dictate how many ballistic resistant sheets (e.g. 250) should be included in the apparatus to satisfy certain performance standards, such as those set forth in NIJ Standard-0101.06.

In one example, ballistic resistant sheets 250 can be cut from large rolls of ballistic resistant sheet material. Due to the size of the sheets, it is common for one or more patterns be cut from a single ballistic resistant sheet. The patterns can be arranged on the ballistic resistant sheet to minimize the amount of ballistic resistant sheet material that is wasted. In one example, a computer program can be used to determine an arrangement of patterns that minimizes the amount of wasted ballistic resistant sheet material.

The ballistic resistant sheets 250 can be cut on a cutting table, such as a model M9000 manufactured by Eastman Machine Company of Buffalo, N.Y. The top surface of the cutting table can include a plurality of holes. The cutting table can be connected to a vacuum pump that applies suction to a lower side of the top surface, thereby drawing air through the plurality of holes and creating suction proximate the top surface of the cutting table. During cutting, the ballistic material can be placed on the cutting table. The suction can assist in preventing movement of the ballistic resistant sheet relative to the cutting table during the cutting process, which can improve cutting performance and precision and thereby reduce wasted material. For instance, employing a cutting table with a vacuum system can reduce fraying of fibers at a cutting location by avoiding unwanted movement of the ballistic resistant sheet during the cutting process.

The top surface of the cutting table can be made of any suitable material. In one example, the top surface of the cutting table can be made of POREX, a porous polymer material. POREX can be costly to replace if damaged by a cutting process or through misuse. A less expensive polymer sheet can be used to cover and protect the POREX. For instance, a LEXAN sheet can be used to cover and protect the POREX surface. The LEXAN sheet can include a plurality of holes that permit air to pass through the sheet and allow suction to be created proximate a top surface of the LEXAN sheet. If the polymer sheet is damaged during a cutting process, it can be replaced at a much lower cost than POREX. Due to its machinability, the polymer sheet can permit an operator to easily drill or create a suitable hole pattern in the polymer sheet. The number, size, or configuration of the plurality holes can vary depending on the pattern to be cut from the ballistic resistant sheet. This provides the operator with additional process flexibility that can enhance cutting performance (e.g. the LEXAN sheet can be modified to intentionally cover and obstruct certain pores in the POREX, thereby increasing the suction proximate the remaining unobstructed pores). If the operator is cutting two patterns on the same cutting table in a single day, the operator can have two polymer sheets that are each optimized for cutting one of the two patterns. For instance, a first polymer sheet can have a number, size, and configuration of holes that is optimized for a first pattern, and a second polymer sheet can have a number, size, and configuration of holes that is optimized for a second pattern.

### Methods for Cutting a Plurality of Ballistic Resistant Sheets

To increase efficiency, it can be desirable to cut a pattern from two or more ballistic resistant sheets (e.g. 250) simultaneously. This can be accomplished by stacking two or more ballistic resistant sheets prior to cutting the sheets. Cutting can be performed on a cutting table with any suitable cutting tool, such as a laser, blade, rotary knife, or die cutter. In one example the cutting tool can be a drag knife mounted to a computer-controlled gantry. When a drag knife is used, a downward cutting force from the drag knife is applied against the stack of ballistic resistant sheets 1005 and, in turn, against the top surface of the cutting table (or polymer sheet covering and protecting the cutting table).

If two or more types of ballistic resistant sheets are being cut simultaneously in a stack 1005, the resulting cut quality of each ballistic resistant sheet can depend on the arrangement of the ballistic resistant sheets within the stack. Certain types of ballistic resistant sheets that are less stiff exhibit poor cut quality if placed on top of the stack. For instance, ballistic resistant sheets that are less stiff may suffer poor cut quality, such as fraying along their edges or fibers pulling from the sheets as the drag knife is cutting, which can compromise the ballistic performance of the sheets.

However, it has been discovered through experimentation that bounding ballistic resistant sheets that are less stiff with ballistic resistant sheets that are stiffer can provide better cut quality along an edge of the less stiff ballistic resistant sheet and produce significantly less fraying or pulling of fibers at the edge of the less stiff ballistic resistant sheet. In one example, a grouping of one or more ballistic resistant sheets that are less stiff can be bounded on a top surface by a grouping of one or more ballistic resistant sheets that are relatively stiffer. Specifically, a stack of ballistic resistant sheets 1005 that is suitable for cutting on a cutting table can include a first grouping of one or more stiffer ballistic resistant sheets on top of a second grouping of one or more less stiff ballistic resistant sheets. In another example, a grouping of one or more ballistic resistant sheets that are less stiff can be bounded on a top surface and a bottom surface by groupings of one or more ballistic resistant sheets that are relatively stiffer. Specifically, a stack of ballistic resistant sheets 1005 that is suitable for cutting on a cutting table can include a first grouping of one or more stiffer ballistic resistant sheets, a second grouping of one or more less stiff ballistic resistant sheets, and a third grouping of one or more stiffer ballistic resistant sheets.

The flexibility of commercially available ballistic resistant sheets varies. In relative terms, K-FLEX ballistic resistant sheets can be less stiff than THERMOBALLISTIC ballistic resistant sheets. K-FLEX ballistic resistant sheets can have a stiffness similar to fabrics used in garments, whereas THERMOBALLISTIC ballistic resistant sheets can have a stiffness similar to a paper business card. When cutting one or more K-FLEX ballistic resistant sheets, cutting performance can be enhanced by grouping the one or more K-FLEX ballistic resistant sheets with one or more THERMOBALLISTIC ballistic resistant sheets, where the one or more THERMOBALLISTIC ballistic resistant sheets are either on a top side only or on both a top side and a bottom side of the one or more K-FLEX ballistic resistant sheets. These groupings of ballistic resistant sheets (where a less stiff grouping is sandwiched between two more stiff groupings) can provide cleaner cuts with less fraying along edges of the K-FLEX ballistic resistant sheets. Reducing fraying along edges of the cut sheets can help ensure that the performance of the sheets is not degraded and, ultimately, that the resulting ballistic panel 100 performs as intended.

Examples of stacks of ballistic resistant sheets 1005 suitable for cutting on a cutting table include the following configurations, where the first listed grouping in each stack is in closest proximity to the top surface of the cutting table, and the last listed grouping in each stack is farthest from the top surface of the cutting table: 1-6 THERMOBALLISTIC 0/90 x-ply ballistic resistant sheets, 1-10 K-FLEX 0/90 x-ply ballistic resistant sheets, 1-6 THERMOBALLISTIC 0/90 x-ply ballistic resistant sheets; 1-5 THERMOBALLISTIC 0/90 x-ply ballistic resistant sheets, 1-10 K-FLEX 0/90 x-ply ballistic resistant sheets, 1-5 THERMOBALLISTIC 0/90 x-ply ballistic resistant sheets; 1-4 THERMOBALLISTIC 0/90 x-ply ballistic resistant sheets, 1-10 K-FLEX 0/90 x-ply ballistic resistant sheets, 1-4 THERMOBALLISTIC 0/90 x-ply ballistic resistant sheets; 1-3 THERMOBALLISTIC 0/90 x-ply ballistic resistant sheets, 1-10 K-FLEX 0/90 x-ply ballistic resistant sheets, 1-3 THERMOBALLISTIC 0/90 x-ply ballistic resistant sheets; 1-2 THERMOBALLISTIC 0/90 x-ply ballistic resistant sheets, 1-10 K-FLEX 0/90 x-ply ballistic resistant sheets, 1-2 THERMOBALLISTIC 0/90 x-ply ballistic resistant sheets; 1 THERMOBALLISTIC 0/90 x-ply ballistic resistant sheets, 1-10 K-FLEX 0/90 x-ply ballistic resistant sheets, 1 THERMOBALLISTIC 0/90 x-ply ballistic resistant sheets; 6 THERMOBALLISTIC 0/90 x-ply ballistic resistant sheets, 10 K-FLEX 0/90 x-ply ballistic resistant sheets, 6 THERMOBALLISTIC 0/90 x-ply ballistic resistant sheets; 6 THERMOBALLISTIC 0/90 x-ply ballistic resistant sheets, 8 K-FLEX 0/90 x-ply ballistic resistant sheets, 6 THERMOBALLISTIC 0/90 x-ply ballistic resistant sheets; or 1 or more THERMOBALLISTIC 0/90 x-ply ballistic resistant sheets, 1 or more K-FLEX 0/90 x-ply ballistic resistant sheets, 1 or more THERMOBALLISTIC 0/90 x-ply ballistic resistant sheets.

Additional examples of stacks of ballistic resistant sheets 1005 suitable for cutting on a cutting table are provided below, where a first plurality of ballistic resistant sheets (e.g. one or more K-FLEX 0/90 x-ply ballistic resistant sheets) are bounded by a second plurality of ballistic resistant sheets (e.g. one or more THERMOBALLISTIC 0/90 x-ply ballistic resistant sheets). In the following examples, the first listed grouping in each stack is in closest proximity to the top surface of the cutting table: 1-6 K-FLEX 0/90 x-ply ballistic resistant sheets, 1-6 THERMOBALLISTIC 0/90 x-ply ballistic resistant sheets; 1-4 K-FLEX 0/90 x-ply ballistic resistant sheets, 1-6 THERMOBALLISTIC 0/90 x-ply ballistic resistant sheets; 2-4 K-FLEX 0/90 x-ply ballistic resistant sheets, 3-6 THERMOBALLISTIC 0/90 x-ply ballistic resistant sheets; 3-4 K-FLEX 0/90 x-ply ballistic resistant sheets; 4-6 THERMOBALLISTIC 0/90 x-ply ballistic resistant sheets; 3 K-FLEX 0/90 x-ply ballistic resistant sheets, 6 THERMOBALLISTIC 0/90 x-ply ballistic resistant sheets; 4 K-FLEX 0/90 x-ply ballistic resistant sheets, 6 THERMOBALLISTIC 0/90 x-ply ballistic resistant sheets.

Although specific examples are described above that include K-FLEX and THERMOBALLISTIC ballistic resistant sheets, the examples are not limiting. In any of the examples provided above, other commercially-available ballistic resistant sheets can be substituted for those listed. For instance, in any of the examples provided above, less stiff commercially-available ballistic resistant sheet can be substituted for the K-FLEX ballistic sheets and relatively more stiff commercially-available ballistic resistant sheets can be substituted for the THERMOBALLISTIC ballistic sheets.

### Homogeneous or Non-Homogeneous Stack

In some examples, the ballistic resistant sheets (e.g. 250) can be arranged in a homogeneous stack, where all ballistic resistant sheets in the stack 1005 are made from the same type of ballistic resistant sheet material. In other examples, any other suitable type or types of ballistic resistant sheets (e.g. sheets made of aramid or glass fibers, sheets made of UHMWPE fibers, sheets made of ceramic, or sheets made of metal) can be interspersed in the stack of ballistic resistant sheets 1005 to improve the ballistic performance of the stack. In another example, a sheet of film adhesive, such as a sheet of film adhesive available from Collano Adhesives AG, headquartered in Switzerland, can be interspersed in the stack of ballistic resistant sheets 1005 to alter the ballistic performance of the stack. In particular, a sheet of adhesive film can be incorporated within the stack near a strike face side of the stack to improve stab resistance of the panel 100. A sheet of adhesive film can be incorporated within the stack 1005 near a wear face side of the stack to reduce back face deformation of the panel 100 after being struck by a projectile.

Panels Constructed from X-Ply Ballistic Resistant Sheets

Two uni-ply ballistic resistant sheets can be bonded together to produce a configuration known as x-ply 250, as shown in FIG. 4. Examples of suitable stacks 1005 of x-ply ballistic resistant sheets 250 for a flexible ballistic resistant apparatus 100 can include a first plurality of x-ply ballistic resistant sheets 1020 containing a first resin with a first melting temperature and a second plurality of x-ply ballistic resistant sheets 1025 containing a second resin with a second melting temperature (see, e.g. FIGS. 11 and 12). The second melting temperature can be higher than the first melting temperature. Examples include: 1-10 0/90 x-ply ballistic resistant sheets containing a first resin and 1-10 0/90 x-ply ballistic resistant sheets containing a second resin; 4-10 0/90 x-ply ballistic resistant sheets containing a first resin and 4-10 0/90 x-ply ballistic resistant sheets containing a second resin; 6-10 0/90 x-ply ballistic resistant sheets containing a first resin and 6-10 0/90 x-ply ballistic resistant sheets containing a second resin; 10-20 0/90 x-ply ballistic resistant sheets containing a first resin and 10-20 0/90 x-ply ballistic resistant sheets containing a second resin; and 20-30 0/90 x-ply ballistic resistant sheets containing a first resin and 20-30 0/90 x-ply ballistic resistant sheets containing a second resin.

Examples of suitable stacks 1005 of x-ply ballistic resistant sheets containing aramid fibers can include a first plurality of x-ply ballistic resistant sheets 1020 containing aramid fibers and a first resin with a first melting temperature and a second plurality of x-ply ballistic resistant sheets 1025 containing aramid fibers and a second resin with a second melting temperature (see, e.g. FIGS. 11 and 12). The second melting temperature can be higher than the first melting temperature. Examples include: 1-10 0/90 x-ply ballistic resistant sheets containing a first resin and 1-10 0/90 x-ply ballistic resistant sheets containing a second resin; 4-10 0/90 x-ply ballistic resistant sheets containing a first resin and 4-10 0/90 x-ply ballistic resistant sheets containing a second resin; 6-10 0/90 x-ply ballistic resistant sheets containing a first resin and 6-10 0/90 x-ply ballistic resistant sheets containing a second resin; 10-20 0/90 x-ply ballistic resistant sheets containing a first resin and 10-20 0/90 x-ply ballistic resistant sheets containing a second resin; 20-30 0/90 x-ply ballistic resistant sheets containing a first resin and 20-30 0/90 x-ply ballistic resistant sheets containing a second resin.

Examples of suitable stacks 1005 of x-ply ballistic resistant sheets for a flexible ballistic panel 100 can include a first plurality of x-ply ballistic resistant sheets 1020 containing a polyethylene resin with a melting temperature of about 215-240 degrees F. and a second plurality of x-ply ballistic resistant sheets 1025 containing a polypropylene resin with a melting temperature of about 255-295 or 295-330 F (see, e.g. FIGS. 11 and 12). Examples include: 1-10 0/90 x-ply ballistic resistant sheets containing a polyethylene resin and 1-10 0/90 x-ply ballistic resistant sheets containing a polypropylene resin; 4-10 0/90 x-ply ballistic resistant sheets containing a polyethylene resin and 4-10 0/90 x-ply ballistic resistant sheets containing a polypropylene resin; 6-10 0/90 x-ply ballistic resistant sheets containing a polyethylene resin and 6-10 0/90 x-ply ballistic resistant sheets containing a polypropylene resin; 10-20 0/90 x-ply ballistic resistant sheets containing a polyethylene resin and 10-20 0/90 x-ply ballistic resistant sheets containing a polypropylene resin; 20-30 0/90 x-ply ballistic resistant sheets containing a polyethylene resin and 20-30 0/90 x-ply ballistic resistant sheets containing a polypropylene resin.

Examples of suitable stacks 1005 of x-ply ballistic resistant sheets for a flexible ballistic panel 100 can include a first plurality of THERMOBALLISTIC ballistic resistant sheets 1025 arranged in a stack having a top surface and a bottom surface and bounded on the top surface by a first plurality of K-FLEX ballistic resistant sheets 1020 and bounded on the bottom surface by a second plurality of K-FLEX ballistic resistant sheets 1030, as shown in FIG. 11. Examples include: 1-10 K-FLEX 0/90 x-ply ballistic resistant sheets, 1-10 THERMOBALLISTIC 0/90 x-ply ballistic resistant sheets, 1-10 K-FLEX 0/90 x-ply ballistic resistant sheets; 4-10 K-FLEX 0/90 x-ply ballistic resistant sheets, 4-10 THERMOBALLISTIC 0/90 x-ply ballistic resistant sheets, 4-10 K-FLEX 0/90 x-ply ballistic resistant sheets; 6-10 K-FLEX 0/90 x-ply ballistic resistant sheets, 6-10 THERMOBALLISTIC 0/90 x-ply ballistic resistant sheets, 6-10 K-FLEX 0/90 x-ply ballistic resistant sheets; 8 K-FLEX 0/90 x-ply ballistic resistant sheets, 10 THERMOBALLISTIC 0/90 x-ply ballistic resistant sheets, 8 K-FLEX 0/90 x-ply ballistic resistant sheets; 6 K-FLEX 0/90 x-ply ballistic resistant sheets, 8 THERMOBALLISTIC 0/90 x-ply ballistic resistant sheets, 6 K-FLEX 0/90 x-ply ballistic resistant sheets; 5 K-FLEX 0/90 x-ply ballistic resistant sheets, 8 THERMOBALLISTIC 0/90 x-ply ballistic resistant sheets, 5 K-FLEX 0/90 x-ply ballistic resistant sheets; 4 K-FLEX 0/90 x-ply ballistic resistant sheets, 8 THERMOBALLISTIC 0/90 x-ply ballistic resistant sheets, 4 K-FLEX 0/90 x-ply ballistic resistant sheets; 10-20 K-FLEX 0/90 x-ply ballistic resistant sheets, 10-20 THERMOBALLISTIC 0/90 x-ply ballistic resistant sheets, 10-20 K-FLEX 0/90 x-ply ballistic resistant sheets; or 20-30 K-FLEX 0/90 x-ply ballistic resistant sheets, 20-30 THERMOBALLISTIC 0/90 x-ply ballistic resistant sheets, 20-30 K-FLEX 0/90 x-ply ballistic resistant sheets.

Examples of suitable stacks 1005 of x-ply ballistic resistant sheets for a flexible ballistic panel 100 can include a first plurality of K-FLEX ballistic resistant sheets 1025 arranged in a stack having a top surface and a bottom surface and bounded on the top surface by a first plurality of THERMOBALLISTIC ballistic resistant sheets 1020 and bounded on the bottom surface by a second plurality of THERMOBALLISTIC ballistic resistant sheets 1030, as shown in FIG. 12. Suitable examples include: 1-10 THERMOBALLISTIC 0/90 x-ply ballistic resistant sheets, 1-10 K-FLEX 0/90 x-ply ballistic resistant sheets, 1-10 THERMOBALLISTIC 0/90 x-ply ballistic resistant sheets; 4-10 THERMOBALLISTIC 0/90 x-ply ballistic resistant sheets, 4-10 K-FLEX 0/90 x-ply ballistic resistant sheets, 4-10 THERMOBALLISTIC 0/90 x-ply ballistic resistant sheets; 6-10 THERMOBALLISTIC 0/90 x-ply ballistic resistant sheets, 6-10 K-FLEX 0/90 x-ply ballistic resistant sheets, 6-10 THERMOBALLISTIC 0/90 x-ply ballistic resistant sheets; 8 THERMOBALLISTIC 0/90 x-ply ballistic resistant sheets, 10 K-FLEX 0/90 x-ply ballistic resistant sheets, 8 THERMOBALLISTIC 0/90 x-ply ballistic resistant sheets; 6 THERMOBALLISTIC 0/90 x-ply ballistic resistant sheets, 8 THERMOBALLISTIC 0/90 x-ply ballistic resistant sheets, 6 THERMOBALLISTIC 0/90 x-ply ballistic resistant sheets; 5 THERMOBALLISTIC 0/90 x-ply ballistic resistant sheets, 8 K-FLEX 0/90 x-ply ballistic resistant sheets, 5 THERMOBALLISTIC 0/90 x-ply ballistic resistant sheets; 4 THERMOBALLISTIC 0/90 x-ply ballistic resistant sheets, 8 K-FLEX 0/90 x-ply ballistic resistant sheets, 4 THERMOBALLISTIC 0/90 x-ply ballistic resistant sheets; 6 THERMOBALLISTIC 0/90 x-ply ballistic resistant sheets, 6 K-FLEX 0/90 x-ply ballistic resistant sheets, 6 THERMOBALLISTIC 0/90 x-ply ballistic resistant sheets; 10-20 THERMOBALLISTIC 0/90 x-ply ballistic resistant sheets, 10-20 K-FLEX 0/90 x-ply ballistic resistant sheets, 10-20 THERMOBALLISTIC 0/90 x-ply ballistic resistant sheets, or 20-30 THERMOBALLISTIC 0/90 x-ply ballistic resistant sheets, 20-30 K-FLEX 0/90 x-ply ballistic resistant sheets, 20-30 THERMOBALLISTIC 0/90 x-ply ballistic resistant sheets.

Examples of suitable stacks 1005 of x-ply ballistic resistant sheets for a ballistic resistant panel 100 can include a grouping of 1-10, 4-10, 6-10, 10-20, or 20-30 x-ply ballistic resistant sheets 1005 made of fibers (such as, for example, aramid fibers or UHMWPE fibers), as shown in FIG. 10. Examples of suitable stacks 1005 of x-ply ballistic resistant sheets for a ballistic panel 100 can include a grouping of 1-10, 4-10, 6-10, 10-20, or 20-30 THERMOBALLISTIC 0/90 x-ply ballistic resistant sheets. Other examples of suitable stacks 1005 of x-ply ballistic resistant sheets for a ballistic panel 100 can include a grouping of 1-10, 4-10, 6-10, 10-20 or 20-30 K-FLEX 0/90 x-ply ballistic resistant sheets.

Panels Constructed from Uni-Ply Ballistic Resistant Sheets

Examples of suitable stacks 1005 of uni-ply ballistic resistant sheets 50 for a flexible ballistic resistant panel 100 can include a first plurality of uni-ply ballistic resistant sheets 1020 containing a first resin with a first melting temperature and a second plurality of uni-ply ballistic resistant sheets 1025 containing a second resin with a second melting temperature (see, e.g. FIGS. 11 and 12). The second melting temperature can be higher than the first melting temperature. Examples include: 1-10 uni-ply ballistic resistant sheets containing a first resin and 1-10 uni-ply ballistic resistant sheets containing a second resin; 4-10 uni-ply ballistic resistant sheets containing a first resin and 4-10 uni-ply ballistic resistant sheets containing a second resin; 6-10 uni-ply ballistic resistant sheets containing a first resin and 6-10 uni-ply ballistic resistant sheets containing a second resin; and 10-20 uni-ply ballistic resistant sheets containing a first resin and 10-20 uni-ply ballistic resistant sheets containing a second resin; and 20-30 uni-ply ballistic resistant sheets containing a first resin and 20-30 uni-ply ballistic resistant sheets containing a second resin.

Examples of suitable stacks of uni-ply ballistic resistant sheets 50 containing aramid fibers can include a first plurality of uni-ply ballistic resistant sheets 1020 containing aramid fibers and a first resin with a first melting temperature and a second plurality of uni-ply ballistic resistant sheets 1025 containing aramid fibers and a second resin with a second melting temperature (see, e.g. FIGS. 11 and 12). The second melting temperature can be higher than the first melting temperature. Examples include: 1-10 uni-ply ballistic resistant sheets containing a first resin and 1-10 uni-ply ballistic resistant sheets containing a second resin; 8-20 uni-ply ballistic resistant sheets containing a first resin and 8-20 uni-ply ballistic resistant sheets containing a second resin; 12-20 uni-ply ballistic resistant sheets containing a first resin and 12-20 uni-ply ballistic resistant sheets containing a second resin; 20-40 uni-ply ballistic resistant sheets containing a first resin and 20-40 uni-ply ballistic resistant sheets containing a second resin; and 40-60 uni-ply ballistic resistant sheets containing a first resin and 40-60 uni-ply ballistic resistant sheets containing a second resin.

Examples of suitable stacks 1005 of uni-ply ballistic resistant sheets 50 for flexible ballistic resistant panels 100 can include a first plurality of uni-ply ballistic resistant sheets 1020 containing a polyethylene resin with a melting temperature of about 215-240 degrees F. and a second plurality of uni-ply ballistic resistant sheets 1025 containing a polypropylene resin with a melting temperature of about 255-295 or 295-330 F (see, e.g. FIGS. 11 and 12). Examples include: 1-10 uni-ply ballistic resistant sheets containing a polyethylene resin and 1-10 uni-ply ballistic resistant sheets containing a polypropylene resin; 8-20 uni-ply ballistic resistant sheets containing a polyethylene resin and 8-20 uni-ply ballistic resistant sheets containing a polypropylene resin; 12-20 uni-ply ballistic resistant sheets containing a polyethylene resin and 12-20 uni-ply ballistic resistant sheets containing a polypropylene resin; 20-40 uni-ply ballistic resistant sheets containing a polyethylene resin and 20-40 uni-ply ballistic resistant sheets containing a polypropylene resin; and 40-60 uni-ply ballistic resistant sheets containing a polyethylene resin and 40-60 uni-ply ballistic resistant sheets containing a polypropylene resin.

Examples of suitable stacks 1005 of uni-ply ballistic resistant sheets 50 for a flexible ballistic resistant panel 100 can include a first plurality of THERMOBALLISTIC ballistic resistant sheets 1025 arranged in a stack having a top surface and a bottom surface and bounded on the top surface by a first plurality of K-FLEX ballistic resistant sheets 1020 and bounded on the bottom surface by a second plurality of K-FLEX ballistic resistant sheets 1030, as shown in FIG. 11. Examples include: 2-20 K-FLEX uni-ply ballistic resistant sheets, 2-20 THERMOBALLISTIC uni-ply ballistic resistant sheets, 2-20 K-FLEX uni-ply ballistic resistant sheets; 8-20 K-FLEX uni-ply ballistic resistant sheets, 8-20 THERMOBALLISTIC uni-ply ballistic resistant sheets, 8-20 K-FLEX uni-ply ballistic resistant sheets; 12-20 K-FLEX uni-ply ballistic resistant sheets, 12-20 THERMOBALLISTIC uni-ply ballistic resistant sheets, 12-20 K-FLEX uni-ply ballistic resistant sheets; 16 K-FLEX uni-ply ballistic resistant sheets, 20 THERMOBALLISTIC uni-ply ballistic resistant sheets, 16 K-FLEX uni-ply ballistic resistant sheets; 12 K-FLEX uni-ply ballistic resistant sheets, 16 THERMOBALLISTIC uni-ply ballistic resistant sheets, 12 K-FLEX uni-ply ballistic resistant sheets; 10 K-FLEX uni-ply ballistic resistant sheets, 16 THERMOBALLISTIC uni-ply ballistic resistant sheets, 10 K-FLEX uni-ply ballistic resistant sheets; 8 K-FLEX uni-ply ballistic resistant sheets, 16 THERMOBALLISTIC uni-ply ballistic resistant sheets, 8 K-FLEX uni-ply ballistic resistant sheets; 20-40 K-FLEX uni-ply ballistic resistant sheets, 20-40 THERMOBALLISTIC uni-ply ballistic resistant sheets, 20-40 K-FLEX uni-ply ballistic resistant sheets; and 40-60 K-FLEX uni-ply ballistic resistant sheets, 40-60 THERMOBALLISTIC uni-ply ballistic resistant sheets, 40-60 K-FLEX uni-ply ballistic resistant sheets. In the stacks listed above, adjacent unidirectional ballistic resistant sheets can be oriented to simulate 0/90 x-ply. For instance, in a stack of four sheets of uni-ply, a first sheet can be oriented at 0 degrees, a second sheet can be oriented at 90 degrees, a third sheet can be oriented at 0 degrees, and a fourth sheet can be oriented at 90 degrees.

Examples of suitable stacks 1005 of uni-ply ballistic resistant sheets 50 can include a first plurality of K-FLEX ballistic resistant sheets 1025 arranged in a stack having a top surface and a bottom surface and bounded on the top surface by a first plurality of THERMOBALLISTIC ballistic resistant sheets 1020 and bounded on the bottom surface by a second plurality of THERMOBALLISTIC ballistic resistant sheets 1030, as shown in FIG. 12. Suitable examples include: 2-20 THERMOBALLISTIC uni-ply ballistic resistant sheets, 2-20 K-FLEX uni-ply ballistic resistant sheets, 2-20 THERMOBALLISTIC uni-ply ballistic resistant sheets; 8-20 THERMOBALLISTIC uni-ply ballistic resistant sheets, 8-20 K-FLEX uni-ply ballistic resistant sheets, 8-20 THERMOBALLISTIC uni-ply ballistic resistant sheets; 12-20 THERMOBALLISTIC uni-ply ballistic resistant sheets, 12-20 K-FLEX uni-ply ballistic resistant sheets, 12-20 THERMOBALLISTIC uni-ply ballistic resistant sheets; 16 THERMOBALLISTIC uni-ply ballistic resistant sheets, 20 K-FLEX uni-ply ballistic resistant sheets, 16 THERMOBALLISTIC uni-ply ballistic resistant sheets; 12 THERMOBALLISTIC uni-ply ballistic resistant sheets, 16 K-FLEX uni-ply ballistic resistant sheets, 12 THERMOBALLISTIC uni-ply ballistic resistant sheets; 10 THERMOBALLISTIC uni-ply ballistic resistant sheets, 16 K-FLEX uni-ply ballistic resistant sheets, 10 THERMOBALLISTIC uni-ply ballistic resistant sheets; 8 THERMOBALLISTIC uni-ply ballistic resistant sheets, 16 K-FLEX uni-ply ballistic resistant sheets, 8 THERMOBALLISTIC uni-ply ballistic resistant sheets; 20-40 THERMOBALLISTIC uni-ply ballistic resistant sheets, 20-40 K-FLEX uni-ply ballistic resistant sheets, 20-40 THERMOBALLISTIC uni-ply ballistic resistant sheets; or 40-60 THERMOBALLISTIC uni-ply ballistic resistant sheets, 40-60 K-FLEX uni-ply ballistic resistant sheets, 40-60 THERMOBALLISTIC uni-ply ballistic resistant sheets. In the stacks listed above, adjacent unidirectional ballistic resistant sheets can be oriented to simulate 0/90 x-ply. For instance, in a stack of four sheets of uni-ply, a first sheet can be oriented at 0 degrees, a second sheet can be oriented at 90 degrees, a third sheet can be oriented at 0 degrees, and a fourth sheet can be oriented at 90 degrees.

Examples of suitable stacks 1005 of unidirectional ballistic resistant sheets for a flexible ballistic resistant panel 100 can include a grouping of 2-20, 8-20, 12-20, 20-40, or 40-60 unidirectional ballistic resistant sheets (e.g. 50) made of fibers such as, for example, aramid or UHMWPE fibers. Examples of suitable stacks of unidirectional ballistic resistant sheets 1005 for a ballistic panel 100 can include a grouping of 2-20, 8-20, 12-20, 20-40, or 40-60 unidirectional THERMOBALLISTIC ballistic resistant sheets. Other examples of suitable stacks of unidirectional ballistic resistant sheets 1005 for a ballistic panel 100 can include a grouping of 2-20, 8-20, 12-20, 20-40, or 40-60 unidirectional K-FLEX ballistic resistant sheets. Still other examples of suitable stacks of unidirectional ballistic resistant sheets 1005 for a ballistic panel 100 can include a grouping of 2-20, 8-20, 12-20, 20-40, or 40-60 TENSYLON ballistic resistant sheets.

Panels Constructed from Double X-Ply Ballistic Resistant Sheets

Two x-ply ballistic resistant sheets 250 can be bonded together to produce a configuration known as double x-ply. Examples of suitable stacks 1005 of double x-ply ballistic resistant sheets for a flexible ballistic resistant panel 100 can include a first plurality of double x-ply ballistic resistant sheets 1020 containing a first resin with a first melting temperature and a second plurality of double x-ply ballistic resistant sheets 1025 containing a second resin with a second melting temperature (see, e.g., FIGS. 11 and 12). The second melting temperature can be higher than the first melting temperature. Examples include: 1-10 0/90/0/90 double x-ply ballistic resistant sheets containing a first resin and 1-10 0/90/0/90 double x-ply ballistic resistant sheets containing a second resin; 4-10 0/90/0/90 double x-ply ballistic resistant sheets containing a first resin and 4-10 0/90/0/90 double x-ply ballistic resistant sheets containing a second resin; 6-10 0/90/0/90 double x-ply ballistic resistant sheets containing a first resin and 6-10 0/90/0/90 double x-ply ballistic resistant sheets containing a second resin; 10-15 0/90/0/90 double x-ply ballistic resistant sheets containing a first resin and 10-15 0/90/0/90 double x-ply ballistic resistant sheets containing a second resin; and 15-20 0/90/0/90 double x-ply ballistic resistant sheets containing a first resin and 15-20 0/90/0/90 double x-ply ballistic resistant sheets containing a second resin.

Examples of suitable stacks 1005 of double x-ply ballistic resistant sheets containing aramid fibers can include a first plurality of double x-ply ballistic resistant sheets containing aramid fibers and a first resin having a first melting temperature and a second plurality of double x-ply ballistic resistant sheets containing aramid fibers and a second resin having a second melting temperature (see, e.g., FIGS. 11 and 12). The second melting temperature can be higher than the first melting temperature. Examples include: 1-10 0/90/0/90 double x-ply ballistic resistant sheets containing a first resin and 1-10 0/90/0/90 double x-ply ballistic resistant sheets containing a second resin; 4-10 0/90/0/90 double x-ply ballistic resistant sheets containing a first resin and 4-10 0/90/0/90 double x-ply ballistic resistant sheets containing a second resin; 6-10 0/90/0/90 double x-ply ballistic resistant sheets containing a first resin and 6-10 0/90/0/90 double x-ply ballistic resistant sheets containing a second resin; 10-15 0/90/0/90 double x-ply ballistic resistant sheets containing a first resin and 10-15 0/90/0/90 double x-ply ballistic resistant sheets containing a second resin; and 15-20 0/90/0/90 double x-ply ballistic resistant sheets containing a first resin and 15-20 0/90/0/90 double x-ply ballistic resistant sheets containing a second resin.

Examples of suitable stacks 1005 of double x-ply ballistic resistant sheets for a flexible ballistic resistant panel 100 can include a first plurality of double x-ply ballistic resistant sheets 1020 containing a polyethylene resin with a melting temperature of about 215-240 degrees F. and a second plurality of double x-ply ballistic resistant sheets 1025 containing a polypropylene resin with a melting temperature of about 255-295 or 295-330 F (see, e.g., FIGS. 11 and 12). Examples include: 1-10 0/90/0/90 double x-ply ballistic resistant sheets containing a polyethylene resin and 1-10 0/90/0/90 double x-ply ballistic resistant sheets containing a polypropylene resin; 4-10 0/90/0/90 double x-ply ballistic resistant sheets containing a first resin and 4-10 0/90/0/90 double x-ply ballistic resistant sheets containing a polypropylene resin; 6-10 0/90/0/90 double x-ply ballistic resistant sheets containing a polyethylene resin and 6-10 0/90/0/90 double x-ply ballistic resistant sheets containing a polypropylene resin; 10-15 0/90/0/90 double x-ply ballistic resistant sheets containing a polyethylene resin and 10-15 0/90/0/90 double x-ply ballistic resistant sheets containing a polypropylene resin; and 15-20 0/90/0/90 double x-ply ballistic resistant sheets containing a polyethylene resin and 15-20 0/90/0/90 double x-ply ballistic resistant sheets containing a polypropylene resin.

Examples of suitable stacks 1005 of double x-ply ballistic resistant sheets for a ballistic resistant panel 100 can include a first plurality of THERMOBALLISTIC ballistic resistant sheets 1025 arranged in a stack having a top surface and a bottom surface and bounded on the top surface by a first plurality of K-FLEX ballistic resistant sheets 1020 and bounded on the bottom surface by a second plurality of K-FLEX ballistic resistant sheets 1030, as shown in FIG. 11. Examples include: 1-5 K-FLEX 0/90/0/90 double x-ply ballistic resistant sheets, 1-5 THERMOBALLISTIC 0/90/0/90 double x-ply ballistic resistant sheets, and 1-5 K-FLEX 0/90/0/90 double x-ply ballistic resistant sheets; 2-5 K-FLEX 0/90/0/90 double x-ply ballistic resistant sheets, 2-5 THERMOBALLISTIC 0/90/0/90 double x-ply ballistic resistant sheets, and 2-5 K-FLEX 0/90/0/90 double x-ply ballistic resistant sheets; 3-5 K-FLEX 0/90/0/90 double x-ply ballistic resistant sheets, 3-5 THERMOBALLISTIC 0/90/0/90 double x-ply ballistic resistant sheets, and 3-5 K-FLEX 0/90/0/90 double x-ply ballistic resistant sheets; 4 K-FLEX 0/90/0/90 double x-ply ballistic resistant sheets, 5 THERMOBALLISTIC 0/900/90 double x-ply ballistic resistant sheets, and 4 K-FLEX 0/900/90 double x-ply ballistic resistant sheets; 3 K-FLEX 0/90/0/90 double x-ply ballistic resistant sheets, 4 THERMOBALLISTIC 0/90/0/90 double x-ply ballistic resistant sheets, and 3 K-FLEX 0/90/0/90 double x-ply ballistic resistant sheets; 3 K-FLEX 0/90/0/90 double x-ply ballistic resistant sheets, 4 THERMOBALLISTIC 0/90/0/90 double x-ply ballistic resistant sheets, and 3 K-FLEX 0/90/0/90 double x-ply ballistic resistant sheets; 2 K-FLEX 0/90/0/90 double x-ply ballistic resistant sheets, 4 THERMOBALLISTIC 0/90/0/90 double x-ply ballistic resistant sheets, and 2 K-FLEX 0/90/0/90 double x-ply ballistic resistant sheets; 5-15 K-FLEX 0/90/0/90 double x-ply ballistic resistant sheets, 5-15 THERMOBALLISTIC 0/90/0/90 double x-ply ballistic resistant sheets, and 5-15 K-FLEX 0/90/0/90 double x-ply ballistic resistant sheets; and 15-20 K-FLEX 0/90/0/90 double x-ply ballistic resistant sheets, 15-20 THERMOBALLISTIC 0/90/0/90 double x-ply ballistic resistant sheets, and 15-20 K-FLEX 0/90/0/90 double x-ply ballistic resistant sheets.

Examples of suitable stacks 1005 of double x-ply ballistic resistant sheets for a flexible ballistic resistant panel 100 can include a first plurality of K-FLEX ballistic resistant sheets 1025 arranged in a stack having a top surface and a bottom surface and bounded on the top surface by a first plurality of THERMOBALLISTIC ballistic resistant sheets 1020 and bounded on the bottom surface by a second plurality of THERMOBALLISTIC ballistic resistant sheets 1030, as shown in FIG. 12. Examples include: 1-5 THERMOBALLISTIC 0/90/0/90 double x-ply ballistic resistant sheets, 1-5 K-FLEX 0/90/0/90 double x-ply ballistic resistant sheets, and 1-5 THERMOBALLISTIC 0/90/0/90 double x-ply ballistic resistant sheets; 2-5 THERMOBALLISTIC 0/90/0/90 double x-ply ballistic resistant sheets, 2-5 K-FLEX 0/90/0/90 double x-ply ballistic resistant sheets, and 2-5 THERMOBALLISTIC 0/90/0/90 double x-ply ballistic resistant sheets; 3-5 THERMOBALLISTIC 0/90/0/90 double x-ply ballistic resistant sheets, 3-5 K-FLEX 0/90/0/90 double x-ply ballistic resistant sheets, and 3-5 THERMOBALLISTIC 0/90/0/90 double x-ply ballistic resistant sheets; 4 THERMOBALLISTIC 0/90/0/90 double x-ply ballistic resistant sheets, 5 K-FLEX 0/90/0/90 double x-ply ballistic resistant sheets, and 4 THERMOBALLISTIC 0/90/0/90 double x-ply ballistic resistant sheets; 3 THERMOBALLISTIC 0/90/0/90 double x-ply ballistic resistant sheets, 4 K-FLEX 0/90/0/90 double x-ply ballistic resistant sheets, and 3 THERMOBALLISTIC 0/90/0/90 double x-ply ballistic resistant sheets; 3 THERMOBALLISTIC 0/90/0/90 double x-ply ballistic resistant sheets, 4 K-FLEX 0/90/0/90 double x-ply ballistic resistant sheets, and THERMOBALLISTIC 0/90/0/90 double x-ply ballistic resistant sheets; 2 THERMOBALLISTIC 0/90/0/90 double x-ply ballistic resistant sheets, 4 K-FLEX 0/90/0/90 double x-ply ballistic resistant sheets, and 2 THERMOBALLISTIC 0/90/0/90 double x-ply ballistic resistant sheets; 5-15 THERMOBALLISTIC 0/90/0/90 double x-ply ballistic resistant sheets, 5-15 K-FLEX 0/90/0/90 double x-ply ballistic resistant sheets, and 5-15 THERMOBALLISTIC 0/90/0/90 double x-ply ballistic resistant sheets; and 15-20 THERMOBALLISTIC 0/90/0/90 double x-ply ballistic resistant sheets, 15-20 K-FLEX 0/90/0/90 double x-ply ballistic resistant sheets, and 15-20 THERMOBALLISTIC 0/90/0/90 double x-ply ballistic resistant sheets.

Examples of suitable stacks 1005 of double x-ply ballistic resistant sheets for a flexible ballistic resistant panel 100 can include a grouping of 1-10, 4-10, 6-10, 10-15, or 15-20 double x-ply ballistic resistant sheets made of fibers such as, for example, aramid or UHMWPE fibers. Examples of suitable stacks 1005 of double x-ply ballistic resistant sheets for a ballistic panel 100 can include a grouping of 1-10, 4-10, 6-10, 10-15, or 15-20 THERMOBALLISTIC 0/90/0/90 double x-ply ballistic resistant sheets. Other examples of suitable stacks of double x-ply ballistic resistant sheets 1005 for a ballistic panel 100 can include a grouping of 1-10, 4-10, 6-10, 10-15, or 15-20 K-FLEX 0/90/0/90 double x-ply ballistic resistant sheets.

Panels Constructed from Uni-Ply, X-Ply, or Double X-Ply Ballistic Resistant Sheets

Although specific examples of stacks 1005 made exclusively of uni-ply, x-ply, or double x-ply ballistic resistant sheets are provided herein, these examples are not limiting. Suitable stacks 1005 can include any combination of uni-ply, x-ply, double-x ply, triple x-ply, or other more elaborate multilayered ballistic resistant sheets. In any of the examples provided herein, two uni-ply ballistic resistant sheets can be substituted for an x-ply ballistic resistant sheet, an x-ply ballistic resistant sheet can be substituted for two uni-ply ballistic resistant sheets, four uni-ply ballistic resistant sheets can be substituted for a double x-ply ballistic resistant sheet, a double x-ply ballistic resistant sheet can be substituted for four uni-ply ballistic resistant sheets, two x-ply ballistic resistant sheets can be substituted for a double x-ply ballistic resistant sheets, a double x-ply ballistic resistant sheet can be substituted for two x-ply ballistic resistant sheets, and so on.

Panels Constructed from Ballistic Resistant Sheets and Fiberglass Sheets

One or more fiberglass sheets (e.g. sheets made of woven glass fibers or sheets made of glass fibers arranged unidirectionally into uni-ply or x-ply) can be incorporated into any of the various stacks 1005 of ballistic resistant sheets described herein to form a ballistic resistant panel 100 (see, e.g. FIG. 13). Fiberglass sheets have several attributes that make them desirable for inclusion in the ballistic resistant panel 100. Specifically, fiberglass sheets are less expensive than sheets made of aramid fibers. Also, fiberglass sheets can enhance stab resistance of the panel 100. Fiberglass sheets can have any suitable thickness depending on the application of the panel 100. For example, for applications that require flexible panels 100, the thickness of each fiberglass sheet can be about 0.006, 0.009, 0.010, 0.005-0.020, 0.010-0.020, or 0.020-0.030 inches.

Examples of suitable stacks 1005 of ballistic resistant sheets for a ballistic resistant panel 100 can include a plurality of x-ply ballistic resistant sheets containing aramid fibers and a first resin with a first melting temperature and a plurality of fiberglass sheets containing glass fibers (see, e.g. FIG. 13). Examples include: 1-10 x-ply ballistic resistant sheets containing aramid fibers and resin and 1-10 fiberglass sheets; 4-10 x-ply ballistic resistant sheets containing aramid fibers and resin and 4-10 fiberglass sheets; 6-10 x-ply ballistic resistant sheets containing aramid fibers and resin and 6-10 fiberglass sheets; 10-15 x-ply ballistic resistant sheets containing aramid fibers and resin and 10-15 fiberglass sheets; and 15-20 x-ply ballistic resistant sheets containing aramid fibers and resin and 15-20 fiberglass sheets.

Examples of suitable stacks of ballistic resistant sheets for a ballistic resistant panel 100 can include a first plurality of x-ply ballistic resistant sheets containing a polyethylene resin with a melting temperature of about 215-240 degrees F. and a plurality of s-glass sheets (see, e.g. FIG. 13). Suitable examples include: 1-10 0/90 x-ply ballistic resistant sheets containing a polyethylene resin and 1-10 s-glass fiberglass sheets; 4-10 0/90 x-ply ballistic resistant sheets containing a polyethylene resin and 4-10 s-glass fiberglass sheets; 6-10 0/90 x-ply ballistic resistant sheets containing a polyethylene resin and 6-10 s-glass fiberglass sheets; 10-20 0/90 x-ply ballistic resistant sheets containing a polyethylene resin and 10-20 s-glass fiberglass sheets; 20-30 0/90 x-ply ballistic resistant sheets containing a polyethylene resin and 20-30 s-glass fiberglass sheets.

Examples of suitable stacks 1005 of ballistic resistant sheets for a ballistic resistant panel 100 can include a first plurality of s-glass fiberglass sheets 1025 arranged in a stack having a top surface and a bottom surface and bounded on the top surface by a first plurality of K-FLEX ballistic resistant sheets 1020 and bounded on the bottom surface by a second plurality of K-FLEX ballistic resistant sheets 1030, as shown in FIG. 13. Examples include: 1-10 K-FLEX 0/90 x-ply ballistic resistant sheets, 1-10 s-glass fiberglass sheets, and 1-10 K-FLEX 0/90 x-ply ballistic resistant sheets; 4-10 K-FLEX 0/90 x-ply ballistic resistant sheets, 4-10 s-glass fiberglass sheets, and 4-10 K-FLEX 0/90 x-ply ballistic resistant sheets; 6-10 K-FLEX 0/90 x-ply ballistic resistant sheets, 6-10 s-glass fiberglass sheets, and 6-10 K-FLEX 0/90 x-ply ballistic resistant sheets; 8 K-FLEX 0/90 x-ply ballistic resistant sheets, 10 s-glass fiberglass sheets, and 8 K-FLEX 0/90 x-ply ballistic resistant sheets; 8 K-FLEX 0/90 x-ply ballistic resistant sheets, 5-7 s-glass fiberglass sheets, and 8 K-FLEX 0/90 x-ply ballistic resistant sheets; 6 K-FLEX 0/90 x-ply ballistic resistant sheets, 8 s-glass fiberglass sheets, and 6 K-FLEX 0/90 x-ply ballistic resistant sheets; 5 K-FLEX 0/90 x-ply ballistic resistant sheets, 8 s-glass fiberglass sheets, and 5 K-FLEX 0/90 x-ply ballistic resistant sheets; 4 K-FLEX 0/90 x-ply ballistic resistant sheets, 8 s-glass fiberglass sheets, and 4 K-FLEX 0/90 x-ply ballistic resistant sheets; 6 K-FLEX 0/90 x-ply ballistic resistant sheets, 6 s-glass fiberglass sheets, and 6 K-FLEX 0/90 x-ply ballistic resistant sheets; 5 K-FLEX 0/90 x-ply ballistic resistant sheets, 5 s-glass fiberglass sheets, and 5 K-FLEX 0/90 x-ply ballistic resistant sheets; and 2 or more K-FLEX 0/90 x-ply ballistic resistant sheets, 1 or more s-glass fiberglass sheets, and 2 or more K-FLEX 0/90 x-ply ballistic resistant sheets.

Suitable stacks 1005 can include one or more uni-ply ballistic resistant sheets and one or more fiberglass sheets. Examples include: 1-20 K-FLEX uni-ply ballistic resistant sheets, 1-10 s-glass fiberglass sheets, and 1-20 K-FLEX uni-ply ballistic resistant sheets; 8-20 K-FLEX uni-ply ballistic resistant sheets, 4-10 s-glass fiberglass sheets, and 8-20 K-FLEX uni-ply ballistic resistant sheets; 12-20 K-FLEX uni-ply ballistic resistant sheets, 6-10 s-glass fiberglass sheets, and 12-20 K-FLEX uni-ply ballistic resistant sheets; 16 K-FLEX uni-ply ballistic resistant sheets, 10 s-glass fiberglass sheets, and 16 K-FLEX uni-ply ballistic resistant sheets; 16 K-FLEX uni-ply ballistic resistant sheets, 5-7 s-glass fiberglass sheets, and 16 K-FLEX uni-ply ballistic resistant sheets; 12 K-FLEX uni-ply ballistic resistant sheets, 8 s-glass fiberglass sheets, and 12 K-FLEX uni-ply ballistic resistant sheets; 10 K-FLEX uni-ply ballistic resistant sheets, 8 s-glass fiberglass sheets, and 10 K-FLEX uni-ply ballistic resistant sheets; 8 K-FLEX uni-ply ballistic resistant sheets, 8 s-glass fiberglass sheets, and 8 K-FLEX uni-ply ballistic resistant sheets; 12 K-FLEX uni-ply ballistic resistant sheets, 6 s-glass fiberglass sheets, and 12 K-FLEX 0/90 x-ply ballistic resistant sheets; and 10 K-FLEX uni-ply ballistic resistant sheets, 5 s-glass fiberglass sheets, and 10 K-FLEX uni-ply ballistic resistant sheets; and 2 or more K-FLEX uni-ply ballistic resistant sheets, 1 or more s-glass fiberglass sheets, and 2 or more K-FLEX uni-ply ballistic resistant sheets.

Suitable stacks 1005 can include one or more double x-ply ballistic resistant sheets and one or more fiberglass sheets. Examples include: 1-10 K-FLEX 0/90/0/90 double x-ply ballistic resistant sheets, 1-10 s-glass fiberglass sheets, and 1-10 K-FLEX 0/90/0/90 double x-ply ballistic resistant sheets; 2-5 K-FLEX 0/90/0/90 double x-ply ballistic resistant sheets, 4-10 s-glass fiberglass sheets, and 2-5 K-FLEX 0/90/0/90 double x-ply ballistic resistant sheets; 6-10 K-FLEX 0/90/0/90 double x-ply ballistic resistant sheets, 6-10 s-glass fiberglass sheets, and 3-5 K-FLEX 0/90/0/90 double x-ply ballistic resistant sheets; 4 K-FLEX 0/90/0/90 double x-ply ballistic resistant sheets, 10 s-glass fiberglass sheets, and 4 K-FLEX 0/90/0/90 double x-ply ballistic resistant sheets; 4 K-FLEX 0/90/0/90 double x-ply ballistic resistant sheets, 5-7 s-glass fiberglass sheets, and 4 K-FLEX 0/90/0/90 double x-ply ballistic resistant sheets; 3 K-FLEX 0/90/0/90 double x-ply ballistic resistant sheets, 4-8 s-glass fiberglass sheets, and 3 K-FLEX 0/90/0/90 double x-ply ballistic resistant sheets; 2 K-FLEX 0/90/0/90 double x-ply ballistic resistant sheets, 4-8 s-glass fiberglass sheets, and 2 K-FLEX 0/90/0/90 double x-ply ballistic resistant sheets; 4 K-FLEX 0/90/0/90 double x-ply ballistic resistant sheets, 8 s-glass fiberglass sheets, and 4 K-FLEX 0/90/0/90 double x-ply ballistic resistant sheets; 3 K-FLEX 0/90/0/90 double x-ply ballistic resistant sheets, 6 s-glass fiberglass sheets, and 3 K-FLEX 0/90/0/90 double x-ply ballistic resistant sheets; 3 K-FLEX 0/90/0/90 double x-ply ballistic resistant sheets, 5 s-glass fiberglass sheets, and 3 K-FLEX 0/90/0/90 double x-ply ballistic resistant sheets; and 2 or more K-FLEX 0/90/0/90 double x-ply ballistic resistant sheets, 1 or more s-glass fiberglass sheets, and 2 or more K-FLEX 0/90/0/90 double x-ply ballistic resistant sheets.

A method of manufacturing a ballistic resistant panel 100 can include providing a stack of ballistic resistant sheets 1005, inserting the stack of ballistic resistant sheets into a variable volume container 13, evacuating air from the vacuum bag, and heating the stack of ballistic resistant sheets in the vacuum bag to a predetermined temperature for a predetermined duration. In some examples, the predetermined temperature can be about 250-550, 225-550, 225-350, 250-300, 250-275, 265-275, 225-250, or 200-240 degrees F., and the predetermined duration can be about 1, 5, 15-30, 30-60, 45-60, 60-120, 120-240, or 240-480 minutes. The method can include applying a predetermined pressure to the stack of ballistic resistant sheets in the vacuum bag for a second predetermined duration. The predetermined pressure can be about 10-100, 50-75, 75-100, 100-500, 500-1,000, 1,000-2,500, 2,500-15,000, or 15,000-30,000 psi, and the second predetermined duration can be about 1, 5, 15-30, 30-60, 45-60, 60-120, 120-240, or 240-480 minutes. The step of heating the stack of ballistic resistant sheets in the vacuum bag to the predetermined temperature for the predetermined duration can occur concurrently with applying the predetermined pressure to the stack of ballistic resistant sheets in the variable volume container 13 for the second predetermined duration. The method can include encasing the stack of ballistic resistant sheets 1005 in a waterproof cover 1105 prior to inserting the stack of ballistic resistant sheets into the variable volume container 13. The waterproof cover 1105 can be made of nylon coated with polyurethane, polypropylene, polyethylene, or polyvinylchloride.

With respect to the method described above, the stack of ballistic resistant sheets 1005 can include a first plurality of ballistic resistant sheets 1020 having a first resin with a melting temperature of about 215-240, 240-265, 265-295, or 295-340 degrees F. The stack 1005 can also include a second plurality of ballistic resistant sheets 1025 adjacent to the first plurality of ballistic resistant sheets, where the second plurality of ballistic resistant sheets have a second resin with a melting temperature of about 255-295, 295-330, 330-355, or 355-375 degrees F. The stack 1005 can also include a third plurality of ballistic resistant sheets 1030 adjacent to the second plurality of ballistic resistant sheets, where the third plurality of ballistic resistant sheets have a third resin with a melting temperature of about 215-240, 240-265, 265-295, or 295-340 degrees F. The first plurality of ballistic resistant sheets 1020 can include 1-10, 10-20, or 20-30 x-ply ballistic resistant sheets, where the ballistic resistant sheets are made of aramid fibers and the first resin is made of polyethylene. The second plurality of ballistic resistant sheets 1025 can include 1-10, 10-20, or 20-30 x-ply ballistic resistant sheets, where the ballistic resistant sheets are made of aramid fibers and the second resin is made of polypropylene. Similar to the first plurality of ballistic resistant sheets 1020, the third plurality of ballistic resistant sheets 1030 can include 1-10, 10-20, or 20-30 x-ply ballistic resistant sheets, where the ballistic resistant sheets are made of aramid fibers and the third resin is made of polyethylene.

Following the heating and pressure steps described above, the method can also include a step of cooling the stack of ballistic resistant sheets 1005 in the variable volume container 13 from the predetermined temperature to room temperature. Cooling can occur using any suitable heat transfer method, such as natural convection, forced convection, or conduction (e.g. by submerging the waterproof panels 100 in a cooling bath).

In some methods of manufacturing flexible ballistic resistant panels 100, a stack of ballistic resistant sheets 1005 can be provided where the stack has a first plurality of ballistic resistant sheets 1020, a second plurality of ballistic resistant sheets 1025 adjacent to the first plurality of ballistic resistant sheets, and a third plurality of ballistic resistant sheets 1030 adjacent to the second plurality of ballistic resistant sheets. Each of the first plurality of ballistic resistant sheets 1020 can be formed of a first arrangement of aramid fibers, where the first arrangement of aramid fibers defines a two-dimensional pattern. The first plurality of ballistic resistant sheets 1020 can be stacked according to the two-dimensional pattern. Each of the second plurality of ballistic resistant sheets 1025 can be formed of a second arrangement of aramid fibers, where the second arrangement of aramid fibers substantially conforms to the two-dimensional pattern. The second plurality of ballistic resistant sheets 1025 can be stacked according to the two-dimensional pattern. Each of the third plurality of ballistic resistant sheets 1030 can be formed of a third arrangement of aramid fibers, where the third arrangement of aramid fibers substantially conforms to the two-dimensional pattern. The third plurality of ballistic resistant sheets 1030 can be stacked according to the two-dimensional pattern. The first plurality of ballistic resistant sheets 1020, the second plurality of ballistic resistant sheets 1025, and the third plurality of ballistic resistant sheets 1030 can be formed in a stack 1005 according to the two-dimensional pattern. The method can include inserting the stack of ballistic resistant sheets 1005 into a variable volume container 13 and evacuating air from the vacuum bag. The method can include heating the stack of ballistic resistant sheets 1005 to a predetermined temperature for a predetermined duration. The predetermined temperature can be between about 200 and 500 degrees F. and, more specifically, about 250-300, 265-275, 225-250, or 200-240 degrees F. The predetermined duration can be at least 5 minutes and, more specifically, about 30-45, 45-60, or 60-120 minutes. The method can include applying a predetermined pressure to the stack of ballistic resistant sheets 1005 in the variable volume container 13 for a second predetermined duration. The predetermined pressure can be at least 10 psi, and the second predetermined duration is at least 5 minutes. More specifically, the predetermined pressure can be about 10-100, 50-75, or 75-100 psi, and the second predetermined duration can be about 30-45, 45-60, 60-120, 120-240, 240-480 minutes.

In the method described above, applying the predetermined pressure to the stack of ballistic resistant sheets 1005 in the variable volume container 13 for the second predetermined duration can occur concurrently with heating the stack of ballistic resistant sheets in the vacuum bag to the predetermined temperature for the predetermined duration. The method can include encasing the stack of ballistic resistant sheets 1005 in a waterproof cover 1105, as shown in FIG. 7, prior to inserting the stack of ballistic resistant sheets into the variable volume container 13. The waterproof cover can be made of nylon coated with polyurethane, polyvinylchloride, polypropylene, or polyethylene.

In the method described above, the first plurality of ballistic resistant sheets 1020 can include a first resin with a melting temperature of about 215-240 degrees F., the second plurality of ballistic resistant sheets 1025 can include a second resin with a melting temperature of about 255-295 degrees F., and the third plurality of ballistic resistant sheets 1030 can include a third resin with a melting temperature of about 215-240 degrees F. To promote partial or full bonding of the ballistic resistant sheets within the first and third pluralities of ballistic resistant sheets (and to avoid bonding of the ballistic resistant sheets within second plurality of ballistic resistant sheets 1025), the predetermined temperature can be about 200-240 or 225-250 degrees F., which is below the melting temperature of the second resin.

In another example, the first plurality of ballistic resistant sheets 1020 can include a first resin with a melting temperature of about 215-240 degrees F., the second plurality of ballistic resistant sheets 1025 can include a second resin with a melting temperature of about 295-330 degrees F., and the third plurality of ballistic resistant sheets 1030 can include a third resin with a melting temperature of about 215-240 degrees F. To promote partial or full bonding of the ballistic resistant sheets within the first and third pluralities of ballistic resistant sheets (and to avoid bonding of the ballistic resistant sheets within second plurality of ballistic resistant sheets 1025), the predetermined temperature can be about 200-240, 225-250, or 265-275 degrees F., which is below the melting temperature of the second resin. In this example, the first plurality of ballistic resistant sheets 1020 can include 1-10 K-FLEX 0/90 x-ply ballistic resistant sheets, the second plurality of ballistic resistant sheets 1025 can include 1-10 THERMOBALLISTIC 0/90 x-ply ballistic resistant sheets, and the third plurality of ballistic resistant sheets 1030 can include 1-10 K-FLEX 0/90 x-ply ballistic resistant sheets.

The method described above can further include cooling the stack of ballistic resistant sheets 1005 in the vacuum bag from the predetermined temperature to room temperature. The method can also include subjecting the panel 100 to a break-in process to enhance its flexibility.

### Flexible Ballistic Panels Having a Plurality of Ballistic Resistant Sheets

In one example (see, e.g. FIGS. 9 and 10), a flexible ballistic resistant panel can include a plurality of ballistic resistant sheets (i.e. a stack 1005 of ballistic resistant sheets). Each of the plurality of ballistic resistant sheets can be formed of an arrangement of high performance fibers (e.g. aramid fibers), and the arrangement of high performance fibers can define a two-dimensional pattern. The plurality of ballistic resistant sheets can be stacked according to the two-dimensional pattern, where each of the plurality of ballistic resistant sheets is at least partially bonded to at least one adjacent ballistic resistant sheet in the plurality of ballistic resistant sheets. In some examples, the plurality of ballistic resistant sheets 1005 can include 1-10, 10-20, or 20-30 ballistic resistant sheets. The plurality of ballistic resistant sheets 1005 can be made of a plurality of high performance fibers coated with a thermoplastic polymer resin. The thermoplastic polymer resin can have a melting temperature of about 215-240, 240-265, 265-295, 295-340, 340-355, or 355-375 degrees F.

In another example (see, e.g. FIGS. 9 and 10), a flexible ballistic resistant panel 100 can include a plurality of ballistic resistant sheets 1005. Each of the plurality of ballistic resistant sheets can be formed of an arrangement of high performance fibers, such as thermoplastic polyethylene fibers (e.g. UHMWPE fibers), and the arrangement of thermoplastic polyethylene fibers can define a two-dimensional pattern. The plurality of ballistic resistant sheets 1005 can be stacked according to the two-dimensional pattern, where each of the plurality of ballistic resistant sheets is at least partially bonded to at least one adjacent ballistic resistant sheet in the plurality of ballistic resistant sheets. In some examples, the plurality of ballistic resistant sheets can include 1-10, 10-20, or 20-30 ballistic resistant sheets made of thermoplastic polyethylene fabric, such as TENSYLON.

The plurality of ballistic resistant sheets 1005, whether containing aramid fibers, thermoplastic polyethylene fibers, or both, can be encased by a protective cover 1105, as shown in FIGS. 9 and 10. The protective cover 1105 can be a waterproof cover and can be made of any suitable material, such as rubber, NYLON, RAYON, ripstop NYLON, CORDURA, polyvinyl chloride, polyurethane, silicone elastomer, or fluoropolymer. The waterproof cover 1105 can be adhered to an outer surface of the plurality of ballistic resistant sheets 1005 to prevent movement of the plurality of ballistic resistant sheets relative to the waterproof cover. The flexible ballistic resistant panel 100 can include a coating on the inner surface of the waterproof cover 1105. The coating can improve water resistance and can serve as an adhesive layer. The coating can be made of, for example, polyurethane, polyvinylchloride, polyethylene, or polypropylene.

### Flexible Ballistic Panels Having First and Second Pluralities of Ballistic Resistant Sheets

A flexible ballistic resistant panel 100 can include a first plurality of ballistic resistant sheets 1020 made of aramid fibers and coated with a first resin having a first melting temperature. The flexible ballistic resistant panel can also include a second plurality of ballistic resistant sheets 1025 adjacent to the first plurality of ballistic resistant sheets, where the second plurality of ballistic resistant sheets are made of aramid fibers coated with a second resin having a second melting temperature. The second melting temperature can be greater than the first melting temperature. The first resin can be a thermoplastic polymer with a melting temperature of about 215-240 degrees F. The second resin can be a thermoplastic polymer with a melting temperature of about 255-295 or 295-330 degrees F. In some examples, the first resin can be polyethylene, and the second resin can be polypropylene. The first plurality of ballistic resistant sheets 1020 can include about 1-10, 10-20, or 20-30 ballistic resistant sheets. Similarly, the second plurality of ballistic resistant sheets 1025 can include about 1-10, 10-20, or 20-30 ballistic resistant sheets. In certain examples, the first plurality of ballistic resistant sheets 1020 can include 1-10, 10-20, or 20-30 K-FLEX 0/90 x-ply ballistic resistant sheets, and the second plurality of ballistic resistant sheets 1025 can include 1-10, 10-20, or 20-30 THERMOBALLISTIC 0/90 x-ply ballistic resistant sheets. In some examples, the first plurality of ballistic resistant sheets 1020 can include 5-10 K-FLEX 0/90 x-ply ballistic resistant sheets, and the second plurality of ballistic resistant sheets 1025 can include 5-10 THERMOBALLISTIC 0/90 x-ply ballistic resistant sheets. The flexible ballistic resistant panel 100 can include a waterproof cover 1105 encasing the first and second pluralities of ballistic resistant sheets (1020, 1025). The waterproof cover 1105 can be made of any suitable material, such as nylon coated with polyurethane, polypropylene, polyvinylchloride, or polyethylene.

### Flexible Ballistic Panels Having First, Second, and Third Pluralities of Ballistic Resistant Sheets

A flexible ballistic resistant panel 100 can include a first plurality of ballistic resistant sheets 1020, each of the first plurality of ballistic resistant sheets 1020 being formed of a first arrangement of aramid fibers. The first arrangement of aramid fibers can define a two-dimensional pattern, where the two-dimensional pattern corresponds to a two-dimensional perimeter shape of the ballistic resistant sheet containing the first arrangement of aramid fibers. The first plurality of ballistic resistant sheets 1020 can be stacked according to the two-dimensional pattern. The flexible ballistic resistant panel 100 can include a second plurality of ballistic resistant sheets 1025 adjacent to the first plurality of ballistic resistant sheets. Each of the second plurality of ballistic resistant sheets 1025 can be formed of a second arrangement of aramid fibers. The second arrangement of aramid fibers can substantially conform to the two-dimensional pattern, and the second plurality of ballistic resistant sheets can be stacked according to the two-dimensional pattern. The flexible ballistic resistant panel 100 can include a third plurality of ballistic resistant sheets 1030 adjacent to the second plurality of ballistic resistant sheets. Each of the third plurality of ballistic resistant sheets 1030 can be formed of a third arrangement of aramid fibers. The third arrangement of aramid fibers can substantially conform to the two-dimensional pattern, and the third plurality of ballistic resistant sheets 1030 can be stacked according to the two-dimensional pattern. The first plurality of ballistic resistant sheets 1020, the second plurality of ballistic resistant sheets 1025, and the third plurality of ballistic resistant sheets 1030 can be formed in a stack 1005 according to the two-dimensional pattern. The flexible ballistic resistant panel 100 can include a waterproof cover 1105 encasing the first plurality of ballistic resistant sheets 1020, the second plurality of ballistic resistant sheets 1025, and the third plurality of ballistic resistant sheets 1030. Within the panel 100, each of the first plurality of ballistic resistant sheets 1020 can be at least partially bonded to at least one adjacent ballistic resistant sheet in the first plurality of ballistic resistant sheets. Likewise, each of the third plurality of ballistic resistant sheets 1030 can be at least partially bonded to at least one adjacent ballistic resistant sheet in the third plurality of ballistic resistant sheets.

The first plurality of ballistic resistant sheets 1020 can include 1-10, 10-20, or 20-30 ballistic resistant sheets, the second plurality of ballistic resistant sheets 1025 can include 1-10, 10-20, or 20-30 ballistic resistant sheets, and the third plurality of ballistic resistant sheets 1030 can include 1-10, 10-20, or 20-30 ballistic resistant sheets. In some examples, where the flexible ballistic resistant panel 100 is configured to be certified as Type IIIA flexible armor under NIJ Standard-0101.06, the first plurality of ballistic resistant sheets 1020 can include 5-10 or 6-8 ballistic resistant sheets (e.g. 250), the second plurality of ballistic resistant sheets 1025 can include 5-10 or 6-8 ballistic resistant sheets (e.g. 250), and the third plurality of ballistic resistant sheets 1030 can include 5-10 or 6-8 ballistic resistant sheets (e.g. 250). In some examples, the first plurality of ballistic resistant sheets 1020 can be K-FLEX 0/90 x-ply ballistic resistant sheets, the second plurality of ballistic resistant sheets 1025 can be THERMOBALLISTIC 0/90 x-ply ballistic resistant sheets, and the third plurality of ballistic resistant sheets 1030 can be K-FLEX 0/90 x-ply ballistic resistant sheets. The panel 100 can have a thickness of less than 0.5, 0.375, or 0.25 inches, and where the panel is configured to be certified as Type IIIA flexible armor under NIJ Standard-0101.06, can have a thickness of 0.15-0.22 or about 0.215 inches.

The first plurality of ballistic resistant sheets 1020 can include a first resin made of polyethylene and having a melting temperature of about 215-240, 240-265, 265-295, or 295-340 degrees F. The second plurality of ballistic resistant sheets 1025 can include a second resin made of polypropylene and having a melting temperature of about 255-295, 295-330, 330-355, or 355-375 degrees F. The third plurality of ballistic resistant sheets 1030 can include a third resin made of polyethylene and having a melting temperature of about 215-240, 240-265, 265-295, or 295-340 degrees F.

In some examples, the flexible ballistic resistant panel 100 can include a first plurality of ballistic resistant sheets 1020 made of high performance fibers, such as aramid fibers. Each ballistic resistant sheet within the first plurality of ballistic resistant sheets 1020 can be at least partially bonded to at least one adjacent ballistic resistant sheet in the first plurality of ballistic resistant sheets. The panel 100 can include a second plurality of ballistic resistant sheets 1025 made of high performance fibers, such as aramid fibers. The second plurality of ballistic resistant sheets 1025 can be positioned adjacent to the first plurality of ballistic resistant sheets 1020. The panel 100 can include a third plurality of ballistic resistant sheets 1030 made of high performance fibers, such as aramid fibers. The third plurality of ballistic resistant sheets 1030 can be positioned adjacent to the second plurality of ballistic resistant sheets 1025. Each ballistic resistant sheet within the third plurality of ballistic resistant sheets 1030 can be at least partially bonded to at least one adjacent ballistic resistant sheet in the third plurality of ballistic resistant sheets. The first plurality of ballistic resistant sheets 1020 can include 1-10, 10-20, or 20-30 ballistic resistant sheets, the second plurality of ballistic resistant sheets 1025 can include 1-10, 10-20, or 20-30 ballistic resistant sheets, and the third plurality of ballistic resistant sheets 1030 can include 1-10, 10-20, or 20-30 ballistic resistant sheets. In certain examples, first plurality of ballistic resistant sheets 1020 can include 1-10 K-FLEX 0/90 x-ply ballistic resistant sheets, the second plurality of ballistic resistant sheets 1025 can include 1-10 THERMOBALLISTIC 0/90 x-ply ballistic resistant sheets or s-glass fiberglass sheets, and the third plurality of ballistic resistant sheets 1030 can include 1-10 K-FLEX 0/90 x-ply ballistic resistant sheets. The panel 100 can include a waterproof cover encasing a stack of ballistic resistant sheets 1005 consisting of the first plurality of ballistic resistant sheets 1020, the second plurality of ballistic resistant sheets 1025, and the third plurality of ballistic resistant sheets 1030. In some examples, the waterproof cover 1105 can be made of nylon coated with polyurethane, polypropylene, polyethylene, or polyvinylchloride. A first resin in the first plurality of ballistic resistant sheets 1020 can have a melting temperature of about 215-240, 240-265, 265-295, or 295-340 degrees F. A second resin in the second plurality of ballistic resistant sheets 1025 can have a melting temperature of about 255-295, 295-330, 330-355, or 355-375 degrees F. A third resin in the third plurality of ballistic resistant sheets can have a melting temperature of about 215-240, 240-265, 265-295, or 295-340 degrees F.

### Stitching

An advantage of the flexible ballistic resistant panels 100 described herein over existing panels is that no stitching is required to manufacture the panels. Instead of stitching, combinations of processes described herein (e.g. vacuum-bagging, applying heat, applying pressure) result in full or partial bonding between adjacent layers of ballistic resistant sheets in the stack 1005. This full or partial bonding resists movement of the ballistic resistant sheets (e.g. 250) relative to each other (similar to how a stitch would) and improves performance of the panel when struck by a projectile. Ballistic resistant panels 100 without stitching are less labor intensive than panels with stitching and don't require access to industrial sewing machines. Consequently, panels 100 without stitching can be manufactured at a lower cost.

The flexible ballistic resistant panels 100 described herein do not require stitching to be as effective, or more effective, than existing panels with similar dimensions. However, where added labor costs are not a primary concern, the panels described herein can include stitches, such as quilt stitches, radial stitches, row stitches, box stitches, or a combination thereof. Stitches can be added to the stack of ballistic resistant sheets at any stage in the manufacturing process, including before vacuum bagging, after vacuum bagging, before heating, after heating, before applying pressure, or after applying pressure, etc. Stitches may be desirable to defend against certain types of ballistic threats.

### Reversible Panel

Some ballistic resistant panels, such as ceramic trauma plates known as small arms protective inserts (SAPI), are designed to have a strike face and a wear face. A strike face is a surface that is designed to face an incoming ballistic threat, and a wear face is a surface that is designed to face the wearer's torso. Panels with a strike face are directional and must be oriented with the strike face facing toward an incoming projectile. If the panel is improperly oriented and a projectile strikes the wear face, the panel will likely fail to perform at the panel's certification level. For example, if a soldier inserts a ballistic resistant panel into a carrier vest 108, but accidentally orients the panel with the wear face directed outward, the panel may fail to perform according to its certification level when struck by a projectile, and the projectile may pass through the panel.

To ensure consistent performance of the ballistic resistant panel regardless of its orientation, it can be desirable to create a panel 100 that does not have a wear face. Instead, the ballistic resistant panel's 100 construction can be symmetrical or nearly symmetrical from a front surface to a back surface (e.g. the panel can have a symmetrical arrangement of ballistic resistant sheets), thereby permitting either side of the panel to serve as a strike face without altering performance. In other instances, it may be suitable to have a non-symmetrical panel. For example, a non-symmetrical panel may be suitable where the panel will be permanently or semi-permanently installed (e.g. in a vehicle door or around an oil or gas pipeline), since the panel will not be moved often and, therefore, the risk of user installation error is greatly diminished or eliminated entirely.

### Multiple Stacks of Ballistic Resistant Sheets

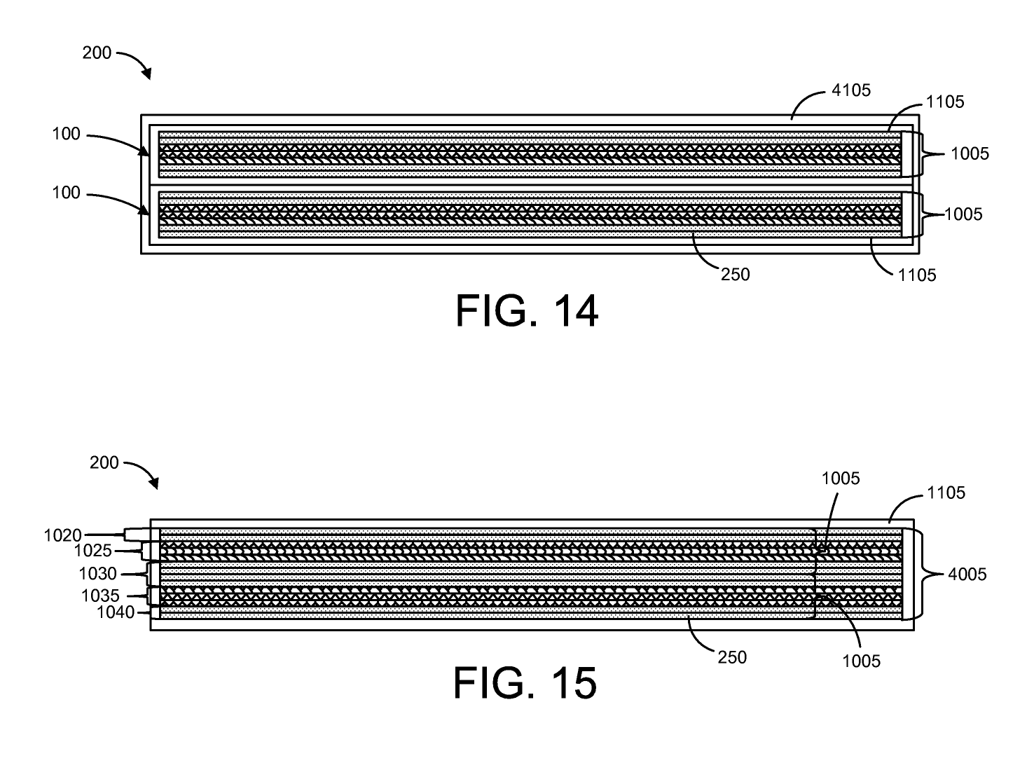

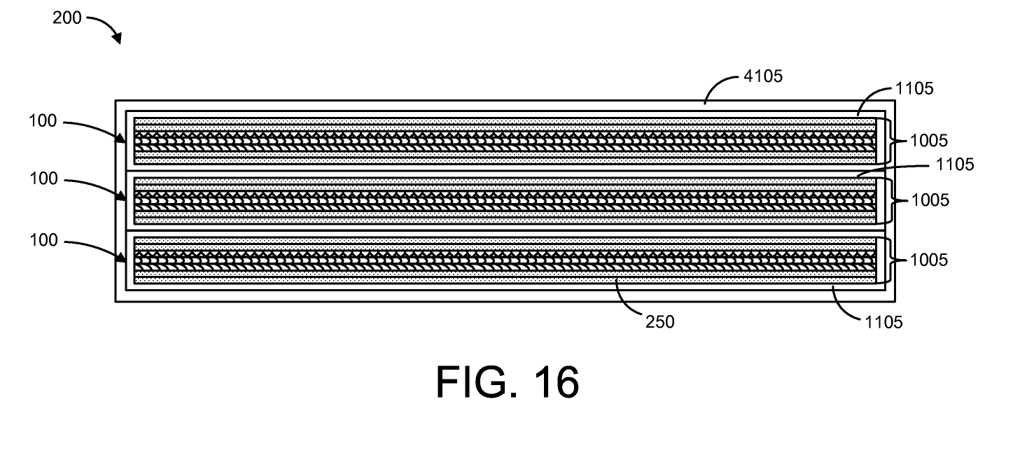

Two or more stacks of ballistic resistant sheets 1005 can be combined to provide additional protection against ballistic threats. For example, two or more stacks of ballistic resistant sheets 1005 can be combined to form a stack of ballistic resistant panels 200, as shown in FIGS. 14-16. In one example shown in FIG. 15, two stacks of ballistic resistant sheets 1005 can be combined within a single protective cover 1105 to form a combined stack of ballistic resistant sheets 4005. The combined stack 4005 can include a first plurality of ballistic resistant sheets 1020, a second plurality of ballistic resistant sheets 1025, a third plurality of ballistic resistant sheets 1030, a fourth plurality of ballistic resistant sheets 1035, and a fifth plurality of ballistic resistant sheets 1040. This configuration can be desirable in situations where ballistic performance is more important than flexibility, since flexibility will decrease as the number of ballistic resistant sheets in the stack increases. In this example, the third plurality 1030 may in fact be two pluralities of the same type of ballistic resistant sheets (e.g. 250) that are shown as a single plurality of ballistic resistant sheets after the two separate stacks are arranged into a combined stack.

In some examples, the stack of panels 200 can include two or more flexible panels 100. FIG. 14 shows a stack of panels 200 containing two flexible ballistic resistant panels 100 encased by a protective cover 1105. FIG. 16 shows a stack of panels 200 containing three flexible ballistic resistant panels 100. Each flexible panel 100 can include its own protective cover 1105, and the stack of panels 200 can include an external protective cover 4105 to provide even greater protection against water intrusion. For instance, if the additional protective cover 4105 is torn during use, the individual protective covers 1105 will protect each stack 1005 of ballistic resistant sheets within each flexible panel 100 from water intrusion and potential performance degradation.

### Dye Diffusion Thermal Transfer Process

For some applications, it can be desirable to produce a ballistic resistant apparatus 100 with one or more markings (e.g. text or graphics) that contain critical identifying information, such as certification level, manufacturer contact information, date of manufacture, lot number, fiber type, resin type, and/or anti-counterfeiting markings, or artwork. Unfortunately, existing methods of creating markings, such as screen-printing or labeling are not suitable for ballistic resistant apparatuses 100 that experience significant amounts of wear or are exposed to frequent fluctuations in temperature and/or humidity level. For instance, screen-printed markings tend to degrade over time in response to repeated abrasion, and adhesive labels tend to fall off in response to repeated fluctuations in temperature and humidity over time. Consequently, screen printing and labeling are not suitable methods for providing abrasion-resistant markings on body armor 100, such as trauma plates 105, that experiences frequent abrasion during wear and fluctuations in temperature and humidity due to both environmental changes and body heat and perspiration.

To overcome these limitations, an abrasion-resistant marking 70, as shown in FIGS. 30 and 35, can be provided on the ballistic resistant apparatus 100 using a dye diffusion thermal transfer process as described herein. The abrasion resistant marking 70 can withstand variations in temperature and humidity as well as repeated abrasion and still remain legible for the lifespan of the ballistic resistant apparatus 100. This is possible, because the abrasion-resistant marking 70 is not applied to the surface of the apparatus 100 where it would be susceptible to rapid wear or peeling. Instead, the abrasion-resistant marking 70 formed by a dye diffusion thermal transfer process is made of dye particles that penetrate beyond surface of the ballistic resistant apparatus and diffuse into a top sheet 65 of the apparatus. Consequently, scratching the surface of the ballistic resistant apparatus 100 will not remove the dye associated with the abrasion-resistant marking 70, and the marking will remain visible and legible for the lifespan of the apparatus. This attribute can have many practical benefits, including ensuring that critical identifying information, such as threat certification level, manufacturer contact information, date of manufacture, lot number, high performance fiber type, resin type, protective cover type (e.g. waterproof, chemically-resistant, etc.) and anti-counterfeiting markings remain legible for the useful life of the ballistic resistant apparatus 100.

The information contained in the marking 70 can be important to ensure accurate selection of an appropriate ballistic resistant apparatus 100 (e.g. selection of a ballistic resistant apparatus with a certain threat level certification) as well as verification that the ballistic resistant apparatus is authentic (i.e. not counterfeit). The information contained in the marking 70 can also be useful for implementing quality control measures, such as facilitating product recalls if defects in certain lots of ballistic resistant sheets (e.g. 250), resins (e.g. 160), or protective cover 1105 materials are identified and need to be refurbished or replaced.

The ballistic resistant apparatus 100 can include a top sheet adhered to an outer surface of the ballistic resistant apparatus 100, as shown in FIGS. 30-37. The top sheet 65 can be configured to receive an abrasion-resistant marking made of sublimation ink during a dye diffusion thermal transfer process, as described herein. Non-limiting examples of materials that are suitable for the top sheet 65 include polyester, ceramic, nylon, glass, metal, fabric, vinyl, ultra high molecular weight polyethylene, acrylonitrile butadiene styrene (ABS), polybutylene terephthalate (PBT), and polypropylene. In some examples, the top sheet 65 can be made of a thermoplastic polymer. One suitable example of a thermoplastic top sheet 65 is Thermoglass PBT Coex from LA/ES Laminati Estrusi Termoplastici S.P.A. of Italy. In addition to receiving the abrasion-resistant marking through a dye diffusion thermal transfer process, the top sheet 65 can also improve stab resistance and ballistic performance of the ballistic resistant apparatus 100.

The top sheet 65 can be a substrate having a first surface and a second surface opposite the first surface. The first surface of the top sheet 65 can be configured to receive the abrasion-resistant marking 70 and can be smooth or textured (e.g. textured to mimic a carbon fiber weave) depending on desired appearance. The second surface of the top sheet 65 can be slightly abraded to improve bonding to the outer surface of the ballistic resistant apparatus 100 during a heating process. The top sheet 65 can have any suitable thickness, including about 0.005-0.050, 0.020-0.030, 0.050-0.10, 0.1-0.25 in., or greater than 0.125 in.

During the dye diffusion thermal transfer process, the marking 70 can first be printed on a sheet of thermal transfer paper 85 using sublimation ink delivered to the thermal transfer paper by a printer, such as an inkjet printer. One example of a suitable inkjet printer is Model SG7100DN made from Ricoh Company, Ltd., headquartered in Tokyo, Japan. When delivered to the thermal transfer paper 85, the sublimation ink can be in a non-activated state, and can remain that way until heated to an activation temperature in a subsequent step of the process. As described below, subsequent steps of the dye diffusion thermal transfer process can include applying heat and pressure to promote an effective transfer of the sublimation ink from the transfer paper 85 to the top sheet 65. One example of a suitable thermal transfer paper 85 is Model TexPrint-R Sublimation Paper from Ricoh.

The sublimation ink can include an aqueous medium having dye particles suspended therein. The aqueous medium, such as water, can serve as a carrier fluid and can permit the dye particles (which otherwise have a powdery consistency when dry) to be printed using inkjet nozzles. Printing an image on the thermal transfer paper 85 can effectively transfer the dye particles to the thermal transfer paper. In some examples, the dye particles can be about 50-1000 nm, and the dye particles can account for about 1-10 percent of the weight of the sublimation ink. The aqueous medium can account for about 30-90 percent of the weight of the sublimation ink. The remaining percent weight of the sublimation ink can be attributed to, for example, certain solvents, surfactants, and biocides. For certain types of sublimation ink, the activation temperature of the sublimation ink can be about 200-350, 300-550, 350-500, 350-400, 375-400, 380-390, 375-425 degrees F. The activation temperature may depend heavily on the type of dye particles selected and the temperature at which the particles change phase to a gas. During a process involving dye diffusion thermal transfer, it can be desirable to set the temperature of the heated press or heating process to equal to or greater than the activation temperature of the sublimation ink. One example of a suitable sublimation ink is SubliJet-R high viscosity gel sublimation ink from Sawgrass Technologies, Inc., headquartered in Charlestown, S.C.

To facilitate transfer of the sublimation ink from the transfer paper 85 to the top sheet 65, the sheet of transfer paper 85 can be placed in contact with the top sheet 65, such that the sublimation ink of the printed image 90 is in direct contact with the top sheet 65. A dye diffusion thermal transfer process can include heating and pressing the transfer paper 85 (and the sublimation ink present thereon) against the top sheet 65 for a predetermined duration. When the sublimation dye reaches an activation temperature, the sublimation ink will change from a solid to a gas and will migrate into pores or other openings in the top sheet 65, thereby allowing the ink to penetrate beyond the top surface of the top sheet to form an abrasion-resistant marking 70, as shown in FIG. 36. During the process, pressing the transfer paper 85 against the top sheet 65 with a suitable pressure can be desirable to ensure that gaseous ink transfers directly from the transfer paper 85 to the top sheet 65, thereby providing a high quality marking 70 with sharp details similar to the image 90 originally printed on the transfer paper 85. If inadequate or uneven pressure is applied by the heated press, the gaseous ink may deposit in unintended locations on the top sheet 65 (i.e. ghosting) or can escape to the atmosphere through an air gap formed between the transfer paper 85 and the top sheet 65 resulting from, for example, an uneven (i.e. misaligned) heated press. Therefore, a suitable amount of even pressure should be applied by the heated press to urge the transfer paper 85 against the top sheet 65 to ensure production of a high quality abrasion-resistant marking 70 on the top sheet 65.

The abrasion-resistant marking 70 can be formed on the ballistic resistant apparatus 100 at any step in the manufacturing process for forming a laminate 1, including before, during, or after the vacuum-bagging step described herein.

In a first example, the abrasion-resistant marking 70 can be formed on the top sheet 65 prior to the vacuum bagging process described herein. This process can involve printing an image 90 on the sheet of thermal transfer paper 85 using sublimation ink and placing the sheet of thermal transfer paper 85 in contact with the top sheet 65 such that the sublimation ink is in direct contact with the top sheet 65. The combination of the top sheet 65 and transfer paper 85 can be positioned within a heated press, and the heated press can be closed for a predetermined duration. During the predetermined duration, the heated press can heat the top sheet 65 and transfer paper 85 (and sublimation ink present thereon) to or beyond an activation temperature of the sublimation ink. Upon reaching the activation temperature, the sublimation ink can transition to gaseous ink and migrate into the top sheet 65 to provide the abrasion-resistant marking 70.

During the pressing process, the heated press can apply about 20-100, 20-60, 30-50, or 40 psi of pressure urging the transfer paper 85 against the top sheet 65. Once at or beyond the activation temperature, the heated press can remain closed while applying pressure for a predetermined duration of about 30-60, 45-60, or at least 30 seconds to ensure adequate migration of the sublimation ink from the thermal transfer paper 85 to the top sheet 65. The heated press can remain in a closed position for about 30-720, 30-240, 30-120, 30-60, or 30-45 seconds.

A method of manufacturing a ballistic resistant apparatus 100 with an abrasion-resistant marking 70 can include providing a top sheet 65 having a top surface and a bottom surface. The method can include providing a sheet of transfer paper 85 adjacent to the top surface of the top sheet, the sheet of transfer paper having an image 90 printed on a first surface, the image 90 formed by sublimation ink containing dye particles. The first surface of the sheet of transfer paper 85 can be placed against the top surface of the top sheet 65 so that the printed image 90 is in contact with the top surface of the top sheet 65. The method can include heating and pressing the sheet of thermal transfer paper 85 against the top sheet to achieve dye diffusion thermal transfer of at least a portion of the dye particles from the image 90 printed on the sheet of thermal transfer paper 85 into the top sheet 65 to form an abrasion-resistant marking 70 in the top sheet 65. The method can include placing the top sheet 65 containing the abrasion-resistant marking 70 within a variable volume container 13. The method can include providing a stack 1005 of ballistic resistant sheets adjacent to the top sheet 65 within the variable volume container 13, where the stack 1005 of ballistic resistant sheets has a first surface and a second surface opposite the first surface, the first surface being adjacent to the top sheet. The method can include sealing the variable volume container and evacuating gas from the variable volume container. The method can include heating the stack 1005 of ballistic resistant sheets and the top sheet 65 in the variable volume container 13 to a predetermined temperature for a predetermined duration.

Pressing the sheet of thermal transfer paper 85 against the top sheet 65 can include pressing the sheet of thermal transfer paper 85 against the top sheet 65 at a pressure of about 20-100, 20-60, or 30-50 psi for about 30-720, 30-240, 30-120, 30-60, or 30-45 seconds. Heating the sheet of thermal transfer paper 85 and the top sheet 65 can include heating the sheet of thermal transfer paper 85 and the top sheet 65 to a temperature of about 300-550, 350-500, 375-425 degrees Fahrenheit.

The method can include providing a durable side wall 80 within the variable volume container 13 prior to evacuating gas from the variable volume container. The durable side wall 80 can extend along at least one side surface of the stack 1005 of ballistic resistant sheets. Following the step of heating the stack 1005 of ballistic resistant sheets and the top sheet 65, the durable side wall 80 can adhere to the bottom surface of the top sheet 65, as shown in FIGS. 36 and 37.

The method can include providing a protective cover 1105 within the variable volume container 13 prior to evacuating gas from the variable volume container. The protective cover 1105 can be adjacent to the second surface of the stack 1005 of ballistic resistant sheets. Following the step of heating the stack 1005 of ballistic resistant sheets and the top sheet 65, the protective cover 1105 can adhere to the durable side wall 80, as shown in FIGS. 36 and 37. The top sheet 65, durable side wall 80, and protective cover 1105 together can form a waterproof and/or airtight enclosure for the stack of ballistic resistant sheets, as shown in FIGS. 36 and 37.

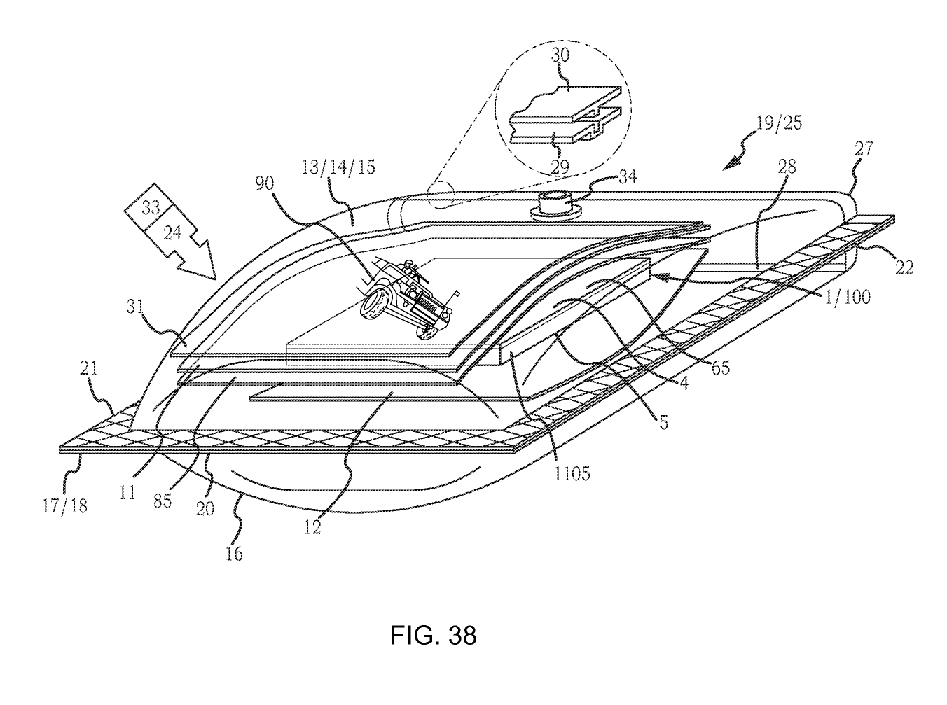

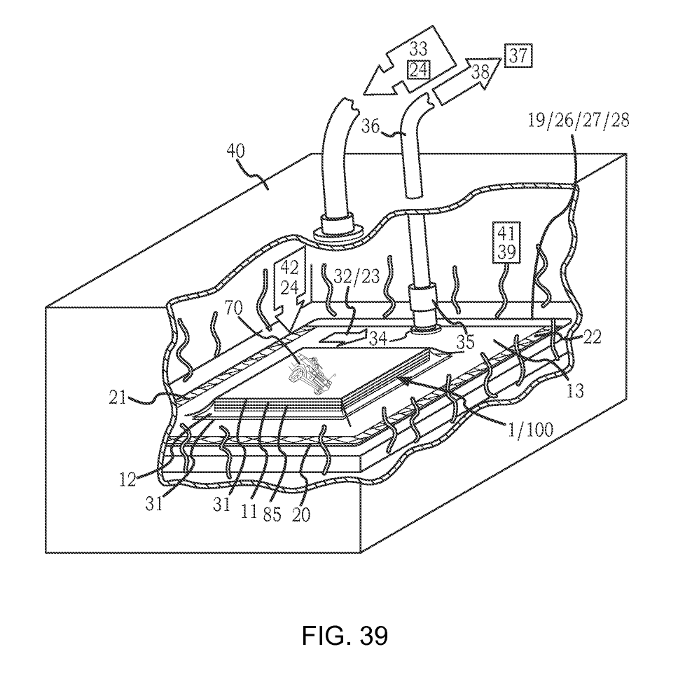

In a second example, the abrasion-resistant marking 70 can be formed on the top sheet 65 during the vacuum bagging process, as shown in FIGS. 38 and 39. As shown in FIG. 38, a sheet of thermal transfer paper 85 can be inserted adjacent to a top sheet 65 within the variable volume container 13. The printed image 90 is visible in FIG. 38 simply to show it's relative location to other items within the variable volume container 13. However, typically, the printed image 90 will not be visible at this step in the process, since it will be obscured by one or more of the variable volume container 13, the release layer 11, the breather layer 31, and/or the thermal transfer paper 85 itself, since the printed image will be printed on the underside of the transfer paper.

A method of manufacturing a ballistic resistant apparatus 100 with an abrasion-resistant marking 70 can include providing a stack 1005 of ballistic resistant sheets within a variable volume container 13, where the stack 1005 of ballistic resistant sheets has a first surface and a second surface opposite the second surface. The method can further include providing a top sheet 65 adjacent to the first surface of the stack 1005 of ballistic resistant sheets within the variable volume container 13, where the top sheet has a top surface and a bottom surface. The method can further include providing a sheet of transfer paper 85 adjacent to the top surface of the top sheet 65, where the sheet of transfer paper has an image printed 90 on the first surface, and the marking is formed with sublimation ink containing dye particles. The sheet of transfer paper can be arranged so that the printed image 90 is placed in contact with the top surface of the top sheet 65. The method can further include sealing the variable volume container 13 and evacuating gas from the variable volume container. The method can further include heating the arrangement containing the stack 1005 of ballistic resistant sheets, the top sheet 65, and the sheet of transfer paper 85 in the variable volume container 13 to a predetermined temperature for a predetermined duration to achieve dye diffusion thermal transfer of at least a portion of the dye particles from the sheet of thermal transfer paper 85 through the top surface of the top sheet 65 and into the top sheet to form an abrasion-resistant marking 70 in the top sheet. In some examples, the method can include applying a predetermined pressure to an external surface of the variable volume container 13 to urge the sheet of thermal transfer paper 85 against the top sheet 65 while heating the stack 1005 of ballistic resistant sheets, the top sheet, and the sheet of thermal transfer paper to the predetermined temperature. In some examples, the predetermined temperature can be about 50-750, 200-325, 250-300, 260-290, 255-285, or 265-275 degrees F., the predetermined duration is about 1, 5-20, 15-30, 25-60, 50-70, 45-75, 50-120, 90-240, or more than 120 minutes, and the predetermined pressure is about 1-5,000, 10-1,000, 10-200, 30-60, 50-125, 75-100, or greater than 75 psi.

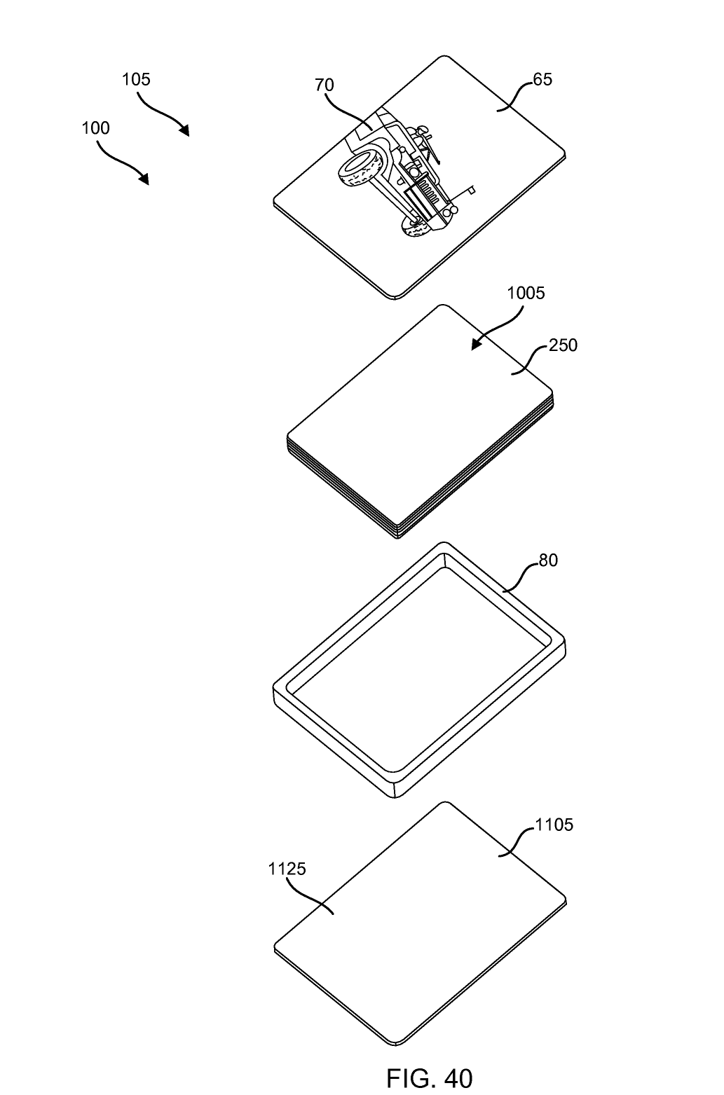

The method can include providing a durable side wall 80 (see, e.g. FIG. 40) within the variable volume container 13 prior to evacuating gas from the variable volume container 13. The durable side wall 80 can form a protective barrier around an outer perimeter of the stack 1005 of ballistic resistant sheets. The durable side wall 80 can be configured to adhere to the bottom surface of the top sheet 65 as shown in FIGS. 36 and 37. The can include providing a protective cover 1105 over the second surface of the stack 1005 of ballistic resistant sheets prior to evacuating gas from the variable volume container, as shown in FIG. 38. In some examples, the method can include providing a protective cover 1105 over an outer surface of the stack 1005 of ballistic sheets within the variable volume container 13 prior to evacuating gas from the variable volume container, where the protective cover 1105 is configured to encapsulate at least a portion of the stack 1005 of ballistic resistant sheets and provide a watertight barrier around the encapsulated stack of ballistic resistant sheets following the step of heating the stack of ballistic resistant sheets in the variable volume container 13. Examples of ballistic resistant apparatuses 100 where the protective cover 1105 encapsulates at least a portion of the stack 1005 of ballistic sheets are provided in FIGS. 33, 34, 36, 37, and 40.

The protective cover 1105 can be made of one or more sheets of nylon fabric comprising a coating of polyurethane, polypropylene, polyethylene, or polyvinylchloride on an inner surface of the nylon fabric. The coating on the protective cover 1105 can be configured to adhere to the outer surface of the stack 1005 of ballistic resistant sheets upon heating the stack of ballistic resistant sheets in the variable volume container 13. In some examples, providing the stack 1005 of ballistic resistant sheets can include providing 1-10, 5-20, 15-30, 25-40, 35-50, 45-60, 55-70, 65-80, or more than 75 ballistic resistant sheets arranged in a stack. Providing the stack 1005 of ballistic resistant sheets can include providing at least one ballistic resistant sheet (e.g. 250) containing aramid, para-aramid, meta-aramid, polyolefin, or ultra-high-molecular-weight polyethylene fibers.

In a third example, the abrasion-resistant marking 70 can be formed on the top sheet 65 of the ballistic resistant apparatus 100 after the vacuum bagging process, such as after the ballistic resistant apparatus 100 in FIG. 25 is removed from the variable volume container 13. The method of forming the abrasion-resistant marking 70 can make use of a heated press or other suitable device capable of simultaneously applying heat and pressure to urge a sheet of transfer paper 85 containing a printed image 90 against the top surface of the top sheet 65.

A method of manufacturing a ballistic resistant apparatus 100 with an abrasion-resistant marking 70 can include providing a stack 1005 of ballistic resistant sheets within a variable volume container 13, where the stack of ballistic resistant sheets has a first surface and a second surface opposite the second surface. The method can include providing a top sheet 65 adjacent to the first surface of the stack 1005 of ballistic resistant sheets within the variable volume container 13, where the top sheet 65 has a top surface and a bottom surface. The method can include sealing the variable volume container 13 and evacuating gas from the variable volume container. The method can include heating the stack 1005 of ballistic resistant sheets within the variable volume 13 container to a predetermined temperature for a predetermined duration to adhere the top sheet 65 to the first surface of the stack 1005 of ballistic resistant sheets. The method can include removing the stack 1005 of ballistic resistant sheet and the top sheet 65 from the variable volume container. The method can include providing a sheet of transfer paper 85 adjacent to the top surface of the top sheet 65, where the sheet of transfer paper has an image 90 printed on a first surface, the image 90 made of sublimation ink comprising dye particles. The first surface of the sheet of transfer paper can be placed against the top surface of the top sheet so that the printed image 90 is in contact with the top surface of the top sheet. The method can include heating and pressing the sheet of thermal transfer paper 85 against the top sheet to achieve dye diffusion thermal transfer of at least a portion of the dye particles from the image 90 on sheet of thermal transfer paper 85 into the top sheet 65 to form an abrasion-resistant marking 70 in the top sheet 65.

The method can include applying a predetermined pressure to an external surface of the variable volume container 13 while heating the stack of ballistic resistant sheets to the predetermined temperature, where the predetermined temperature is about 50-750, 200-325, 250-300, 260-290, 255-285, or 265-275 degrees F., the predetermined duration is about 1, 5-20, 15-30, 25-60, 50-70, 45-75, 50-120, 90-240, or more than 120 minutes, and the predetermined pressure is about 1-5,000, 10-1,000, 10-200, 30-60, 50-125, 75-100, or greater than 75 psi.

In some examples, pressing the sheet of thermal transfer paper 85 against the top sheet 65 can include pressing the sheet of thermal transfer paper against the top sheet at a pressure of about 20-100, 20-60, or 30-50 psi for about 30-720, 30-240, 30-120, 30-60, or 30-45 seconds. Heating the sheet of thermal transfer paper 85 and the top sheet 65 can include heating the sheet of thermal transfer paper and the top sheet to a temperature of about 300-550, 350-500, 375-425 degrees Fahrenheit.

The method can include providing a durable side wall 80 within the variable volume container 13 prior to evacuating gas from the variable volume container 13, where the durable side wall extends along at least one side surface of the stack 1005 of ballistic resistant sheets. Upon heating the stack 1005 of ballistic resistant sheets and the top sheet 65, the durable side wall 80 adheres to the bottom surface of the top sheet 65.

The method can include providing a protective cover 1105 within the variable volume container 13 prior to evacuating gas from the variable volume container, where the protective cover 1105 is adjacent to the second surface of the stack 1005 of ballistic resistant sheets. Upon heating the stack 1005 of ballistic resistant sheets and the top sheet 65, the protective cover 1105 can adhere to the durable side wall 80. The top sheet 65, durable side wall 80, and protective cover 1105 together form a waterproof enclosure for the stack of ballistic resistant sheets, as shown in FIGS. 36 and 37.

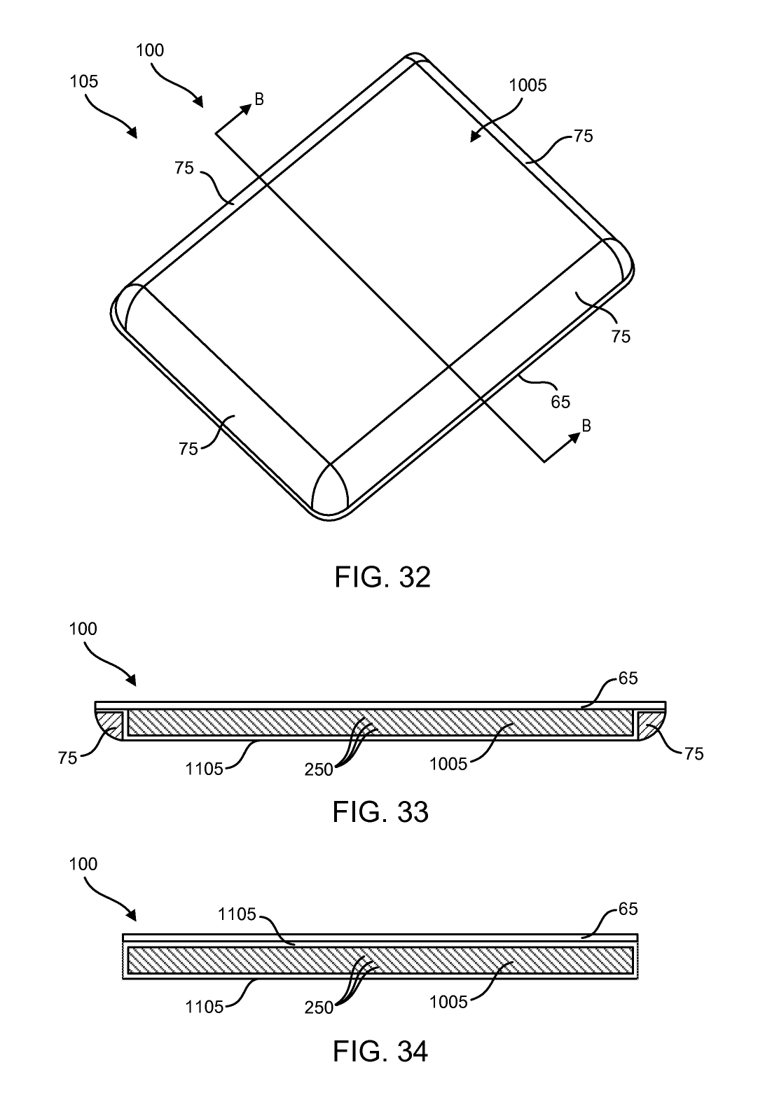

FIG. 30 shows a front perspective view of a ballistic resistant apparatus 100 having an abrasion-resistant marking 70 formed in a top sheet 65 of the apparatus. FIG. 31 shows rear perspective view of the ballistic resistant apparatus of FIG. 30. FIG. 32 shows a rear perspective view of a ballistic resistant apparatus 100 having cushioned perimeter portions 75. FIG. 33 shows a cross-sectional side view of the ballistic resistant apparatus of FIG. 32 taken along section B-B, exposing a stack 1005 of ballistic resistant sheets encased by a protective cover 1105 and a top sheet 65.

FIG. 34 shows a cross-sectional side view of a ballistic resistant apparatus 100 having a stack 1005 of ballistic resistant sheets fully encased by a protective cover 1105 and having a top sheet 65 adhered to an outer surface of the protective cover.

FIG. 35 shows a person wearing a bulletproof vest 500 including a carrier vest 108 and a ballistic resistant apparatus 100 attached to the carrier vest by any suitable method. In some examples, the ballistic resistant apparatus 100 can be fitted into a pocket of the carrier vest 108. The ballistic resistant apparatus 100 can have an abrasion-resistant marking 70, and the marking can include critical information about the apparatus, such as threat certification level, manufacturer name, date of manufacture, type of ballistic resistant sheets (e.g. 250) within a stack 1005, and lot number.

FIG. 36 shows a cross-sectional side view of a ballistic resistant apparatus 100 having a stack 1005 of ballistic resistant sheets encased by a top sheet 65, a durable side wall 80, and a protective cover 1105. The apparatus 100 can include an abrasion-resistant marking 70 formed in the top sheet by dye particles distributed beneath an outer surface of the top sheet. As shown in FIG. 36, the dye particles can extend downward from and beneath a top surface of the top sheet 65.

FIG. 37 shows a cross-sectional side view of a ballistic resistant apparatus 100 having a stack 1105 of ballistic resistant sheets encased by a top sheet, a durable side wall 80, and a protective cover 1105. The ballistic resistant apparatus include cushioned perimeters portions 75 that can protect the apparatus from impact-related damage if dropped and can make the apparatus easier to handle by an individual.

FIG. 38 shows a method of forming an abrasion-resistant marking 70 on a ballistic resistant apparatus 100. The method employs a variable volume container 13 and a sheet of thermal transfer paper 85 with an image printed on the sheet of thermal transfer paper. The image can be printed with a sublimation ink containing dye particles fluidly transferred through inkjet nozzles via an aqueous solution.

FIG. 39 shows a method of forming an abrasion-resistant marking 70 on a ballistic resistant apparatus 100, the method can employ a heated and pressurized enclosure 42 as described with respect to FIGS. 19A and 19B. In FIG. 39, the abrasion resistant marking 70 is visible simply to show it's relative location with respect to the other items within the variable volume container 13. However, typically, the abrasion-resistant marking 70 will not be visible at this step in the process, since it will be obscured by one or more of the variable volume container 13, the release layer 11, the breather layer 31, and/or the thermal transfer paper 85.

FIG. 40 shows an exploded view of a ballistic resistant apparatus 100 having a stack 1005 of ballistic resistant sheets configured to be encased by a combination of a protective cover 1105, durable side wall 80, and a top sheet 65, where the top sheet 65 has an abrasion-resistant marking 70 formed therein. The abrasion resistant marking 70 can be formed by dye particles distributed within the top sheet 65. The durable side wall 80 can be configured to extend around the entire perimeter of the stack of ballistic resistant sheets to protect all four side surfaces of the stack, as shown in FIG. 40. In other examples, the durable side wall 80 not extend around the entire perimeter of the stack and instead be positioned at corners or along one or more side surfaces of the stack of ballistic resistant sheets, which may be desirable to reduce material costs and weight.

### Edge Protection Feature

To protect the stack 1005 of ballistic resistant sheets within the ballistic resistant apparatus 100 from drop-induced damage, it can be desirable to provide an edge protection feature 80. If the ballistic resistant apparatus 100 is dropped, the edge protection feature can absorb and dissipate impact forces and thereby prevent the edges of the ballistic resistant sheets (e.g. 250) within the stack 1005 from being damaged. Protecting the edges of the sheets (e.g. 250) from being damaged is important to ensure that the ballistic resistant apparatus 100 retains consistent ballistic performance at all locations on the apparatus, even near its edges, over the useful life of the apparatus.

The edge protection feature can be a side wall 80, as shown in FIGS. 36, 37, and 40. The side wall 80 can improve the durability of ballistic resistant apparatus 100 and can protect the ballistic resistant sheets (e.g. 250) from damage during normal usage of the ballistic resistant apparatus 100. The side wall 80 can be made from any durable, resilient material that is capable of being impacted without experiencing cracking or significant deformation. The durable side wall 80 can be made of any suitable material, such as phenolic resin, wood, nylon, thermoplastic polymer, thermoplastic elastomer, metal (e.g. aluminum or titanium), or ultra high molecular weight polyethylene.

As shown in FIG. 40, the side wall 80 can extend around a perimeter of the ballistic resistant apparatus 100. The stack 1005 of ballistic resistant sheets can be configured to nest within a central opening of the side wall 80 when the ballistic resistant apparatus 100 is assembled. As shown in FIGS. 36 and 37, the side wall 80 can protrude outward beyond the edges of the stack 1005 of ballistic resistant sheets a suitable distance to ensure that any impact delivered to an edge of the apparatus 100 will be received and dissipated by the side wall 80 and not the stack 1005 of ballistic resistant sheets. Although the side wall shown in FIG. 40 extends around the entire perimeter of the stack 1005 of ballistic resistant sheets, this is not limiting. In other examples, the side wall 80 may not extend continuously around the perimeter of the stack 1005 of ballistic resistant sheets. Instead, the side wall 80 may include one or more discrete side wall sections that are strategically positioned around the perimeter (e.g. along edges and/or at corners) of the stack 1005 of ballistic resistant sheets to provide protection while also reducing material cost and weight.

In one example shown in FIG. 36, the side wall 80 can be positioned adjacent to the second surface of the top sheet 65. The side wall 80 can surround the sides of the stack 1005 of ballistic resistant sheets. In some examples (see, e.g. FIG. 40), the side wall 80 can protect substantially all side surfaces of the stack of ballistic resistant sheets, and in other examples (see, e.g. FIGS. 36 and 37), the side wall 80 may only protect a portion of each side surface of the stack of ballistic resistant sheets.

A first surface of the stack 1005 of ballistic resistant sheets can be adjacent to the second surface of the top sheet 65. The protective cover 1105 can cover a second surface of the stack 1005 of ballistic resistant sheets. The protective cover can extend outward beyond the edges of the stack 1005 of ballistic resistant sheets and can adhere to a surface of the side wall 80. Any suitable adhesive can be used to adhere the protective cover 1105 to the surface of the side wall 80. For instance, an adhesive film sheet or a resin can be used to adhere the protective cover 1105 to the surface of the side wall 80. In another example, the protective cover 1105 can be made of a material that is coated with polyurethane, polypropylene, vinyl, polyethylene, or a combination thereof, on the inner surface the cover. Heating the protective cover 1105 to a temperature above the melting point of the adhesive or resin and then cooling the cover below the melting point can result in bonding of the inner surface of the cover to the outer surface of the stack of ballistic resistant sheets 1005 and to the surface of the side wall 80.

For body armor applications, it can be desirable to provide a ballistic resistant apparatus 100 that is comfortable to wear in close proximity to a person's body and without any sharp corners that could cause discomfort. The ballistic resistant apparatus 100 shown in FIG. 37 is similar to the ballistic resistant apparatus of FIG. 36, but includes cushioned edge portions 75. The cushioned edge portions 75 can provide a ballistic resistant apparatus 100 with contoured edges. The cushioned edge portions 75 can be made of any suitable material, such as thermoplastic elastomer or butyl rubber. In addition to improving comfort of the ballistic resistant apparatus when worn in close proximity to one's body, the cushioned edge portions 75 can further protect the edges of the ballistic resistant sheets (e.g. 250) within the stack 1005 from damage resulting from an impact to an edge of the ballistic resistant apparatus 100 (e.g. if the apparatus is dropped). The contoured edge portions can also improve ingress and egress of the ballistic resistant apparatus 100 with respect to a pocket of a carrier vest 108 of a bulletproof vest 500. In some examples, the cushioned edge portions 75 can be buoyant and provide adequate buoyancy to enable the ballistic resistant apparatus 100 to float in fresh or salt water.

Ballistic Resistant Apparatus with Flotation

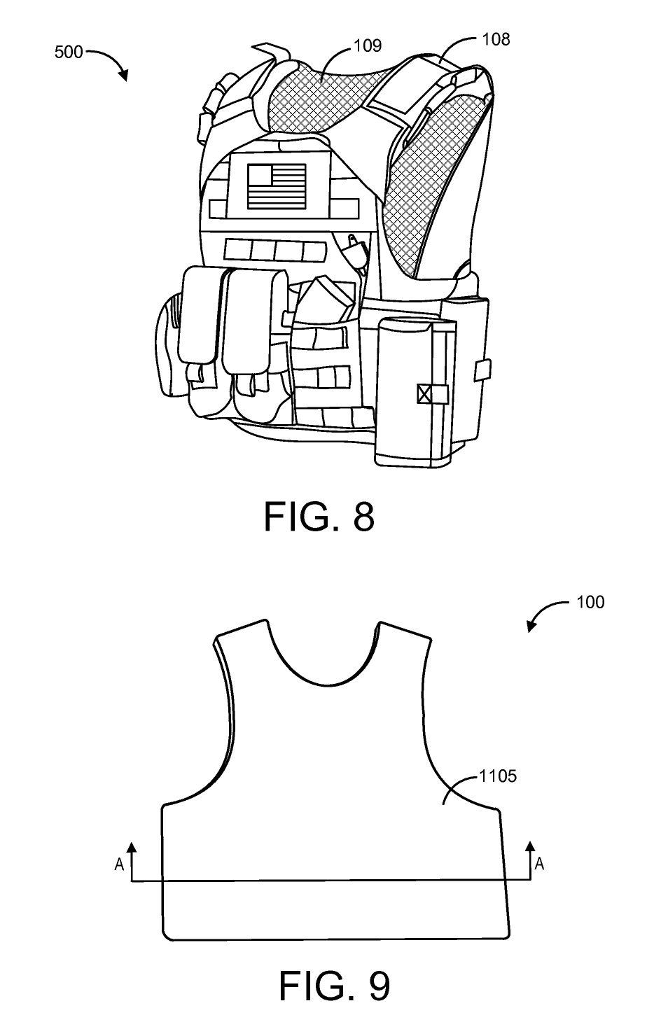

The ballistic resistant apparatus 100 described herein can be combined with a flotation device to provide a floating ballistic resistant apparatus. In some examples, the flotation device can be a personal flotation device having at least one buoyant member made from, for example, foam rubber or closed cell polystyrene or having an inflatable bladder configured to inflate with gas, such as air, nitrogen, carbon dioxide, or some other gas. One or more ballistic resistant apparatuses 100 can be concealed within the personal flotation device to provide a wearable floating ballistic resistant apparatus. As shown in FIG. 8, the floating ballistic resistant apparatus can be a bulletproof vest 500 with a buoyant member incorporated into the carrier vest 108. The carrier vest in FIG. 8, with the buoyant member 109 incorporated therein, is an example of a static flotation device, which does not require activation to float. In other examples, the flotation device can be a dynamic flotation device requiring completion of an activation step prior to floating. One example of a dynamic flotation device is a carrier vest 108 having a buoyant member 109 that includes a self-inflating bladder configured to inflate with gas during an activation step.

### Physical Tracking of Ballistic Resistant Apparatuses

The abrasion-resistant markings 70 can also be used to track products using unique identifying serial numbers formed on each ballistic resistant apparatus 100 using the dye diffusion thermal transfer process described herein. In other examples, the ballistic resistant apparatus 100 can be tracked using an RFID chip embedded within the apparatus, such as between the protective cover 1105 and the stack 1005 of ballistic resistant sheets. The RFID chip can allow the ballistic resistant apparatus 100 to easily be identified within a shipping container during transport through customs. Counterfeit ballistic resistant apparatuses that lack a chip can then easily be distinguished from authentic ballistic resistant apparatuses without having to resort to destructive testing. Because the ballistic resistant apparatuses described herein can be incredibly effective at defeating ballistic threats, it is desirable to ensure they do not end up in the hands of criminals or terrorists, and if they do, it can be desirable to know the location of the ballistic resistant apparatuses so they can be retrieved or destroyed. For this reason, it can be desirable to track the physical location of the ballistic resistant apparatus 100. The ballistic resistant apparatus can include a GPS chip and a communication module, which can be concealed within the apparatus, such as between the protective cover 1105 and the stack 1005 of ballistic resistant sheets. The communication module can be configured to transmit location information received from the GPS chip when the location information is requested by a requestor. The requestor can request the location information by transmitting a request signal that is received by an antennae concealed within the ballistic resistant apparatus and electrically connected to the communication module. Upon receiving the request signal, the communication module can transmit the location information received from the GPS chip. In other examples, the communication module can continuously or periodically transmit the location information without requiring the step of first receiving a request signal.

### Modular Armor Systems

A modular armor system can include a carrier vest 108, similar to the vests shown in FIGS. 5 and 8, configured to receive one or more flexible ballistic resistant panels 100 as described herein. The carrier vest 108 may be adapted to fit a human torso and may include a pocket adapted to receive and store the one or more flexible ballistic resistant panels 100. In some examples, each flexible ballistic resistant panel 100 can include a portion of hook and loop fastener (or other suitable fastener) attached to an exterior surface of the panel. The fastener can permit a user to quickly add or remove panels 100 as needed to protect against ballistic threats. In one example, a soldier can modify the number of panels 100 in a stack of panels disposed in the pocket of the carrier vest 108 based on a threat level or anticipated threat level of a combat situation. If the threat level is higher than expected, the soldier can add one or more additional panels 100 to the stack for greater protection. Alternately, if the threat level is lower than expected, the soldier can remove one or more panels from the stack of panels to reduce the weight of the stack, increase the flexibility of the stack, and thereby enhance the soldier's mobility.

In some examples, a modular armor system can include a carrier vest 108 adapted to fit a human torso, where the carrier vest includes a pocket adapted to receive and store one or more flexible ballistic resistant panels 100 as described herein. The one or more flexible ballistic resistant panels 100 can be adapted to fit inside the pocket of the carrier vest 108. Each of the flexible ballistic resistant panels 100 can include at least a first plurality of ballistic resistant sheets 1020 and a second plurality of ballistic resistant sheets 1025. The first plurality of ballistic resistant sheets 1020 can be made of aramid fibers and a can be coated with a first resin having a first melting temperature. Similarly, the second plurality of ballistic resistant sheets 1025, which can be adjacent to the first plurality of ballistic resistant sheets 1020, can be made of aramid fibers and can be coated with a second resin having a second melting temperature, where the second melting temperature is greater than the first melting temperature.

Each of the one or more flexible ballistic resistant panels 100 can include a portion of hook and loop fastener attached to an exterior surface of the panel. The portion of hook and loop fastener can allow the flexible ballistic resistant panel 100 to be removably attached to a second flexible ballistic resistant panel 100 to prevent relative shifting. The first resin can be a thermoplastic polymer having a melting temperature of about 215-240 degrees F. The second resin can be a thermoplastic polymer having a melting temperature of about 255-295 or 295-330 degrees F. In some examples, the first resin can be polyethylene, and the second resin can be polypropylene. Within each flexible ballistic resistant panel 100, the first plurality of ballistic resistant sheets 1020 can include 1-10, 10-20, or 20-30 ballistic resistant sheets, such as K-FLEX 0/90 x-ply ballistic resistant sheets, and the second plurality of ballistic resistant sheets 1025 can include 1-10, 10-20, or 20-30 ballistic resistant sheets, such as THERMOBALLISTIC 0/90 x-ply ballistic resistant sheets.

### Protective Covers for Oil or Gas Pipelines

A flexible ballistic resistant panel 100 can be adapted to serve as a ballistic resistant cover for an oil or gas pipeline. The flexible ballistic resistant panel 100 can include a plurality of ballistic resistant sheets 1005, and each of the plurality of ballistic resistant sheets can be formed of an arrangement of high performance fibers. The arrangement of high performance fibers can define a two-dimensional pattern. The plurality of ballistic resistant sheets 1005 can be stacked according to the two-dimensional pattern. Within the stack 1005, each of the plurality of ballistic resistant sheets can be at least partially bonded to at least one adjacent ballistic resistant sheet in the plurality of ballistic resistant sheets. The flexible ballistic resistant panel 100 can also include a waterproof cover 1105 encasing the plurality of ballistic resistant sheets. In some examples, the waterproof cover 1105 can include an adhesive coating on an inner surface. The adhesive coating can adhere the waterproof cover 1105 to an outer surface of the plurality of ballistic resistant sheets to prevent movement of the waterproof cover relative to the plurality of ballistic resistant sheets. The adhesive coating can be made of polyurethane, polyvinylchloride, polyethylene, or polypropylene. The waterproof cover 1105 can be made of rubber, NYLON, RAYON, ripstop NYLON, CORDURA, polyvinyl chloride, polyurethane, silicone elastomer, or fluoropolymer. The waterproof cover 1105 can be coated with an ultraviolet (UV) protectant to limit damage from sunlight exposure.

In some examples, the flexible ballistic resistant panel 100 can include a magnetic attachment feature configured to allow quick and easy mounting of the flexible ballistic resistant panel to an outer surface of a steel pipeline. In other examples, the magnetic attachment feature can be replaced with any other suitable attachment feature such as, for example, zippers, snaps, or hook and loop fasteners.

The plurality of ballistic resistant sheets 1005 within flexible ballistic resistant panel 100 for the oil or gas pipeline can include about 1-10, 10-20, or 20-30 ballistic resistant sheets. The plurality of ballistic resistant sheets 1005 can be made from a plurality of aramid fibers coated with a thermoplastic polymer resin. The thermoplastic polymer resin can have a melting temperature of about 215-240, 255-295, or 295-330 degrees F. The panel 100 can be manufactured according to any of the manufacturing methods specifically described herein.

### Panel Dimensions and Weight

The flexible ballistic resistant panels 100 described herein are lighter and thinner than existing panels having a similar threat level certification. For instance, existing stitched panels certified as Type IIIA have a weight of about 1.25 pounds for a 1-foot by 1-foot panel and a thickness of about 0.30 inches. Conversely, the ballistic resistant panels 100 described herein, which achieved the same threat level certification, have a weight of about 1.0 pound for a 1-foot by 1-foot panel and a thickness of about 0.215 inches or less. A panel 100 that is thinner and lighter is more versatile and is suitable for a wider range of applications.

### Ballistic Performance Standards

The ballistic resistant panels 100 described herein can be configured to comply with certain performance standards, such as those set forth in NIJ Standard-0101.06, Ballistic Resistance of Body Armor (July 2008), which is hereby incorporated by reference in its entirety. The National Institute of Justice (NIJ), which is part of the U.S. Department of Justice (DOJ), is responsible for setting minimum performance standards for law enforcement equipment, including minimum performance standards for police body armor. Under NIJ Standard-0101.06, personal body armor is classified into five categories (IIA, II, IIIA, III, IV) based on ballistic performance of the armor. Type HA armor that is new and unworn is tested with 9 mm Full Metal Jacketed Round Nose (FMJ RN) bullets with a specified mass of 8.0 g (124 gr) and a velocity of 373 m/s±9.1 m/s (1225 ft/s±30 ft/s) and with 0.40 S&W Full Metal Jacketed (FMJ) bullets with a specified mass of 11.7 g (180 gr) and a velocity of 352 m/s±9.1 m/s (1155 ft/s±30 ft/s). Type II armor that is new and unworn is tested with 9 mm FMJ RN bullets with a specified mass of 8.0 g (124 gr) and a velocity of 398 m/s±9.1 m/s (1305 ft/s±30 ft/s) and with 0.357 Magnum Jacketed Soft Point (JSP) bullets with a specified mass of 10.2 g (158 gr) and a velocity of 436 m/s±9.1 m/s (1430 ft/s±30 ft/s). Type IIIA armor that is new and unworn shall be tested with 0.357 SIG FMJ Flat Nose (FN) bullets with a specified mass of 8.1 g (125 gr) and a velocity of 448 m/s±9.1 m/s (1470 ft/s±30 ft/s) and with 0.44 Magnum Semi Jacketed Hollow Point (SJHP) bullets with a specified mass of 15.6 g (240 gr) and a velocity of 436 m/s±9.1 m/s (1430 ft/s±30 ft/s). Type III flexible armor shall be tested in both the “as new” state and the conditioned state with 7.62 mm FMJ, steel jacketed bullets (U.S. Military designation M80) with a specified mass of 9.6 g (147 gr) and a velocity of 847 m/s±9.1 m/s (2780 ft/s±30 ft/s). Type IV flexible armor shall be tested in both the “as new” state and the conditioned state with .30 caliber AP bullets (U.S. Military designation M2 AP) with a specified mass of 10.8 g (166 gr) and a velocity of 878 m/s±9.1 m/s (2880 ft/s±30 ft/s).

The term “ballistic limit” describes the impact velocity required to perforate a target with a certain type of projectile. To determine the ballistic limit of a target, a series of experimental tests must be conducted. During the tests, the velocity of the certain type of projectile is increased until the target is perforated. The term “V₅₀” designates the velocity at which half of the certain type of projectiles fired at the target will penetrate the target and half will not.

In some examples, a method of manufacturing a ballistic resistant apparatus 100 can include providing a stack 1005 of ballistic resistant sheets 250 within a variable volume container 13, evacuating gas 32 from the variable volume container, and heating the stack 1005 of ballistic resistant sheets in the variable volume container to a predetermined temperature for a predetermined duration. The method can include applying a predetermined pressure to an external surface (e.g. a flexible wall 14) of the variable volume container 13 that is in contact with an outer surface of the stack 1005 of ballistic resistant sheets 250 while heating the stack 1005 of ballistic resistant sheets 250 to the predetermined temperature. The method can include providing a protective cover 1105 over an outer surface of the stack 1005 of ballistic sheets 250 within the variable volume container 13 prior to evacuating gas 32 from the variable volume container. Providing the protective cover 1105 can include providing a waterproof cover configured to encapsulate the stack 1005 of ballistic resistant sheets 250 and provide a watertight and/or airtight barrier around the encapsulated stack of ballistic resistant sheets following heating the stack of ballistic resistant sheets in the variable volume container 13. Providing the waterproof cover 1105 can include providing one or more sheets of nylon fabric having a coating of polyurethane, polypropylene, polyethylene, or polyvinylchloride on an inner surface of the nylon fabric, where the coating is configured to mate with the outer surface of the stack 1005 of ballistic resistant sheets 250 following heating the stack of ballistic resistant sheets in the variable volume container 13. Providing the stack 1005 of ballistic sheets 250 can include providing 1-10, 5-20, 15-30, 25-40, 35-50, 45-60, 55-70, 65-80, or 75 or more ballistic resistant sheets arranged in a stack 1005. Providing the stack 1005 of ballistic resistant sheets 250 can include providing at least one ballistic resistant sheet 250 having one or more aramid, para-aramid, meta-aramid, polyolefin, or ultra-high-molecular-weight polyethylene fibers. Providing the stack 1005 of ballistic resistant sheets 250 can include providing one or more pre-impregnated ballistic resistant sheets. In some examples, the predetermined temperature can be about 50-750, 250-300, 265-275, 225-250, or 200-240 degrees F. In some examples, the predetermined duration of the heating step can be about 1, 5-20, 15-30, 25-60, 50-70, 45-75, 50-120, 90-240, or 120 or more minutes. In some examples, the predetermined pressure can be about 1-5,000, 10-1,000, 10-200, 50-125, 75-100, or 75 or more psi. The pressure can be applied concurrently with the heating step or after the heating step while the stack 1005 of ballistic resistant sheets 250 is still at an elevated temperature, the elevated temperature being above 70 degrees Fahrenheit.

A system for production of a ballistic resistant apparatus 100 can include a variable volume container 13 configured to receive a stack 1005 of ballistic resistant sheets 250. The system can include a vacuum source 38 coupled to the variable volume container 13 to evacuate an amount of gas 32 from inside the variable volume container. The vacuum source 38 can generate a vacuum pressure to evacuate gas from inside the variable volume container 13. The system can include a heat source configured to heat the stack 1005 of ballistic resistant sheets 250 within the variable volume container 13 coupled to the vacuum source 38. The system can include a pressure source configured to apply pressure to the stack 1005 of ballistic resistant sheets 250 within the variable volume container 13 coupled to the vacuum source 38. In some examples, the heat source can achieve a temperature of about 50-750, 250-300, 265-275, 225-250, or 200-240 degrees F. In some examples, the heat source can achieve the temperature for a duration of about 1, 5-20, 15-30, 25-60, 50-70, 45-75, 50-120, 90-240, or 120 or more minutes. In some examples, the pressure source 38 can achieve a pressure of about 1-5,000, 10-1,000, 10-200, 50-125, or 75-100 psi. In some examples, the variable volume container 13 can be a vacuum bag 1310.

A system for production of a ballistic resistant apparatus 100 can include a variable volume container 13 configured to receive a stack 1005 of ballistic resistant sheets 250. The system can include a vacuum source 38 coupled to the variable volume container 13 to evacuate an amount of gas 32 from inside the variable volume container. The system can include a pressurized heated enclosure 42 configured to receive and heat the stack 1005 of ballistic resistant sheets 250 within the variable volume container 13 coupled to the vacuum source 38. The pressurized heated enclosure 42 can also be configured to apply pressure to the stack 1005 of ballistic resistant sheets 50 within the variable volume container coupled to the vacuum source 38. In some examples, the pressurized heated enclosure 42 can achieve a temperature of about 50-750, 250-300, 265-275, 225-250, or 200-240 degrees F. In some examples, the pressurized heated enclosure 42 can achieve the temperature for a duration of about 1, 5-20, 15-30, 25-60, 50-70, 45-75, 50-120, 90-240, or 120 or more minutes. In some examples, the pressurized heated enclosure 42 can achieve a pressure of about 1-5,000, 10-1,000, 10-200, 50-125, or 75-100 psi.

As can be understood from the foregoing description and the corresponding figures, the basic concepts of the present method may be embodied in a variety of ways. The methods and systems involve numerous and varied embodiments of a laminate 1, such as a ballistic resistant apparatus 100 including a plurality of laminated ballistic resistant sheets (e.g. 250), and methods of producing the laminate.

As such, the particular embodiments or elements of the method disclosed by the description or shown in the figures accompanying this application are not intended to be limiting, but rather exemplary of the numerous and varied embodiments generically encompassed by the method or equivalents encompassed with respect to any particular element thereof. In addition, the specific description of a single embodiment or element of the method may not explicitly describe all embodiments or elements possible; many alternatives are implicitly disclosed by the description and figures.

It should be understood that each element of an apparatus and system and each step of a method may be described by an apparatus term or method term. Such terms can be substituted where desired to make explicit the implicitly broad coverage to which this method is entitled. As but one example, it should be understood that all steps of a method may be disclosed as an action, a means for taking that action, or as an element which causes that action. Similarly, each element of an apparatus may be disclosed as the physical element or the action that physical element facilitates. As but one example, the disclosure of “laminate” should be understood to encompass disclosure of the act of “laminating”—whether explicitly discussed or not—and, conversely, were there effectively disclosure of the act of “laminating,” such a disclosure should be understood to encompass disclosure of “a laminate,” “a ballistic resistant apparatus,” and even a “means for laminating.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

Moreover, for the purposes of the present method, the term “a” or “an” entity refers to one or more of that entity; for example, “a layer of laminatable material” refers to one or more layers of laminatable material. As such, the terms “a” or “an,” “one or more,” and “at least one” can be used interchangeably herein. Furthermore, an element “selected from the group consisting of refers to one or more of the elements in the list that follows, including combinations of two or more of the elements.

All numeric values (e.g. process temperatures, pressures, durations, and numbers of ballistic resistant sheets) presented herein are assumed to be modified by the term “about,” whether or not explicitly indicated. For the purposes of the methods described herein, ranges may be expressed as from “about” one particular value to “about” another particular value. When such a range is expressed, another embodiment includes from the one particular value to the other particular value. The recitation of numeric ranges by endpoints includes all the numeric values subsumed within that range. A numeric range of one to five includes, for example, the numeric values 1, 1.5, 2, 2.75, 3, 3.80, 4, 5, and so forth. It will be further understood that the endpoints of each of the numeric ranges are significant, both in relation to the other endpoint and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Thus, the applicant should be understood to claim at least: i) each of the stacks 1005 of ballistic resistant sheets and ballistic resistant panels 100 (either in whole or in part) herein disclosed and described, ii) the related methods and systems disclosed and described, iii) similar, equivalent, and even implicit variations of each of these apparatuses, systems, and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent methods, vii) the wide-ranging applications enhanced by the various systems or apparatuses disclosed, viii) the resulting products produced by such systems disclosed, ix) methods, systems, and apparatuses substantially as described hereinbefore and with reference to any of the accompanying examples, x) the various combinations and permutations of each of the previous elements disclosed.

The foregoing description has been presented for purposes of illustration and description. It is not intended to be exhaustive or to limit the claims to the embodiments disclosed. Other modifications and variations may be possible in view of the above teachings. The embodiments were chosen and described to explain the principles of the invention and its practical applications to enable others skilled in the art to best utilize the invention in various embodiments and various modifications as are suited to the particular use contemplated. It is intended that the claims be construed to include other alternative embodiments of the invention except insofar as limited by the prior art.

What is claimed is:

1. A ballistic resistant apparatus with an abrasion-resistant marking, the ballistic resistant apparatus comprising:
a plurality of ballistic resistant sheets arranged to form a stack of ballistic resistant sheets, the stack of ballistic resistant sheets comprising a first surface and a second surface opposite the first surface; and
a top sheet adjacent to the first surface of the stack of ballistic resistant sheets; the top sheet comprising an abrasion-resistant marking, the abrasion-resistant marking comprising dye particles deposited within the top sheet.

2. The ballistic resistant apparatus of claim 1, further comprising a sheet of adhesive film between the first surface of the stack of ballistic resistant sheets and the top sheet, the sheet of adhesive film configured to bond the top sheet to the first surface of the stack of ballistic resistant sheets.

3. The ballistic resistant apparatus of claim 1, wherein the top sheet comprises polyester, ceramic, nylon, glass, metal, fabric, vinyl, ultra high molecular weight polyethylene, acrylonitrile butadiene styrene, polybutylene terephthalate, or polypropylene

4. The ballistic resistant apparatus of claim 1, wherein the plurality of ballistic resistant sheets comprise high performance fibers, the high performance fibers comprising aramid, para-aramid, meta-aramid, polyolefin, or ultra-high-molecular-weight polyethylene fibers.

5. The ballistic resistant apparatus of claim 1, further comprising a protective cover adjacent to the second surface of the stack of ballistic resistant sheets.

6. The ballistic resistant apparatus of claim 5, wherein the protective cover comprises nylon with a coating comprising polyurethane, polypropylene, polyethylene, or polyvinylchloride, the coating provided on a surface of the protective cover that is in contact with the second surface of the stack of ballistic resistant sheets.

7. The ballistic resistant apparatus of claim 5, further comprising a durable side wall disposed between the top sheet and the protective cover, wherein the durable side wall comprises a thermoplastic polymer.

8. The ballistic resistant apparatus of claim 7, wherein the durable side wall circumscribes a perimeter of the stack of ballistic resistant sheets.

9. The ballistic resistant apparatus of claim 8, wherein the protective cover is adhered to a surface of the durable side wall to provide a sealed volume formed by the protective cover, the durable side wall, and the top sheet, the sealed volume containing the stack of ballistic resistant sheets, the sealed volume being watertight.

10. A ballistic resistant apparatus with an abrasion-resistant marking, the ballistic resistant apparatus comprising:
a stack of ballistic resistant sheets comprising:
a first plurality of ballistic resistant sheets comprising high performance fibers, wherein each ballistic resistant sheet within the first plurality of ballistic resistant sheets is at least partially bonded to at least one adjacent ballistic resistant sheet in the first plurality of ballistic resistant sheets;
a second plurality of ballistic resistant sheets comprising high performance fibers, wherein the second plurality of ballistic resistant sheets is adjacent to the first plurality of ballistic resistant sheets; and
a third plurality of ballistic resistant sheets comprising high performance fibers, wherein the third plurality of ballistic resistant sheets is adjacent to the second plurality of ballistic resistant sheets, wherein each ballistic resistant sheet within the third plurality of ballistic resistant sheets is at least partially bonded to at least one adjacent ballistic resistant sheet in the third plurality of ballistic resistant sheets; and
a top sheet adjacent to a surface of the stack of ballistic resistant sheets, the top sheet comprising an abrasion-resistant marking, the abrasion-resistant marking comprising dye particles deposited within the top sheet.

11. The ballistic resistant apparatus of claim 10, wherein the first plurality of ballistic resistant sheets comprises 1-10, 10-20, or 20-30 ballistic resistant sheets, the second plurality of ballistic resistant sheets comprises 1-10, 10-20, or 20-30 ballistic resistant sheets, and the third plurality of ballistic resistant sheets comprises 1-10, 10-20, or 20-30 ballistic resistant sheets.

12. The ballistic resistant apparatus of claim 10, wherein the first plurality of ballistic sheets comprises 1-10 0/90 x-ply ballistic resistant sheets, wherein the second plurality of ballistic sheets comprises 1-10 0/90 x-ply ballistic resistant sheets or s-glass fiberglass sheets, and wherein the third plurality of ballistic sheets comprises 1-10 0/90 x-ply ballistic resistant sheets.

13. The ballistic resistant apparatus of claim 10, wherein a first resin in the first plurality of ballistic sheets has a melting temperature of about 215-240, 240-265, 265-295, or 295-340 degrees F., wherein a second resin in the second plurality of ballistic sheets has a melting temperature of about 255-295, 295-330, 330-355, or 355-375 degrees F., and wherein a third resin in the third plurality of ballistic sheets has a melting temperature of about 215-240, 240-265, 265-295, or 295-340 degrees F.

14. A trauma plate with an abrasion-resistant marking, the trauma plate comprising:
a plurality of ballistic resistant sheets arranged to form a stack of ballistic resistant sheets, the stack of ballistic resistant sheets comprising a first surface and a second surface opposite the first surface;
a top sheet adjacent to the first surface of the stack of ballistic resistant sheets; the top sheet comprising an abrasion-resistant marking, the abrasion-resistant marking comprising dye particles deposited within the top sheet beneath a top surface of the top sheet;
a durable side wall extending around a perimeter of the stack of ballistic resistant sheets, wherein the durable side wall is adhered to a bottom surface of the top sheet; and
a protective cover adjacent to the second surface of the stack of ballistic resistant sheets, the protective cover being adhered to the durable side wall, wherein the stack of ballistic resistant sheets is encased and bounded by a combination of the top sheet, the durable side wall, and the protective cover.

15. The ballistic resistant apparatus of claim 14, wherein the top sheet comprises a polymer configured to receive dye particles when heated.

16. The ballistic resistant apparatus of claim 14, wherein the top sheet comprises polyester, ceramic, nylon, glass, metal, fabric, vinyl, ultra high molecular weight polyethylene, acrylonitrile butadiene styrene, polybutylene terephthalate, or polypropylene

17. The ballistic resistant apparatus of claim 14, wherein the top sheet, the durable side wall, and the protective cover together define an airtight and watertight volume, the volume containing the stack of ballistic resistant sheets.

18. The ballistic resistant apparatus of claim 14, wherein the stack of ballistic resistant sheets comprises:
a first plurality of ballistic sheets comprising aramid fibers and a first resin with a first melting temperature; and
a second plurality of ballistic sheets adjacent to the first plurality of ballistic sheets, the second plurality of ballistic sheets comprising aramid fibers and a second resin with a second melting temperature, wherein the second melting temperature is greater than the first melting temperature.

19. The ballistic resistant apparatus of claim 14, wherein the first plurality of ballistic resistant sheets comprises about 1-10, 10-20, or 20-30 ballistic resistant sheets, and the second plurality of ballistic resistant sheets comprises about 1-10, 10-20, or 20-30 ballistic sheets.

20. The ballistic resistant apparatus of claim 14, wherein the protective cover comprises rubber, NYLON, RAYON, ripstop NYLON, CORDURA, polyvinyl chloride, polyurethane, silicone elastomer, or fluoropolymer, and the durable side wall comprises phenolic resin, nylon, thermoplastic elastomer, or ultra high molecular weight polyethylene.
